(19) United States
(12) Patent Application Publication
(10) Pub. No.: US 2007/0298306 A1
(43) Pub. Date: Dec. 27, 2007

(54) Stationary cartridge based fuel cell system, fuel cell power supply system, and method of activating the fuel cell

(75) Inventors: Gennadi Finkelshtain, Shoham (IL); Mark Estrin, Meuhad (IL); Mark Kinkelaar, Glenmoore, PA (US); Yuri Katsman, Hadera (IL)

Correspondence Address: GREENBLUM & BERNSTEIN, P.L.C., 1950 ROLAND CLARKE PLACE, RESTON, VA, 20191, US

(73) Assignee: More Energy Ltd., Lod (IL)

(21) Appl. No.: 11/475,063

(22) Filed: Jun. 27, 2006

(51) Int. Cl. H01M 8/04; H01M 8/06

(52) U.S. Cl. 429/34; 429/19; 429/17

(57) ABSTRACT

A power supply system, in particular for use during emergencies and/or power outages, that includes at least one liquid fuel cell, at least one cartridge, and a system or device for transferring the contents of the cartridge to the fuel cell. A cartridge-free power supply system is also disclosed. This Abstract is not intended to define the invention disclosed in the specification, nor intended to limit the scope of the invention in any way.

### BACKGROUND OF THE INVENTION

1. Field of the Invention

The present invention relates to a high powered, stationary liquid fuel cell which is particularly suitable as power supply in emergency situations such as power outages. The fuel cell power supply system preferably is a stand-alone, stationary unit, which can generate from the 10s of watts to the 1,000s of watts. The fuel cell preferably is a direct liquid fuel cell which uses a borohydride-based liquid fuel.

The invention is also directed to a cartridge system that activates the fuel cell. The fuel cell may be activated by e.g., manually, mechanically, or automatically by pressing one or more cartridges containing a liquid fuel and/or an electrolyte or components thereof into the fuel cell. Alternatively, the fuel cell may already contain all components that are needed for the operation of the fuel cell but at least one of these components is not yet in contact with the appropriate electrode of the fuel cell.

2. Discussion of Background Information

Liquid fuel cells produce electricity by oxidizing a liquid fuel at an anode of the fuel cell and at the same time reducing an oxidant such as, e.g., oxygen at a cathode. The anode and the cathode are in contact through an electrolyte which may be a liquid, a gel, etc. As the fuel cell produces electricity, the liquid fuel and the electrolyte are gradually exhausted of their useful components. After a period of use, the spent liquid fuel and the spent electrolyte need to be removed from the fuel cell and replaced if the fuel cell is not to be discarded. This process is not easily and/or economically accomplished. Refilling the fuel cell also presents other difficulties due to the hazardous nature of the spent liquid fuel and the spent electrolyte. Thus, there is a need for a system for filling a fillable liquid fuel cell which allows one to perform the filling process more easily, more economically, and more safely, and which can safely store the spent fuel once its useful properties have been exhausted.

Conventional fuel cells (PEM, alkaline, molten, etc.) use various types of fuel (hydrogen/hydrocarbons and different kinds of alcohol). They typically require a fuel tank, a fuel replacement system, a heater, a water management system, etc. All of these additional systems are needed for fuel replacement, to support the desired constant reaction conditions, and in order to provide for product elimination. Such arrangements yield to the energy capacity per unit volume of the fuel cell and provide for fuel cell systems which are not, to say the least, convenient to use.

Conventional fuel cells require a continuous supply of fuel or a replaceable cartridge. Even with such systems, the fuel is usuually delivered, using a complex process which may even involve dilution, to a tank. The fuel then is oxidized at the anode. Micro-fuel cells based on methanol use a relatively small tank and usually require a feeding system to supply fuel to the tank.

Especially during a power outage generators which use gasoline are usually employed as back-up power supply system for essential electric equipment and appliances. Generators are expensive and the need to store relatively large quantities of a flammable liquid, i.e., gasoline, (e.g., in a residence) gives rise to inconvenience and danger associated with these devices. The disadvantages of a gasoline-based generator are even aggravated by the fact that in many instances the chances of ever having to use a generator because of a power outage are not very high. Accordingly, there is a need for a system which can be used as a back-up power supply system, is not complicated, is reliable, inexpensive, easy to use and capable of delivering a relatively high power. The system should be for one-time use only and be discardable or refurbishable after its use.

### SUMMARY OF THE INVENTION

The present invention provides a power supply system which is capable of providing an electrical energy of preferably at least about 500 watt-hour and comprises one or more liquid fuel cells, one or more cartridges and a transfer system for transferring the contents of the one or more cartridges to the one or more liquid fuel cells. A liquid fuel cell comprises at least one fuel chamber for holding a liquid fuel and at least one electrolyte chamber for holding an electrolyte. A cartridge comprises at least one substance selected from a liquid fuel or a component thereof and a liquid electrolyte or a component thereof.

In one aspect, the system may be designed as a stand-alone unit and/or a modular unit and/or a back-up power supply system.

In another aspect, the system may be capable of providing an electrical energy of at least about 1,000 watt-hour, e.g., at least about 2,000 watt-hour, at least about 5,000 watt-hour, or at least about 10,000 watt-hour, and/or of providing a voltage of at least about 2 V, e.g., a voltage of at least about 10 V, at least about 20 V, at least about 40 V, at least about 100 V, or at least about 200 V.

In another aspect, the system may comprise a plurality of fuel cells, e.g. at least about 2, at least about 4, at least about 8, at least about 10, at least about 20, or at least about 30 fuel cells. These fuel cells may be electrically connected in series to each other, in parallel to each other or partly in series and partly in parallel to each other. Each or at least some of the fuel cells of the plurality of fuel cells may be capable of providing an electrical energy of at least about 20 watt-hour, e.g., at least about 30 watt-hour, at least about 40 watt-hour or at least about 50 watt-hour and/or may be capable of providing an electrical power of at least about 20 watts, e.g., at least about 30 watts, at least about 40 watts or at least about 50 watts.

In another aspect of the system of the present invention, the at least one fuel chamber of a fuel cell may be substantially empty and the liquid fuel or the components thereof may be present in one or more cartridges and/or the at least one electrolyte chamber may be substantially empty and the electrolyte or the components thereof may be present in one or more cartridges. Alternatively, the at least one electrolyte chamber may contain an electrolyte or a component thereof, which may be advantageous, for example, in a case where the electrolyte comprises a gel electrolyte.

In another aspect of the system of the present invention, the at least one electrolyte chamber may comprise a liquid electrolyte, or the at least one electrolyte chamber may contain a first component of the liquid electrolyte and the at least one cartridge may contain a second component of the liquid electrolyte which in combination with the first component affords the liquid electrolyte.

In yet another aspect of the system, the liquid fuel may comprise a fuel concentrate and a liquid diluent for diluting the concentrate and both of these components may be present in one or more cartridges. Alternatively, at least a part of the liquid diluent may be present in the at least one fuel chamber and the concentrate (and optionally a part of the liquid diluent) may be present in one or more cartridges. Alternatively, at least a part of the concentrate may be present in the at least one fuel chamber and the liquid diluent (and optionally a part of the concentrate) may be present in one or more cartridges.

In another aspect of the system, a cartridge may comprise in separate sections thereof at least two of (i) a liquid fuel or a concentrate thereof, (ii) a liquid diluent for diluting the fuel concentrate and (iii) a liquid electrolyte or a (preferably liquid) component thereof. For example, the cartridge may comprise in separate sections thereof a liquid fuel concentrate and a liquid for diluting the fuel concentrate. Of course, the cartridge may comprise further separate sections, e.g., one or more sections which comprise a liquid electrolyte or one or more components thereof.

In a still further aspect of the system, a cartridge may comprise at least one puncturable cap and/or at least one puncturable separating wall (e.g., a film or sheet made of plastic material) which divides the cartridge into at least two separate sections (in the present specification and the appended claims, the terms “wall” and “membrane” are used interchangeably). In this case, it may be advantageous for a fuel cell to comprise at least one device for puncturing the puncturable separating wall and/or the puncturable cap of the cartridge.

In another aspect of the system, a cartridge may be connected to a fuel cell by a transfer system. For example, the cartridge may be connected (e.g., non-removably) to the fuel cell by the transfer system. Also, the transfer system may connect the fuel cell to more than one cartridge and/or the transfer system may connect the cartridge to more than one fuel cell.

In another aspect of the system of the present invention, the transfer system may comprise a frame and a device for (a) moving, (b) automatically moving upon activation, (c) allowing upon activation and/or (d) guiding upon activation the cartridge from a first position wherein the cartridge is not connected to a designated fuel cell to a second position wherein the cartridge is connected to the fuel cell and/or the transfer system may comprise a frame and a device for forcing, upon activation, the contents of the cartridge into the fuel cell.

In another aspect, the transfer system may comprise a frame and a device for moving, upon activation, a cartridge from a first position wherein the cartridge is not connected to a designated fuel cell to a second position wherein the cartridge is connected to the fuel cell, whereby the contents of the cartridge in the second position are automatically transferred to the fuel cell.

In another aspect, the system of the present invention may further comprise an enclosure for housing at least one cartridge and at least one (corresponding) fuel cell.

In another aspect, the system may be configured to allow the contents of the at least one cartridge to be transferred to the at least one fuel cell due at least partially to gravity and/or a biasing force.

In yet another aspect, a cartridge may be configured to slide into an opening in the designated fuel cell.

In a still further aspect, the system may be designed to cause the transfer system to transfer the contents of a cartridge to a designated fuel cell based on a predetermined condition. The system may further comprise a sensing system for sensing the predetermined condition and/or an activation system for activating the transfer system based on the predetermined condition, e.g., a predetermined condition which has been sensed by the sensing system.

In yet another aspect, the system of the present invention may further comprise a valve system which connects at least one cartridge to at least one fuel cell. For example, the transfer system may comprise a valve system which is connected to at least one cartridge and at least one fuel cell. For example, the valve system may comprise a plurality of entrance ports and exit ports which are in fluid communication with each of the at least one cartridge and the at least one fuel cell.

In another aspect, the system may further comprise a battery which is capable of supplying power during the time where the at least one fuel cell is powered up (depending, inter alia, on the specific fuel cell(s), cartridge(s) and transfer system(s) used, it may take several minutes from the time of activation is initiated to the time the system is able to supply (full) power). This is especially advantageous for commercial and cell tower applications in the case of a sudden power outage.

In a still further aspect, the system may further comprise a DC to AC converter. The provision of such a converter is especially expedient for systems which are intended to provide power for the numerous devices which operate in an AC power mode.

In another aspect of the system, the volume of the at least one fuel chamber of a single fuel cell may be at least about 0.5 liters, e.g., at least about 1 liter, or at least about 2 liters and/or the total fuel chamber volume of the entire system may be at least about 2 liters, e.g., at least about 5 liters, at least about 10 liters, or at least about 20 liters.

In another aspect, a single cartridge may comprise up to about 50 liters, e.g., up to about 25 liters, of a liquid fuel or the components thereof, e.g., a fuel concentrate plus a liquid diluent for diluting the fuel concentrate. Alternatively or cumulatively, a single cartridge may comprise up to about 10 liters of a liquid electrolyte or a component thereof.

In yet another aspect of the system of the present invention, a fuel cell may comprise a generally rectangular housing or a generally cylindrical housing and/or a cartridge may comprise a generally rectangular housing or a generally cylindrical housing.

In another aspect of the system, the liquid fuel may comprise a hydride compound such as, e.g., one or more of LiH, NaH, KH, CaH₂, BeH₂, MgH₂, NaAIH₄, LiAIH₄ and KAIH₄ and/or the liquid fuel may comprise a borohydride compound. For example, the liquid fuel may comprise one or more borohydride compounds and/or may comprise a fuel concentrate and a liquid for diluting the concentrate. The one or more borohydride compounds may be selected from, e.g., NaBH₄, KBH₄, LiBH₄, NH₄BH₄, Be(BH₄)₂, Ca(BH₄)₂, Mg(BH₄)₂, Zn(BH₄)₂, AI(BH₄)₃, polyborohydrides, (CH₃)₃NBH₃, and NaCNBH₃. Further, the liquid fuel may comprise one or more borohydride compounds in a total concentration of at least about 0.5 mole per liter of concentrate, e.g., at least about 1 mole, at least about 2 moles, or at least about 3 moles per liter of concentrate.

In another aspect of the system, the electrolyte may comprise ammonium hydroxide and/or one or more alkali metal hydroxides such as, e.g., LiOH, NaOH, KOH, RbOH, CsOH, Ca(OH)₂, Mg(OH)₂, Ba(OH)₂, Zn(OH)₂, and AI(OH)₃, usually at least NaOH and/or KOH.

The present invention also provides a power supply system comprising at least one liquid fuel cell which comprises at least one fuel chamber for holding a liquid fuel and at least one electrolyte chamber for holding an electrolyte, at least one cartridge which comprises at least one substance selected from a liquid fuel or a component thereof and a liquid electrolyte or a component thereof, and a transfer system for transferring the contents of the at least one cartridge to the at least one liquid fuel cell. This system is designed to cause the transfer system to be activated based on a predetermined condition (e.g., a power outage or a drop of the voltage and/or a drop of the power provided by a regular power supply system below a predetermined value).

In one aspect, the system may further comprise an activation system for activating the transfer system based on the predetermined condition and/or a sensing system for sensing the predetermined condition. For example, the activation system may be capable of activating the transfer system based on a sensing of the predetermined condition by the sensing system.

The present invention also provides a power supply system which comprises at least one direct liquid fuel cell and a system or device for transferring liquid fuel or a component thereof to the at least one fuel cell. The power supply system is capable of providing an electrical energy of at least about 500 watt-hour, e.g., at least about 1,000 watt-hour, at least about 5,000 watt-hour or at least about 10,000 watt-hour.

In one aspect, the system may comprise a liquid fuel which comprises one or more borohydride compounds.

The present invention also provides a load which is in electrical contact with a power supply system. The load has an electric power of at least about 20 watts, e.g., at least about 50 watts, at least about 100 watts, at least about 500 watts, or at least about 1,000 watts, and the power supply system is capable of powering the load and providing an electrical energy of at least about 100 watt-hour, e.g., at least about 250 watt-hour, at least about 500 watt-hour, at least about 1,000 watt-hour, or at least about 5,000 watt-hour. The power supply system comprises at least one direct liquid fuel cell which comprises at least one fuel chamber for holding a liquid fuel and at least one electrolyte chamber for holding an electrolyte, at least one cartridge which comprises at least one substance selected from a liquid fuel or a component thereof and a liquid electrolyte or a component thereof, and a transfer system for transferring the contents of the at least one cartridge to the at least one liquid fuel cell.

In one aspect, the load may comprise a hospital or facility thereof, a store or facility thereof, an office or facility thereof, a communications system, or a residential or retirement home. In another aspect, the load may comprise a cell phone tower, an industrial motor, a life support system, a computer system (optionally including, for example, monitor(s) and printer(s)), a facsimile machine, an (e.g., emergency) lighting system, an air conditioner, a furnace fan, a space heater, a water heater, a freezer, a refrigerator, a range, a hotplate, a microwave oven, a water well pump, a sump pump, and/or a battery charger.

In yet another aspect, the system may comprise a liquid fuel which comprises one or more borohydride compounds.

The present invention also provides a method of generating electrical power during a power outage. The method comprises activating one of the power supply systems of the present invention, including the various aspects thereof as set forth above and below. In one aspect, the method may comprise activating the power supply system based on a predetermined condition.

The present invention also provides a method of generating electrical energy during a power outage, wherein the method comprises activating a power supply system which is designed for one-time use and comprises at least one direct liquid fuel cell and a hydride and/or borohydride containing liquid fuel and is capable of providing an electrical energy of at least about 100 watt-hour, e.g., at least about 250 watt-hour, at least about 500 watt-hour, or at least about 1,000 watt-hour.

In one aspect of the method, the power supply system may comprise a plurality of direct liquid fuel cells, e.g., at least about four direct liquid fuel cells, which are electrically connected to each other (in series and/or in parallel).

In another aspect, the method may comprise an automatic activation of the system when the power outage is detected.

The present invention also provides a method of supplying a customer with an emergency power supply. The method comprises supplying the customer with a power supply system for one-time use or a component thereof. The system comprises at least one direct liquid fuel cell. The terms “one-time use” and “single-use” as used herein and the appended claims are intended to mean that once the supply system has been activated, it can only be used over a limited period of time even if the system has not been completely exhausted during its first or subsequent use (due, e.g., to a gradual decomposition of the liquid fuel inside the fuel cell). The limited period may, for example, comprise about ten weeks, e.g., about four weeks, or about two weeks.

In one aspect of the method, the system may further comprise at least one cartridge which comprises at least one substance which is selected from a liquid fuel or a component thereof and a liquid electrolyte or a component thereof and/or the system may further comprise a transfer system for transferring the contents of the at least one cartridge to the fuel cell.

In another aspect, the liquid fuel may comprise a hydride compound and/or a borohydride compound.

In yet another aspect, the power supply system may be capable of providing an electrical energy of at least about 100 watt-hour, e.g., at least about 250 watt-hour, at least about 500 watt-hour, at least about 1,000 watt-hour, at least about 5,000 watt-hour, or at least 10,000 watt-hour.

In another aspect, the method may further comprise providing the customer with an opportunity to return the used power supply system or a component thereof (e.g., the cartridge or the fuel cell). In yet another aspect, the method may further comprise providing the customer with an opportunity to exchange a used power supply system or a component thereof for an operational power supply system or component thereof. The method may further comprise refurbishing a returned power supply system or a component thereof and offering the refurbished system or component thereof for sale to the same or a different customer.

In another aspect, the method may further comprise (i) offering to deliver and/or install the power supply system or a component thereof at a location specified by the customer and/or (ii) offering to pick up a used power supply system or component thereof and replace it by a new power supply system or component thereof and/or (iii) offering to refurbish a used power supply system or a component thereof at the location.

In another aspect, the method may further comprise offering to check and, if needed, repair an installed power supply system at the location in periodic intervals to ensure operability thereof at the time of use, e.g., at the time of a power outage.

In yet another aspect of the method, the customer may be a private customer, or the customer may be a commercial customer (e.g., a store, a hospital, an office, etc.).

The present invention also provides a fuel cell based power supply system which does not comprise one or more cartridges for supplying fuel and/or electrolyte or components thereof to a fuel cell. Specifically, the present invention provides a power supply system which comprises at least one (self-contained) liquid fuel cell. The at least one fuel cell comprises a cathode, an anode, a fuel chamber comprising a liquid fuel or at least one component thereof (e.g., a fuel concentrate) on one side of the anode and an electrolyte chamber comprising an electrolyte (e.g., a liquid electrolyte or a gel electrolyte) or at least one component thereof between the anode and the cathode. At least the contents of the fuel chamber (or at least one component of the liquid fuel) are separated from the anode by a first separating device which is removable from the anode and/or puncturable/slitable. The system (e.g., the at least one fuel cell itself) further comprises a first activation device by which the first separating device can be removed from the anode and/or punctured (in the present specification and the appended claims the terms “puncture” and “puncturable” are used interchangeably with the terms “slit”, “rip”, “tear” and “slitable”, “ripable” and “tearable”, respectively) to allow the contents of the fuel chamber to contact the anode.

In one aspect of the system, also the contents of the electrolyte chamber may be separated from the anode by a second separating device which is removable from the anode and/or puncturable, and the system (e.g., the at least one fuel cell itself) may also comprise a second activation device by which the second separating device can be removed from the anode and/or punctured to allow the contents of the electrolyte chamber to contact the anode.

In another aspect of the system, the contents of the electrolyte chamber may be separated from the cathode by a third separating device which is removable from the cathode and/or puncturable, and the system may further comprise a third activation device by which the third separating device can be removed from the cathode and/or punctured to allow the contents of the electrolyte chamber to contact the cathode.

In yet another aspect of the system, the liquid fuel may comprise a fuel concentrate and a liquid diluent for diluting the concentrate and the fuel chamber may be divided into at least a first fuel chamber section and a second fuel chamber section by a fourth separating device which is puncturable and/or removable. One of the first and second fuel chamber sections comprises the concentrate and the other one of the first and second fuel chamber sections comprises the liquid diluent and the system (e.g., the at least one fuel cell itself) may further comprise a fourth activation device by which the fourth separating device can be punctured and/or removed to allow the concentrate and the liquid diluent to mix.

In a still further aspect of the system, the electrolyte may comprise a first liquid component and a second component (e.g., a liquid, solid or semi-liquid component) and the fuel chamber may be divided into at least a first electrolyte chamber section and a second electrolyte chamber section by a fifth separating device which is puncturable and/or removable. One of the first and second electrolyte chamber sections comprises the first component and the other one of the first and second electrolyte chamber sections comprises the second component and the system may further comprise a fifth activation device by which the fifth separating device can be punctured and/or removed to allow the first and second components to mix.

In another aspect, the first separating device may comprise a membrane and/or the first activation device may comprise a blade for puncturing the membrane. By way of non-limiting example, the device may be a dagger or a knife (e.g., a scoring knife). The same applies to any of the second to fifth separating devices and any of the second to fifth activation devices. Also, the at least one fuel cell may comprise any combination of the first separating device/first activation device with two to four of the second to fifth separating device/second to fifth activation device combinations. Further, two or more of the first to fifth activation devices may be combined in a single device. For example, the first and second activation devices may be combined in a single activation device, or the first and fourth activation devices may be combined in a single activation device. Still further, if more than one fuel cell is present in the system, activation devices for different fuel cells may be connected so that they can all be operated at the same time (the same applies to the cartridge/fuel cell system which comprises more than one fuel cell/cartridge combination; also in this case the activation of two or more cartridges may be centralized by an appropriate device).

Apart from the fact that the cartridge-free power supply system comprises at least one fuel cell which does not have associated therewith one or more cartridges from which one or more components which are necessary for the operation of the fuel cell (i.e., fuel and/or electrolyte or components thereof) are supplied to the fuel cell, the system may be the same and operate in the same way, after activation thereof, as the cartridge/fuel cell system set forth herein (it is to be appreciated that these two systems may also be combined in a single “mixed” system comprising one or more cartridge-free fuel cells and one or more cartridge/fuel cell combinations; further, the present invention also encompasses “hybrids” wherein a fuel cell comprises one or more separating devices and also has one or more cartridges associated therewith). Accordingly, whenever in the following the cartridge/fuel cell system is discussed, it needs to be kept in mind that with the exception of the absence of a cartridge and the modifications necessitated thereby the same applies to the cartridge-free system.

By way of non-limiting example, the cartridge-free system may have the same power output, may supply the same energy, may have the same size of fuel cell, the same number of fuel cells and may use the same fuel and electrolyte as the cartridge/fuel cell system set forth herein. Activation of the at least one fuel cell of the cartridge-free system is brought about by operating the first activation device and any of the other activation devices (e.g., any of the second to fifth activation devices) which may be present in the system (e.g., in the fuel cell). The fuel cell will supply power only after all of the separating devices that are present in the at least one fuel cell have been removed and/or punctured. An activation device may be operated in principally the same way as a cartridge in the cartridge/fuel cell system. For example, if the activation device comprises a blade (e.g., a scoring knife), the activation device may simply be pressed down (manually, hydraulically, with a spring, automatically, based on a predetermined condition, etc.), whereby a separating device such as a membrane may be slit, thereby allowing a liquid fuel or an electrolyte to contact the anode (or the cathode in the case of an electrolyte) or allowing two components of the liquid fuel (e.g., concentrate and liquid diluent) or the electrolyte (e.g., water and a solid alkali and/or alkaline earth metal hydroxide) to mix. Of course, both the fuel chamber and the electrolyte chamber may comprise more than one separating device, although one separating device, if any, will usually be sufficient.

The separating device(s) or is (are) made of a material that is able to withstand prolonged contact with the fuel or the electrolyte or any of the components thereof, respectively, with which the separating device is intended to come into contact (the same applies to the separating walls inside a cartridge). Non-limiting examples of suitable materials include plastic materials (e.g., in the form of films or sheets) such as those set forth below as suitable for other components of the fuel cell and/or the cartridge. Of course, if two or more separating devices are present in the fuel cell, they may not necessarily be made of the same material, for example, because they are intended to be exposed to different chemical environments.

In one aspect of the cartridge-free system, the at least one fuel cell may not contain all of the components which are necessary for the operation of the fuel cell. For example, the fuel chamber may contain a fuel concentrate but not the liquid diluent therefor and/or the electrolyte chamber may contain a solid alkali and/or alkaline earth metal hydroxide but not the water for affording the aqueous solution thereof that is desired as (liquid) electrolyte. In such a case, the at least one fuel cell may comprise one or more (sealable or resealable) openings (e.g., closed by a screw cap or the like) through which the corresponding liquid(s), in particular, water can be introduced in the fuel chamber or the electrolyte chamber (e.g. by using a funnel or by connecting a cartridge thereto). The absence of one or more liquid components of the fuel and/or the electrolyte (especially water) in the fuel cell helps to reduce the weight of the fuel cell and thereby also reduces transportation costs. Also, the absence of the liquid diluent in the fuel chamber will usually remove the desirability of the employment of a fourth separating device and a corresponding fourth activation device. The same applies to the fifth separating device/fifth activation device combination if the electrolyte chamber contains only one of two components of a (liquid) electrolyte.

As set forth above, according to one aspect of the invention, the power supply system may be a stand-alone, stationary unit, which can generate from the 10s of watts to the 1,000s of watts (e.g., at least about 10 watts, at least about 20 watts, at least about 50 watts, at least about 100 watts, at least about 200 watts, or at least about 500 watts). Moreover, one or more of the following elements and technologies may be incorporated in the system: fuel cells, fuel compositions, electrodes, electrolytes, cartridges, gas elimination devices, devices for preventing fuel decomposition, etc. disclosed in, e.g., U.S. Pat. Nos. 6,554,877, 6,758,871 and 7,004,207 and pending U.S. patent application Ser. Nos. 10/757,849 (US2005/0155279 A1), Ser. No. 10/758,081 (US2005/0155668 A1), Ser. No. 10/634,806 (US2005/0058882 A1), Ser. No. 10/758,080 (US2005/0158609 A1), Ser. No. 10/803,900 (US2005/0206342 A1), Ser. No. 10/824,443 (US2005/0233190 A1), Ser. No. 10/796,305 (US2004/0241521 A1), Ser. No. 10/849,503 (US2005/0260481 A1), Ser. No. 11/132,203 (US2006/0047983 A1), Ser. No. 10/959,763 (US2006/0078783 A1), Ser. no. 10/941,020 (US2006/0057435 A1), Ser. No. 11/226,222 (US2006/0057437 A1), US2002/0076602 A1, US2002/0142196 A1, 2003/0099876 A1, Ser. No. 11/384,364, 11/384,365, 11/325,466, 11/325,326 and 60/781,340. The entire disclosures of all of these patents and patent applications are hereby expressly incorporated by reference herein.

The invention is also directed to a high powered fuel cell power supply system for portable, auxiliary and remote power requirements. Preferably, the fuel cell system has a target power output of between about 20 watts to about 5,000 watts for a limited use time of between about 1 hour and about 500 hours.

The technology which can be used in the fuel cell power supply system of the present invention can preferably be based on technology specifically disclosed in pending U.S. patent application Ser. No. 10/824,443 (US 2005/0233190 A1).

The invention also relates to a cartridge system than activates the cartridge/fuel cell system. By pressing a cartridge into the fuel cell, the power supply system can be fueled, i.e., activated, and made ready to generate power.

Alternative non-limiting methods for activating the cartridge/fuel cell system can include the following:
vertically releasing and/or gravitational dropping of a cartridge or cartridge module onto or into the fuel cell module below it and the resulting transfer of contents from the cartridge to the fuel cell system;
a spring release system which presses the cartridge module into the fuel cell module and the resulting transfer of contents from the cartridge to the fuel cell system;
a hydraulic or pneumatic piston arrangement that presses the cartridge module into the fuel cell module and the resulting transfer of contents from the cartridge to the fuel cell system; and
a manual and/or mechanical lever system that can be utilized to press the cartridge module into the fuel cell module and the resulting transfer of contents from the cartridge to the fuel cell system.

The fuel cartridge may, for example, contain a paste-like (e.g., medium to high viscosity) fuel concentrate, a liquid for diluting the concentrate and optionally a liquid electrolyte. By way of non-limiting example, the fuel cell can utilize fuels and fuel concentrates of the type disclosed in pending U.S. patent application Ser. Nos. 10/758,081, 11/384,364, and 11/384,365.

The invention also contemplates that, once the fuel is depleted, the fuel cell module can be replaced with a new one. That is, the power supply system can be (and preferably is) a single-use system.

The power supply system can be a generally rectangular system module or can be a generally cylindrical system. Furthermore, the fuel cell can utilize a single cell configuration, a double cell configuration, or even a multiple cell configuration.

When the fuel cell system is a cylindrical system, the fuel can be introduced within the cylinder and the cylinder can contain an anode (fuel side), cathode (air side), as well as electrolyte (between anode and cathode). Furthermore, the cylinders can be connected in a series and/or in parallel to boost the voltage and/or current.

In a dual configuration, two electrode pairs are positioned back to back and the fuel is positioned in the center, between the anodes (in this case, the fuel cell will usually comprise one fuel chamber and two electrolyte chambers). This back to back configuration can be extended to include additional cells to boost voltage and/or current.

In a rectangular configuration, one or more cells are positioned with fuel on the anode, in a manner which is analogous to the smaller configuration disclosed in pending U.S. patent application Ser. No. 10/849,503.

According to one aspect of the invention, the cartridge system can have the following characteristics:
the fuel can be stored in the cartridge as a paste (concentrate) and liquid diluent (solvent), analogous to the smaller configurations disclosed in pending U.S. patent application Ser. Nos. 10/824,443 and 10/758,081.
the cartridge can optionally include electrolyte, or gel electrolyte technology which can be employed to reduce complexity. Non-limiting examples of suitable gel electrolytes are disclosed in U.S. provisional patent application No. 60/781,340. Before introducing the fuel into the fuel cell no reaction occurs within the fuel cell, so the fuel cell power supply system of the present invention can have an extended shelf-life.

According to one aspect of the invention, a fuel cell power supply system of the present invention can also have the following characteristic: a power management system utilizing a current chipset which can be restructured to optimally handle more than one cell.

According to still another aspect of the invention, a fuel cell power supply system can comprise a configuration wherein a number of fuel cell units are arranged or connected in series such that at least one of the units can be activated as described herein. Since the configuration is arranged in series, power supply from all of the units can be prevented until the designated unit(s) is (are) intentionally activated.

According to still another aspect of the invention, a fuel cell power supply system can comprise a configuration wherein a number of fuel cell units are arranged or connected in parallel such that at least one of the units can be activated as described herein. Since the configuration is arranged in parallel, power supply occurs from all of the units except for the designated unit(s), which can then be intentionally activated when additional power is required.

According to still another aspect of the invention, a fuel cell power supply system can comprise a configuration which combines units arranged in series with units arranged in parallel. By way of non-limiting example, a plurality of sub-power-supply arrangements may be arranged in series wherein each of the sub-power-supply arrangements comprises a plurality of fuel cell units arranged in parallel. At least one of the sub-power-supply arrangements can be activated as described herein. That is, all of the units of the designated power-supply arrangement can be activated when it is desired to utilize the power supply from all of the series connected power-supply arrangements. Since the configuration is arranged in series, power supply from all of the power-supply arrangements can be prevented until the designated power-supply arrangement(s) are intentionally activated.

According to still another aspect of the invention, a single fuel cell module preferably is capable of providing a power of at least about 20 watts, e.g., at least about 30 wafts, but will often not supply more than about 100 wafts, e.g., not more than 50 wafts. Depending of the power requirements needed for a particular location, the number of fuel cell modules in the system can range from between 1 to a plurality of modules, and can preferably be at least about 4, e.g., at least about 8, but will usually not exceed about 80 modules and will preferably not exceed about 50 modules.

According to still another aspect of the invention, the fuel cell and fuel cell power supply system will preferably have the following characteristics: watt-hour output of at least about 500, e.g., at least about 1,000, at least about 2,000, at least about 5,000, or at least about 10,000, but often not more than about 50,000; voltage from about 2 volts to about 250 volts, e.g., from about 2 volts to about 40 volts (e.g., from about 2 volts to about 20 volts), or from about 100 volts to about 250 volts (e.g., from about 110 volts to about 230 volts); the exposed anode area of each fuel cell unit will often be from about 200 cm² to about 2,000 cm²; the exposed cathode area of each fuel cell unit will often be from about 200 cm² to about 2,000 cm²; the fuel chamber volume of each fuel cell unit will often be from about 0.5 liters to about 20 liters, e.g., from about 1 liter to about 10 liters; the fuel chamber volume of the entire power supply system will often be from about 2 liters to about 200 liters, e.g., from about 5 liters to about 100 liters; the (total) electrolyte chamber volume (e.g., for liquid or gel electrolyte) of each fuel cell unit will usually be from about 0.01 liters to about 2 liters, and between about 0.2 liters to about 40 liters for the entire power supply system.

According to still another aspect of the invention, the cartridge system for a single fuel cell of a fuel cell power supply system will often have the following characteristics: watt-hour output range for a fuel cell/cartridge module from about 50 to about 5,000; electrolyte section volume, if any, of a cartridge from about 0.01 liters to about 10 liters; (total) fuel section volume of cartridge (e.g., for fuel or for concentrate plus liquid diluent) from about 0.1 liters to about 50 liters. By way of non-limiting example, a concentrate volume can be from about 0.05 liters up to about 40 liters (e.g., up to about 80% of the available volume) and a liquid diluent volume can be the same, i.e., from about 0.05 liters up to about 40 liters (e.g., up to about 80% of the available volume).

Non-limiting ways of storing the components in the cartridge in order to facilitate transfer to the fuel cell can include, i.e., piston/cylinder storage (see e.g., US2005/0155668 A1), flexible bladder storage (see e.g., 2005/0233190 A1 and 2005/0260481 A1), as well as pressurized storage, etc.

Each fuel cell module in the fuel cell system can utilize its own corresponding cartridge module (one or more cartridges, usually one cartridge). The number of fuel cell modules (with their corresponding cartridge modules) will often be from about 4 to about 80 (and preferably not higher than about 50) in a stationary fuel cell system.

During stand-by (when the fuel cell power supply system is not supplying power), the cartridge module remains unconnected to and/or un-inserted into the fuel cell module (or at least one activation device of the cartridge-free system is not activated).

If the fuel is employed in the form of a concentrate and liquid diluent, a cartridge module is preferably divided into at least into two separate sections (also referred to herein as “chambers”); one chamber contains fuel, e.g., fuel concentrate (e.g., a paste-like, high viscosity mass), and another chamber contains liquid diluent (for example, a solvent such as, e.g., one or more water, (cyclo)aliphatic alcohols having up to about 6 carbon atoms and up to about 6 hydroxy groups, C₂₋₄ alkylene glycols, di(C₂₋₄ alkylene glycols), poly(C₂₋₄ alkylene glycols), mono-C₁₋₄-alkyl ethers of C₂₋₄ alkylene glycols, di(C₂₋₄ alkylene glycols) and poly(C₂₋₄ alkylene glycols), di-C₁₋₄-alkyl ethers of C₂₋₄ alkylene glycols, di(C₂₋₄ alkylene glycols) and poly(C₂₋₄ alkylene glycols), ethylene oxide/propylene oxide block copolymers, ethoxylated aliphatic polyols, propoxylated aliphatic polyols, ethoxylated and propoxylated aliphatic polyols, aliphatic ethers having up to about 6 carbon atoms, aliphatic ketones having up to about 6 carbon atoms, aliphatic aldehydes having up to about 6 carbon atoms, C₁₋₄-alkyl esters of C₁₋₄ alkanoic (aliphatic) acids and primary, secondary and tertiary aliphatic amines having a total of up to about 10 carbon atoms, for example, at least one of water, methanol, ethanol, propanol, isopropanol, ethylene glycol, diethylene glycol, 1,2,4-butanetriol, trimethylolpropane, pentaerythritol, sorbitol, glycerol, acetone, methyl ethyl ketone, diethyl ketone, methyl acetate, ethyl acetate, dioxan, tetrahydrofuran, diglyme, triglyme, monoethanolamine, diethanolamine, triethanolamine, monopropanolamine, dipropanolamine and tripropanolamine). An optional third chamber can be provided in the cartridge for storing liquid electrolyte (for example, an aqueous solution comprising an alkali and/or alkaline earth metal hydroxide). Each chamber may have a sealable opening and/or an opening which can be accessed to allow the transfer of the contents of the cartridge into the appropriate corresponding chambers in the fuel cell module.

In this regard, it is noted that the fuel cell may already contain, for example, a part of or the entire liquid diluent for the concentrate and/or may already contain the electrolyte (especially in the case of a gel electrolyte) or a part thereof (e.g., in the case of an aqueous solution of an alkali metal hydroxide as electrolyte, the electrolyte chamber of the fuel cell may already contain at least a part of the water or at least a part of a solid alkali and/or alkaline earth metal hydroxide). In this case the cartridge may, for example, comprise only one chamber for the concentrate and optionally another chamber for the electrolyte or a component thereof.

A number of non-limiting options for storing the components in the cartridge chambers may be utilized as follows:
one or more of the chambers may comprise a rigid housing containing a lower seal tab and a vertical/horizontal or diagonal membrane separating the paste from its solvent;
one or more of the chambers may comprise a rigid housing containing a lower seal tab and a “floating” membrane bag containing one component surrounded by the second component inside the rigid housing;
one or more of the chambers may comprise be a rigid housing, without a lower seal tab, containing two “floating” membrane bags for each component;
one or more of the chambers may comprise a non-rigid, “concertina” housing that can be compressed vertically with any one of the above-noted options.

The cartridge and fuel cell module housings will preferably be produced primarily from lightweight, low-cost materials. Due to cost considerations, the cartridge and fuel cell module housings will preferably be made of polymer materials which are capable of withstanding (prolonged) exposure to the chemicals contained in the cartridge and the fuel cell. Preferred examples of polymer materials include, but are not limited to (optionally filled) plastic materials such as PVC, PP, ABS, polycarbonate, polyurethane, etc. In practice, substantially all components (other than those with specific mechanical requirements such as springs, puncturing devices, etc.) are preferably made from such polymer materials. Of course, other materials can be used as well, such as, e.g., metals or alloys thereof (e.g., aluminum, chromium, nickel, titanium, copper, steel, brass, etc.). It also is possible, for example, to use polymer materials for some parts of the cartridge housing and/or fuel cell housing and other materials such as, e.g. metals or alloys thereof, for other parts of the housing. Exemplary dimensions of cartridge module housings are, for example, from about 5 cm×5 cm×5 cm up to about 20 cm×25 cm×100 cm. Exemplary dimensions for fuel cell module housings are from about 10 cm×10 cm×10 cm up to about 40 cm×50 cm×200 cm.

Non-limiting ways of activating the fuel cell module of the cartridge/fuel cell system can include a pressing device which presses the cartridge into or onto the fuel cell module. The contents of the cartridge can then be caused and/or allowed to transfer from the cartridge to the fuel cell module. This can occur using valves to provide the required interface between the cartridge and fuel cell module. Preferably, no valves are used and instead the cartridge can be directly connected to the fuel cell module in a manner which allows for the direct transfer of contents.

Each type of cartridge chamber in the stationary system can, for example, utilize a bottom port that is sealed with a seal tab or an open port with a membrane bag resting on it. Both types of cartridge, e.g., sealed or open ports, are matched by each type of fuel cell in the stationary system having one type of top, open port with a sharp puncturing component, e.g., a puncturing needle, corresponding to the cartridge bottom port.

The needle can have one or more sharp points. It can be configured either as a tube/pipe which is open at both ends. A top portion can be beveled and have a pointed edge. Alternatively, it may utilize a sharp tipped blade which is beveled or which has a multi-angled configuration. By way of non-limiting example, the tip can be V-shaped or have the form of a two pronged dagger.

The mixing of the fuel components (for example, if the fuel is employed in the form of a concentrate and a liquid diluent therefor) can be performed immediately before use, e.g., between transfer from the cartridge and the fuel cell module. This mixing process can, for example, be performed during the connecting process of the cartridge to the fuel cell module by puncturing both the seal tab and membrane that divides the fuel from its solvent. The same seal tab puncturing process can be executed with the optional electrolyte present in an optional third chamber. Gravitational force can be utilized to permit the contents, i.e., fuel concentrate, liquid diluent and optional electrolyte, to enter the fuel cell module.

For example, the arrangement can be such that a downward movement of the cartridge into the fuel cell causes the sharp point of the puncturing device to puncture either the seal tab and/or the membrane bag and release the entire contents of the cartridge into the appropriate chamber of the fuel cell.

The downward movement of each type of cartridge module system can be accomplished in a controlled manner such that the bottom port of the cartridge system is precisely aligned with a top port of the fuel cell system. This control is performed by a guiding arrangement which can be as simple as a frame, an outer casing, or by utilizing vertical guides.

One way in which the downward movement occurs is by a release and gravitational drop of the suspended cartridge system onto the fuel cell system. By way of non-limiting example, the cartridge can be released for its gravitational drop by extracting a retaining pin.

Another non-limiting option for causing the downward movement of the cartridge module can utilize a spring release mechanism. This mechanism can be located above the cartridge module such that, when released, the spring participates with gravity in forcing the cartridge module down into and/or onto the fuel cell module.

Still another non-limiting option for causing the downward movement of the cartridge module can utilize a hydraulic or pneumatic piston that moves the cartridge module down into and/or onto the fuel cell module. The piston mechanism can be located above the cartridge module. When the piston moves down, it forces the cartridge module down into and/or onto the fuel cell module.

Still another non-limiting option for causing the downward movement of the cartridge module can utilize a mechanically and/or manually operated lever that moves the cartridge module down into and/or onto the fuel cell module. The lever can be located on one side of the cartridge and can extend above the cartridge module. When the lever is pulled down/up, it forces the cartridge module down into and/or onto the fuel cell module.

The invention also contemplates other non-limiting ways of connecting the cartridge to a cylindrical fuel cell module. According to one non-limiting design of the cartridge module, the cartridge module can be a cylindrical fuel cell module which corresponds to a cylindrically configured fuel cell module. In this case, both the cylindrical cartridge module and the cylindrical fuel cell module can utilize all of the options discussed above for connecting and transferring contents, as well as for activation the fuel cell system.

The following is a list of the locations and/or devices which could utilize the power back-up system of the invention, e.g., in the case of a power outage: cell phone towers; as an emergency back-up power system for residential homes; as an emergency back-up power system for one or more office locations; as a small store/shop emergency power back-up system; as a emergency power back-up system for hospital units; as a power system for recreational activities (boating, camping, etc.). The system can also be used in industrial applications such as e.g., emergency response situations; remote operations (forestry, warehouse, mining); communications systems back up; emergency lighting systems; as well as military applications.

The invention is also directed to a power supply system comprising at least one fuel cell, at least one cartridge, and a system for transferring at least some of the contents of the at least one cartridge to the at least one fuel cell based on a predetermined condition.

The power supply system may be at least one of a stand-alone unit, a modular unit, and a back-up power supply system. The at least one cartridge may comprise at least one fuel chamber. The at least one cartridge may comprise a plurality of separate chambers. The at least one cartridge may comprise a fuel chamber and an electrolyte chamber. The at least one fuel cell may comprise at least one substantially empty fuel chamber. The at least one fuel cell may comprise a plurality of separate substantially empty chambers. The at least one fuel cell may comprise a fuel chamber and an electrolyte chamber.

The at least one cartridge may be connected to the fuel cell by the system for transferring. The at least one cartridge may be non-removably connected to the fuel cell by the system for transferring. The at least one cartridge may be connected to the fuel cell prior to the system for transferring causing the contents of the fuel cell to enter the fuel cell. At least one port of the at least one cartridge may be connected to at least one port of the fuel cell prior to the system for transferring causing the contents of the fuel cell to enter the fuel cell. Ports of the at least one cartridge may be connected to ports of the fuel cell prior to the system for transferring causing the contents of the fuel cell to enter the fuel cell. Each port may be in fluid communication with a chamber of the at least one cartridge and the at least one fuel cell.

The system for transferring may comprise a frame and a device for moving the at least one cartridge from a first position wherein the at least one cartridge is not connected to the at least one fuel cell to a second position wherein the at least one cartridge is connected to the at least one fuel cell. The system for transferring may comprise a frame and a device for automatically moving, when activated, the at least one cartridge from a first position wherein the at least one cartridge is not connected to the at least one fuel cell to a second position wherein the at least one cartridge is connected to the at least one fuel cell. The system for transferring may comprise a frame and a device for automatically allowing, when activated, the at least one cartridge from a first position wherein the at least one cartridge is not connected to the at least one fuel cell to a second position wherein the at least one cartridge is connected to the at least one fuel cell. The system for transferring may comprise a frame and a device for guiding, when activated, the at least one cartridge from a first position wherein the at least one cartridge is not connected to the at least one fuel cell to a second position wherein the at least one cartridge is connected to the at least one fuel cell. The system for transferring may comprise a frame and a device for forcing, when activated, the contents of the at least one cartridge into the at least one fuel cell. The system for transferring may comprise a frame and a device for moving, when activated, the at least one cartridge from a first position wherein the at least one cartridge is not connected to the at least one fuel cell to a second position wherein the at least one cartridge is connected to the at least one fuel cell, whereby the contents of the at least one cartridge in the second position are automatically transferred to the at least one fuel cell.

The power supply system of the present invention may further comprise an enclosure for housing the at least one cartridge and the at least one fuel cell, wherein the system for transferring comprises a device for moving the at least one cartridge from a first position wherein the at least one cartridge is not connected to the at least one fuel cell to a second position wherein the at least one cartridge is connected to the at least one fuel cell. The power supply system may further comprise an enclosure for housing the at least one cartridge and the at least one fuel cell, wherein the system for transferring comprises a device for automatically moving, when activated, the at least one cartridge from a first position wherein the at least one cartridge is not connected to the at least one fuel cell to a second position wherein the at least one cartridge is connected to the at least one fuel cell. The power supply system may further comprise an enclosure for housing the at least one cartridge and the at least one fuel cell, wherein the system for transferring comprises a device for automatically allowing, when activated, the at least one cartridge from a first position wherein the at least one cartridge is not connected to the at least one fuel cell to a second position wherein the at least one cartridge is connected to the at least one fuel cell. The power supply system may further comprise an enclosure for housing the at least one cartridge and the at least one fuel cell, wherein the system for transferring comprises a device for guiding, when activated, the at least one cartridge from a first position wherein the at least one cartridge is not connected to the at least one fuel cell to a second position wherein the at least one cartridge is connected to the at least one fuel cell. The power supply system may further comprise an enclosure for housing the at least one cartridge and the at least one fuel cell, wherein the system for transferring comprises a device for forcing, when activated, the contents of the at least one cartridge into the at least one fuel cell. The system may further comprise an enclosure for housing the at least one cartridge and the at least one fuel cell, wherein the system for transferring comprises a device for moving, when activated, the at least one cartridge from a first position wherein the at least one cartridge is not connected to the at least one fuel cell to a second position wherein the at least one cartridge is connected to the at least one fuel cell, whereby the contents of the at least one cartridge in the second position are automatically transferred to the at least one fuel cell.

The contents may be transferred due at least partially to the force of gravity. The contents may be transferred due at least partially to a biasing force.

The at least one cartridge may be configured to slide into an opening in the at least one fuel cell. The at least one cartridge may comprise at least one puncturable separating wall. The at least one cartridge may comprise at least one puncturable cap. The at least one cartridge may comprise at least one puncturable separating wall dividing the at least one cartridge into at least two separate chambers. The at least one fuel cell may comprise at least one device for puncturing a puncturable separating wall and/or at least one puncturable cap.

The power supply system may further comprise a system for sensing a predetermined condition. The power supply system may further comprise a system for activating the system for transferring at the time of the predetermined condition. The power supply system may further comprise a system for activating the system for transferring when the predetermined condition is sensed. The power supply system may further comprise a system for activating the system for transferring after the predetermined condition is sensed. The power supply system may further comprise a system for activating the system for transferring immediately after the predetermined condition is sensed. The at least one fuel cell may comprise a generally rectangular housing. The at least one cartridge may comprise a generally rectangular housing. The at least one fuel cell may comprise a generally cylindrical housing. The at least one cartridge may comprise a generally cylindrical housing. The power supply system may further comprise a valve system connecting the at least one cartridge to the at least one fuel cell. The system for transferring may comprise a valve system connected to each of the at least one cartridge and the at least one fuel cell. The power supply system may further comprise a system for sensing a predetermined condition. The power supply system may further comprise a system for activating the system for transferring at the time of the predetermined condition. The power supply system may further comprise a system for activating the system for transferring when the predetermined condition is sensed. The power system may further comprise a system for activating the system for transferring after the predetermined condition is sensed. The valve system may comprise a plurality of entrance ports and exit ports which are in fluid communication with each of the at least one cartridge and the at least one fuel cell.

The power supply system may further comprise at least one other fuel cell electrically connected in series to the at least one fuel cell. The system may further comprise at least one other fuel cell electrically connected in parallel to the at least one fuel cell. The system may further comprise a plurality of fuel cells electrically connected in series to the at least one fuel cell. The power supply system may further comprise a plurality of fuel cells electrically connected in parallel to the at least one fuel cell.

The invention also provides for a method of generating electrical power using a power supply system described herein and comprising at least one fuel cell. The method comprises feeding fuel into the at least one fuel cell when a predetermined condition is detected.

The method may further comprise storing the fuel or components thereof in a cartridge before the feeding. The method may further comprise connecting a cartridge to the at least one fuel cell before the feeding. The method may further comprise automatically connecting a cartridge to the at least one fuel cell before the feeding. The feeding may comprise automatically feeding the fuel or components thereof into the at least one fuel cell when the predetermined condition is detected. The method may further comprise sensing the predetermined condition before the feeding. The method may further comprise moving a cartridge towards the at least one fuel cell when the predetermined condition is detected. The method may further comprise guiding a cartridge towards the at least one fuel cell when the predetermined condition is detected. The method may further comprise automatically moving a cartridge towards the at least one fuel cell when the predetermined condition is detected. The method may further comprise automatically guiding a cartridge towards the at least one fuel cell when the predetermined condition is detected. The method may further comprise non-removably connecting a cartridge to the at least one fuel cell. The feeding may comprise controlling fluid flow between a cartridge and the at least one fuel cell via a valve system.

The method may further comprise, before the feeding, moving a cartridge towards the at least one fuel cell when the predetermined condition is detected, wherein the feeding occurs automatically when the cartridge is connected to the at least one fuel cell. The method may further comprise, before the feeding, connecting at least one port of a cartridge to at least one port of the at least one fuel cell when the predetermined condition is detected, wherein the feeding occurs automatically when said ports are connected to each other. The method may further comprise electrically connecting the at least one fuel cell in series with at least one other fuel cell. The method may further comprise electrically connecting the at least one fuel cell in parallel with at least one other fuel cell. The method may further comprise electrically connecting the at least one fuel cell to a device which utilizes electrical power. The device may comprise a cell phone tower. The feeding may comprise forcing the fuel into the at least one fuel cell. The method may further comprise puncturing with a puncturing device a cartridge before the feeding. The method may further comprise feeding an electrolyte into the at least one fuel cell.

The invention is also directed to a method of generating electrical energy using a power supply system comprising at least one fuel cell, wherein the method comprises automatically activating the at least one fuel cell when a predetermined condition is detected or sensed.

The activation may comprise feeding fuel into the at least one fuel cell when a predetermined condition is detected.

The invention is also directed to a power supply system comprising at least one fuel cell and a system or device for transferring fuel into the at least one fuel cell, wherein the power supply system has a watt-hour output of at least about 500 and preferably at least about 1,000 (and usually not more than about 50,000).

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically shows a first embodiment of a power system which includes a fuel cell, a cartridge, a system for connecting the cartridge to the fuel cell, and a frame system for supporting these components;

FIG. 2 schematically shows the first embodiment of FIG. 1 after the cartridge has been connected to the fuel cell with the system for connecting the cartridge to the fuel cell;

FIG. 3 schematically shows the frame system and connecting system of the first embodiment of FIG. 1 with the cartridge and fuel cell removed;

FIG. 4 schematically shows the fuel cell used in the first embodiment of FIG. 1;

FIG. 5 schematically shows the cartridge used in the first embodiment of FIG. 1;

FIG. 6 schematically shows a second embodiment of a power system which includes a fuel cell, a cartridge, a system for connecting the cartridge to the fuel cell, and a frame system for supporting these devices;

FIG. 7 schematically shows a third embodiment of a power system which includes a fuel cell, a cartridge, a system for connecting the cartridge to the fuel cell, and a frame system for supporting these components;

FIG. 8 schematically shows a fourth embodiment of a power system which includes a fuel cell, a cartridge, a system for connecting the cartridge to the fuel cell, and an enclosure system for housing these components;

FIG. 9 schematically shows the fourth embodiment of FIG. 8 after the cartridge has been connected to the fuel cell with the system for connecting the cartridge to the fuel cell;

FIG. 10 schematically shows another embodiment of a fuel cell and cartridge which can be used in the invention. The fuel cell utilizes a single anode, a single cathode, a fuel chamber, and an electrolyte chamber;

FIG. 11 schematically shows another embodiment of a fuel cell and cartridge which can be used in the invention. The fuel cell utilizes two anodes, two cathodes, a fuel chamber, and two electrolyte chambers;

FIG. 12 schematically shows another embodiment of a fuel cell which can be used in the invention. The fuel cell utilizes a cylindrical anode, a cylindrical cathode, a cylindrical fuel chamber, and an annular electrolyte chamber;

FIG. 13 schematically shows one non-limiting way in which the fuel cell of FIG. 12 can be connected with a cylindrical cartridge;

FIG. 14 schematically shows one non-limiting fuel cell opening for receiving the cartridge. The opening is square-shaped and the fuel cell utilizes two entry ports arranged at the bottom of the opening, one in fluid communication with a fuel chamber and one in fluid communication with an electrolyte chamber;

FIG. 15 schematically shows how the fuel cell opening of FIG. 14 can receive therein the cartridge. The figure shows the cartridge in an aligned position prior to being inserted into the opening;

FIG. 16 schematically shows the fuel cell opening of FIG. 14 with the cartridge installed therein;

FIG. 17 schematically shows one non-limiting way in which the fuel cell can be connected in series with other fuel cells;

FIG. 18 schematically shows another non-limiting way in which the fuel cell can be connected in parallel with other fuel cells;

FIG. 19 schematically shows one non-limiting way in which a number of fuel cells can be connected in series and in parallel with other fuel cells;

FIG. 20 schematically shows one non-limiting way in which the power system of the invention can be connected to an exemplary load such as a cell tower;

FIG. 21 schematically shows one non-limiting embodiment of a cartridge. The cartridge is shown in cross-section and utilizes two chambers separated by a horizontal puncturable thin or membrane wall as well as a puncturable thin or membrane cap. Once the membrane wall is punctured, the contents of the two chambers can start to mix with each other in the cartridge;

FIG. 22 schematically shows another non-limiting embodiment of a cartridge. The cartridge is shown in cross-section and utilizes two chambers separated by a vertical puncturable thin or membrane wall as well as a puncturable thin or membrane cap. Once the membrane wall is punctured, the contents of the two chambers can start to mix with each other in the cartridge;

FIG. 23 schematically shows another non-limiting embodiment of a cartridge. The cartridge is shown in cross-section and utilizes two chambers separated by a diagonal puncturable thin or membrane wall as well as a puncturable thin or membrane cap. Once the membrane wall is punctured, the contents of the two chambers can start to mix with each other in the cartridge;

FIG. 24a schematically shows another non-limiting embodiment of a cartridge. The cartridge is shown in cross-section and utilizes two chambers. One of the chambers is located within a puncturable thin or membrane bag while the other chamber constitutes the volume of the cartridge outside of the bag. The cartridge also utilizes a puncturable thin or membrane cap. Once the membrane bag is punctured, the contents of the two chambers can start to mix with each other in the cartridge;

FIG. 25 schematically shows another non-limiting embodiment of a cartridge. The cartridge is shown in cross-section and utilizes one chamber arranged within a housing which has a variable volume. The cartridge also utilizes a puncturable thin or membrane cap;

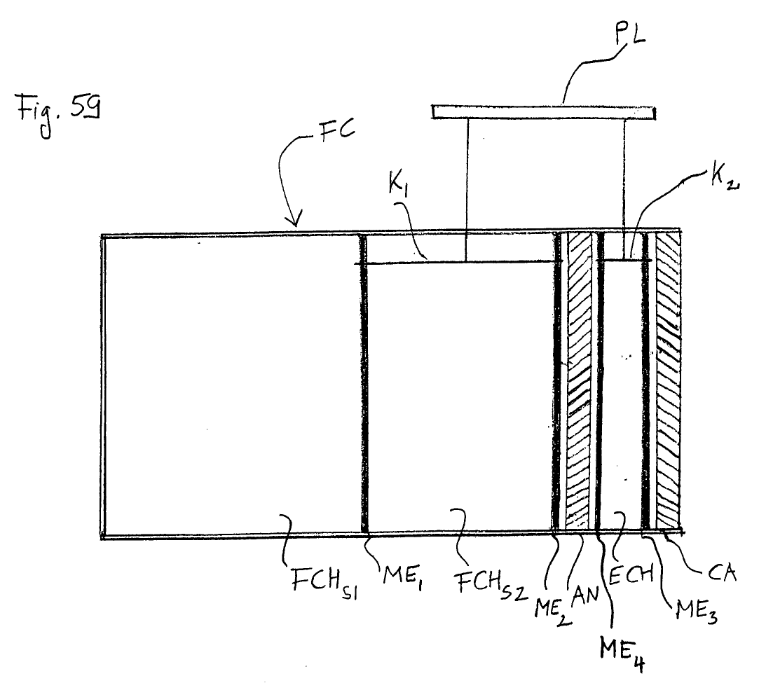

FIG. 24b schematically shows another non-limiting embodiment of a cartridge. The cartridge is shown in cross-section and utilizes two chambers. Each of the chambers is located within a puncturable thin or membrane bag. The cartridge also utilizes a puncturable thin or membrane cap. Once the membrane bags are punctured, the contents of the two chambers can start to mix with each other in the cartridge;

FIG. 26 schematically shows one non-limiting way in which a cartridge can be connected with a fuel cell such that the connection causes the membrane cap of the cartridge to be punctured;

FIG. 27 schematically shows the cartridge and fuel cell of FIG. 26 after the cartridge is connected to the fuel cell and illustrates the membrane cap of the cartridge being punctured;

FIG. 28 schematically shows another non-limiting way in which a cartridge can be connected with a fuel cell such that the connection causes both the membrane cap and the membrane wall of the cartridge to be punctured;

FIG. 29 schematically shows the cartridge and fuel cell of FIG. 28 after the cartridge is connected to the fuel cell;

FIG. 30 schematically shows another non-limiting way in which a cartridge can be connected with a fuel cell such that the connection causes both the membrane cap and the membrane wall of the cartridge to be punctured. In this embodiment, the cartridge contains a solvent and a paste. The cartridge and fuel cell each also utilize a sealing member;

FIG. 31 schematically shows the cartridge and fuel cell of FIG. 30 as the cartridge is moved towards a fully connected state with the fuel cell;

FIG. 32 schematically shows the cartridge and fuel cell of FIG. 30 after the cartridge is fully connected with the fuel cell;

FIG. 33 schematically shows another non-limiting way in which a cartridge can be connected with a fuel cell such that the connection causes both the membrane cap and the membrane wall of the cartridge to be punctured. In this embodiment, the cartridge contains a solvent and a paste. The cartridge and fuel cell each also utilize a sealing member;

FIG. 34 schematically shows the cartridge and fuel cell of FIG. 33 as the cartridge is moved towards a fully connected state with the fuel cell;

FIG. 35 schematically shows the cartridge and fuel cell of FIG. 33 after the cartridge is fully connected with the fuel cell;

FIG. 36 shows one non-limiting port/valve configuration for placing one or more of the chambers of the cartridge into fluid connection with one or more ports of the fuel cell;

FIG. 37 shows a first spring and plunger valve which is utilized in the fuel cell valve/port;

FIG. 38 shows a second spring and ball valve which is utilized in the cartridge valve/port;

FIG. 39 shows a partial view of the two valves/ports in an assembled state prior to being connected to each other;

FIG. 40 shows a partial view of the two valves/ports in a connected state and in a state which allows for fluid communication between the cartridge and fuel cell;

FIG. 41 shows a partial view of another valve/port embodiment wherein the outer portions of the valve sleeves are arranged adjacent to one another;

FIG. 42 shows a first spring and plunger valve which is utilized in the fuel cell valve;

FIG. 43 shows side cross-sectional and front end views of a pierceable washer which is utilized in the cartridge valve;

FIG. 44 shows a partial view of the two valves in an assembled state prior to being connected to each other;

FIG. 45 shows a partial view of the two valves in a connected state and in a state which allows for fluid communication between the cartridge and fuel cell. The pierceable washer is shown in a pierced state and the plunger valve is shown in a retracted position caused by fluid pressure sufficient to overcome the biasing force of the first spring, i.e., the fluid pressure caused by the fluid being forced from the cartridge and into the fuel cell;

FIG. 46 shows a top view of a fuel cell embodiment which can be used in the power system of the invention;

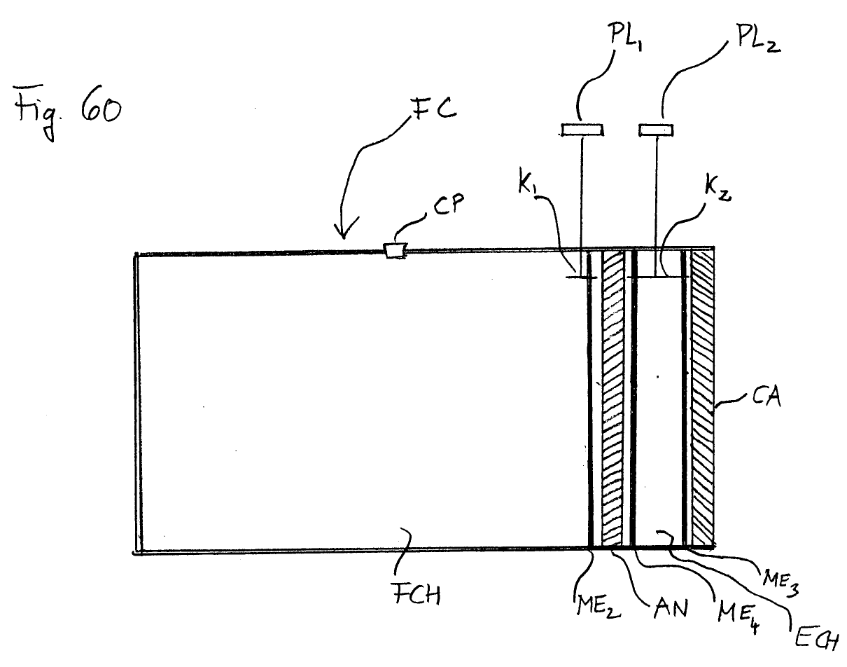

FIG. 47 shows a side cross-section view of the fuel cell shown in FIG. 25. The anode and cathodes are not shown;

FIG. 48 shows a bottom view of a cartridge without the pierceable washer and sealing ring installed thereon;

FIG. 49 shows a side cross-section view of the cartridge shown in FIG. 48. The pierceable washer and sealing ring are shown in an uninstalled state;

FIG. 50 shows a side cross-section view of the cartridge shown in FIGS. 48 and 49, and the disposable fuel cell shown in FIGS. 46 and 47. The cartridge contains the fuel component(s) and the sealing ring and the pierceable washer are shown in an installed state. The cartridge is arranged in an aligned position prior to being connected to the fuel cell;

FIG. 51 shows a side cross-section view of the cartridge and fuel cell shown in FIG. 50 in a non-removably fully connected state. The cartridge is shown with its pierceable washers being pierced by the piercing members of the fuel cell;

FIG. 52 shows a side cross-section view of the cartridge and fuel cell shown in FIG. 51. The pistons of the cartridge are shown in a lowermost position after having moved automatically under the influence of the springs. The fuel component(s) of the cartridge has been transferred to the fuel cell;

FIG. 53 shows a side cross-section view of another cartridge and fuel cell system in a fully non-removably connected state. This embodiment is similar to the embodiment shown in FIGS. 46-52 except that it includes flexible variable-volume chambers in the cartridge;

FIG. 54 shows an enlarged partial view of FIG. 53;

FIG. 55 shows a side cross-section view of another cartridge and fuel cell system in a fully non-removably connected state. This embodiment is similar to the embodiment shown in FIGS. 46-52 except that it utilizes a mechanical piston actuation system in place of the springs and except that it utilizes one-way cartridge valves in place of piercing washers;

FIG. 56 shows an enlarged partial view of FIG. 55;

FIG. 57 shows an enlarged partial view of an alternative fuel port/cartridge port connection. The connection utilizes two O-rings and the pierceable washer;

FIG. 58 shows a side cross-section view of another cartridge and fuel cell system in a fully connected state. This embodiment uses a valve system to connect the cartridge to the fuel cell and a control system to control the valve system;

FIG. 59 shows a schematic side cross-section view of a cartridge-free fuel cell with separating devices and a activation device combination; and

FIG. 60 shows a schematic side cross-section view of another cartridge-free fuel cell with separating devices and two activation devices. This fuel cell has an opening in the fuel chamber which makes it possible to introduce a fuel component that is not yet contained in the fuel chamber.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

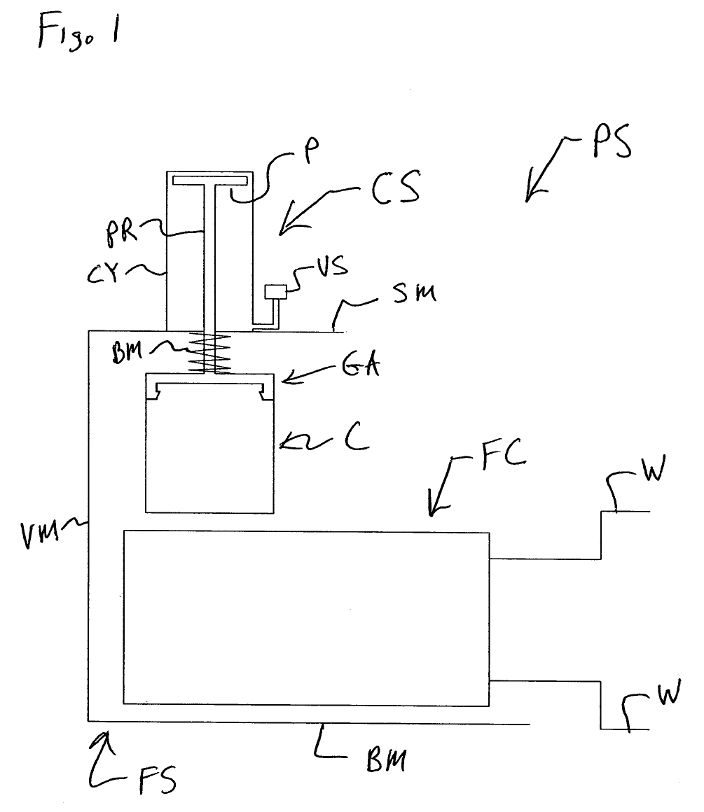

FIGS. 1-5 show a first non-limiting embodiment of a stand-alone fuel cell power system PS. The power system PS utilizes fuel cell FC and cartridge C arrangement and/or system. The fuel cell FC includes an outer housing which can be generally rectangular in shape. Of course, the fuel cell FC can have any other desired shape including, but not limited to polygonal, linear, oval, round, and/or curvilinear shapes. A plurality of wires W can have one end connected directly to the housing of the fuel cell FC or alternatively to a bus bar (not shown) which itself is electrically connected to the fuel cell FC. The bus bar or fuel cell FC can then be connected to a main bus bar or power circuit which feeds the source (e.g., a cell phone tower) electrical power for operation. As is shown in FIG. 1, the cartridge C is arranged above the fuel cell FC in a position which will allow the cartridge C to be correctly positioned within and/or mounted to the fuel cell FC at a desired time. Since the cartridge C contains certain active ingredients (e.g., fuel or fuel concentrate and optionally electrolyte) which the fuel cell FC needs to begin producing electrical power, until the cartridge C is mated with the fuel cell FC and until the contents of the cartridge C are transferred to the proper chambers of the fuel cell FC, the fuel cell FC does not produce power and provides an open circuit to wires W. When it is desired to place the fuel cell FC into operation, the cartridge C can be lowered into position within and/or on the fuel cell FC such that the contents of the cartridge C are safely and properly transferred to the fuel cell FC.

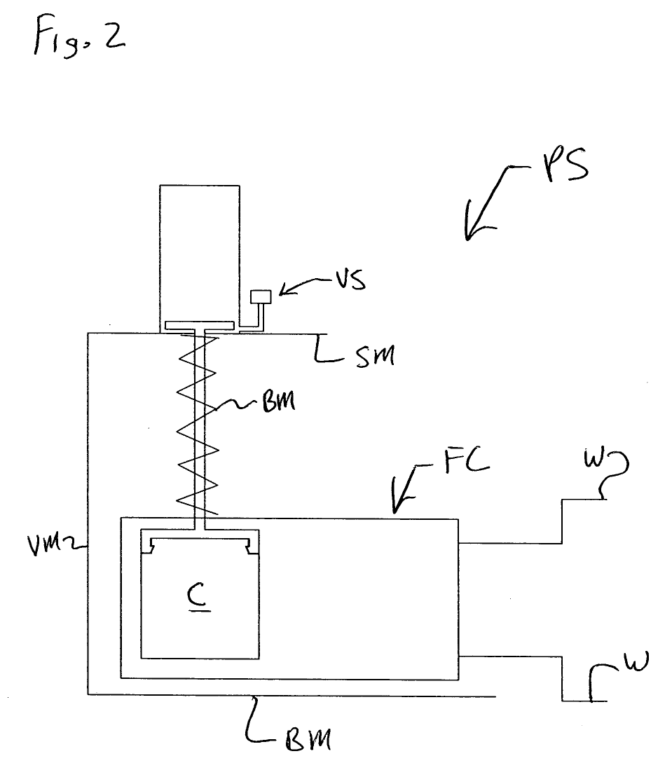

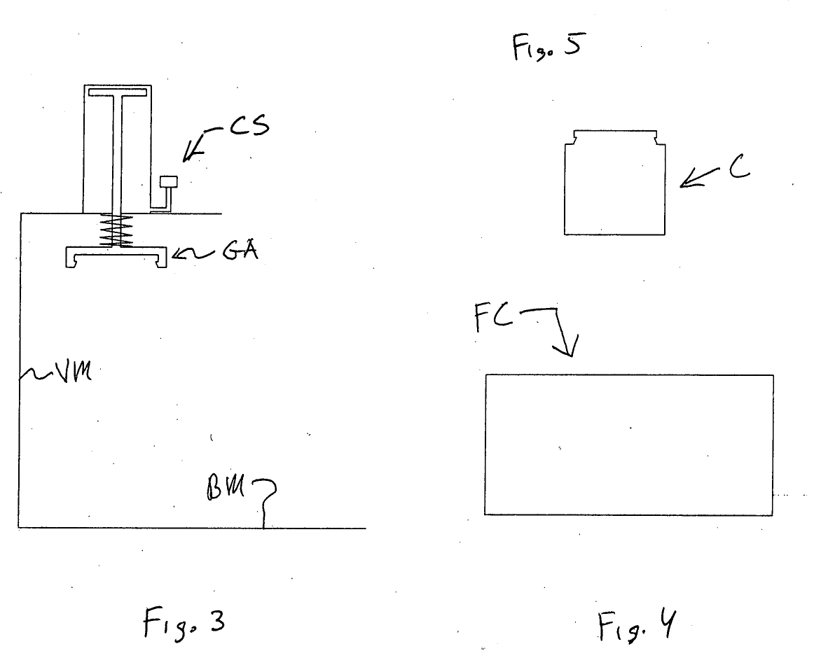

According to the non-limiting embodiment of FIGS. 1-5, the cartridge C is mounted to a guiding arrangement GA which ensures that the cartridge C is correctly aligned with the desired mating configuration of the fuel cell FC. In this way, when it is desired to connect the cartridge C to the fuel cell FC, the guiding arrangement GA ensures that the port(s) (which will be described in detail later on) of the cartridge C are properly mated with the port(s) of the fuel cell FC. In this regard, the guiding arrangement GA can ensure that the cartridge C has the correct rotational position as well as the correct vertical and horizontal position when the cartridge C is moved from the position shown in FIG. 1 to the final or connected position shown in FIG. 2. The guiding arrangement GA is coupled to a connecting system CS which is configured to cause the cartridge C to be connected to the fuel cell FC at a desired point in time and/or under certain desired predetermined conditions.

According to the non-limiting embodiment of FIGS. 1-5, the connecting system CS utilizes a piston P which is connected to a piston rod PR and which is slidably and sealingly engaged with a cylinder CY. A biasing member BM can optionally be utilized to bias the guiding arrangement GA downward towards a connected position. A venting system VS is used to cause the guiding arrangement GA to move downwards thereby ensuring that the cartridge C is properly connected to the fuel cell FC. The venting system VS can function as follows: until the venting system VS is opened, the fluid medium (e.g., air, liquid, or other flowable materials) located in the cylinder CY underneath the piston P prevents the piston P (and also the guiding arrangement GA and the cartridge C) from moving downwards. However, when opened, the medium can flow out of the cylinder CY and the venting system VS owing to the force of gravity (due mainly to the weight of the cartridge C) and/or under the biasing force of the biasing member BM. This allows the piston P to descend downwards within the cylinder CY. Because the guiding arrangement GA and the cartridge C are connected to the piston P, e.g., via the piston rod PR, the guiding arrangement GA and the cartridge C also descend downwards. Once venting is started, the cartridge C will descend until it becomes connected to the fuel cell FC. As will be described later on, once the cartridge C fully mates with the fuel cell FC, the contents of the cartridge C can automatically transfer to the fuel cell FC.

In the embodiment of FIGS. 1-5, the fuel cell FC and the cartridge C are arranged on a frame system FS which can be removably statically mounted to a particular location (e.g., within a portion of the cell tower). The frame system FS utilizes a base member BM which supports the fuel cell FC and which can include stops (not shown) which ensure that the fuel cell FC is correctly located below the cartridge C. The frame system FS also utilizes a vertical member VM which supports a support member SM. The support member SM supports the connecting system CS. It is preferred that the system shown in FIG. 1 be installed as a modular unit. This way, the system PS can function, when activated, to the point when the fuel cell FC has substantially exhausted of its power capabilities (or reaches the point where the voltage and/or current drop to a predetermined point) and/or is utilized a single time. Then, the unit can be sent back to, e.g., the manufacturer, for possible refurbishment. A new unit can then be installed in place of the used unit.

According to one aspect of the invention, the fuel cell system PS of FIGS. 1-5 is a stand-alone, stationary unit, which can generate from the 10s of watts to the 1,000s of watts. The fuel cell FC preferably incorporates one or more of the components and technologies which are described, e.g., in U.S. Pat. Nos. 6,554,877, 6,758,871 and 7,004,207 and in pending U.S. Patent Application Nos. US2002/0076602 A1, US2002/0142196 A1, 2003/0099876 A1, Ser. No. 10/757,849 (US2005/0155279 A1), Ser. No. 10/758,081 (US2005/0155668 A1), Ser. No. 10/634,806 (US2005/0058882 A1), Ser. No. 10/758,080 (US2005/0158609 A1), Ser. No. 10/803,900 (US2005/0206342 A1), Ser. No. 10/824,443 (US2005/0233190 A1), Ser. No. 10/796,305 (US2004/0241521 A1), Ser. No. 10/849,503 (US2005/0260481 A1), Ser. No. 11/132,203 (US2006/0047983 A1), Ser. No. 10/959,763 (US2006/0078783 A1), Ser. No. 10/941,020 (US2006/0057435 A1), Ser. No. 11/226,222 (US2006/0057437 A1), Ser. Nos. 11/384,364, 11/384,365, 11/325,466, 11/325,326 and 60/781,340. The power system PS is also more preferably a high powered fuel cell system for portable, auxiliary and remote power requirements. Preferably, the fuel cell system PS has a target power output of between approximately 20 watts to approximately 5000 watts for a limited use time of between approximately 1 hour and approximately 500 hours.

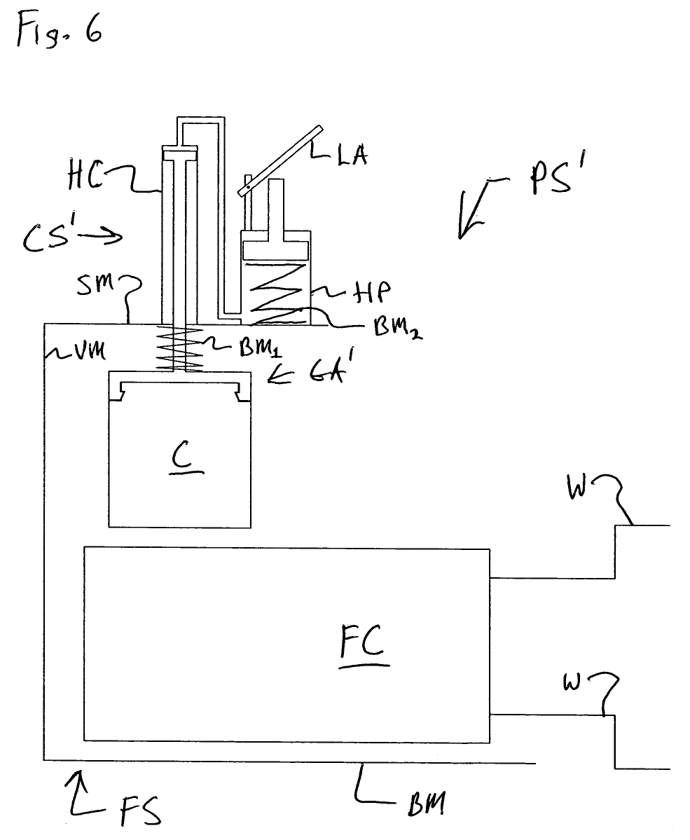

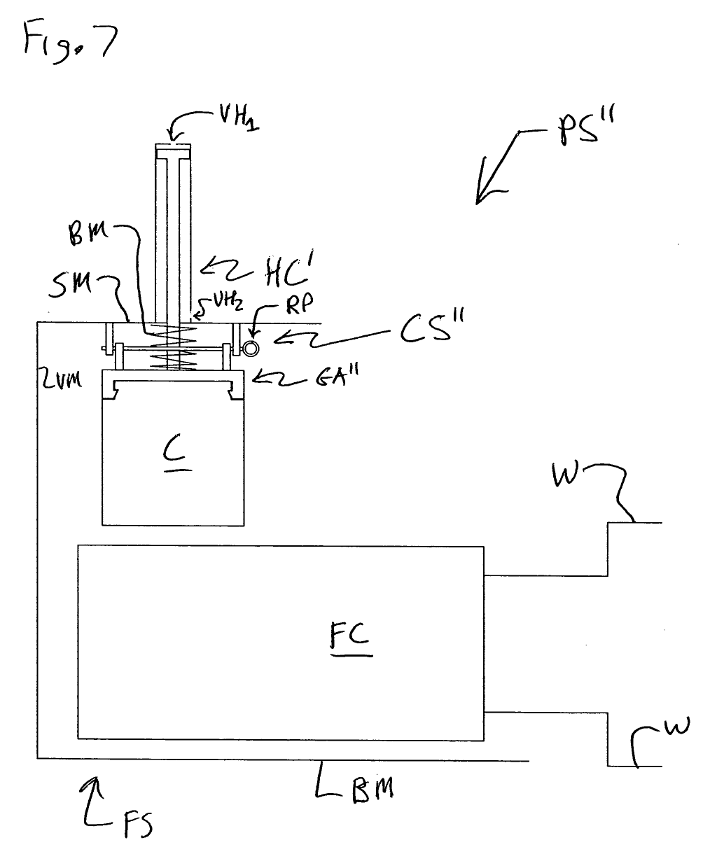

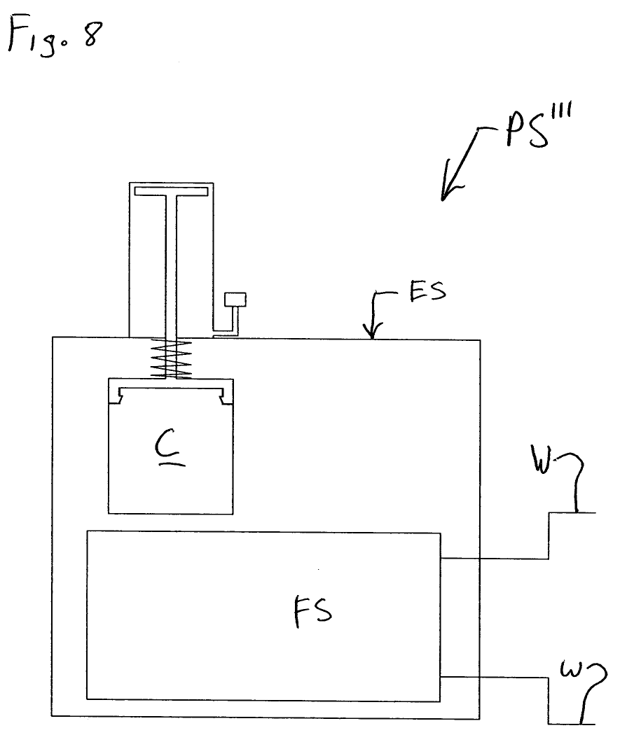

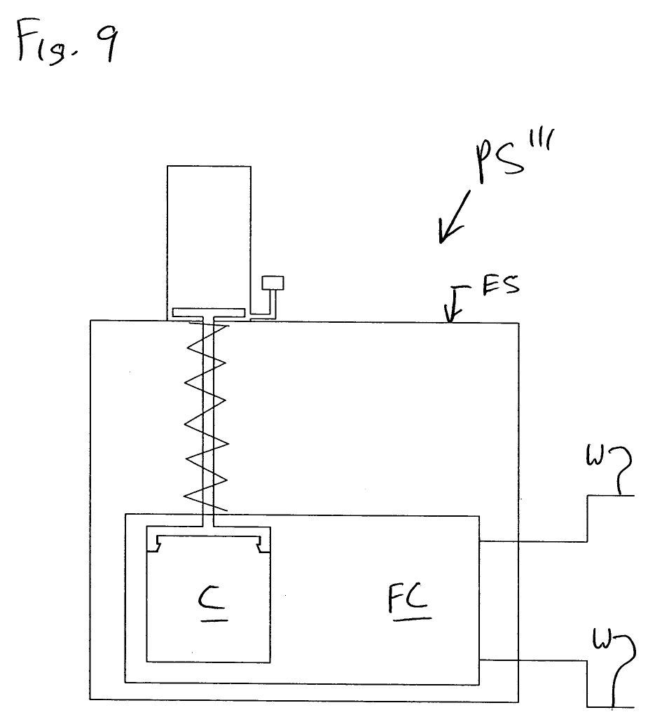

FIG. 6 shows a second non-limiting embodiment of a stand-alone fuel cell power system PS′. As in the previous embodiment, the power system PS′ utilizes a fuel cell FC and cartridge C arrangement. The fuel cell FC includes an outer housing which can be generally rectangular in shape. Of course, the fuel cell FC can have any other desired shape including, but not limited to polygonal, linear, oval, round, and/or curvilinear shapes. A plurality of wires W can have one end connected directly to the housing of the fuel cell FC or alternatively to a bus bar (not shown) which itself is electrically connected to the fuel cell FC. The bus bar or fuel cell FC can then be connected to a main bus bar or power circuit which feeds the source (e.g., a cell phone tower) electrical power for operation. As is shown in FIG. 6, the cartridge C is arranged above the fuel cell FC in a position which will allow the cartridge C to be correctly positioned within and/or mounted to the fuel cell FC at a desired time. Since the cartridge C contains certain active ingredients (e.g., fuel or fuel concentrate and optionally electrolyte) which the fuel cell FC needs to begin producing electrical power, until the cartridge C is mated with the fuel cell FC and until the contents of the cartridge C are transferred to the proper chambers of the fuel cell FC, the fuel cell FC does not produce power and provides an open circuit to wires W. When it is desired to place the fuel cell FC into operation, the cartridge C can be lowered into position within and/or on the fuel cell FC such that the contents of the cartridge C are safely and properly transferred to the fuel cell FC.

According to the non-limiting embodiment of FIG. 6, the cartridge C is mounted to a guiding arrangement GA′ which ensures that the cartridge C is correctly aligned with the desired mating configuration of the fuel cell FC. In this way, when it is desired to connect the cartridge C to the fuel cell FC, the guiding arrangement GA′ ensures that the port(s) (which will be described in detail later on) of the cartridge C are properly mated with the port(s) of the fuel cell FC. In this regard, the guiding arrangement GA′ can ensure that the cartridge C has the correct rotational position as well as the correct vertical and horizontal position when the cartridge C is moved from the position shown in FIG. 6 to the final or connected position (not shown). The guiding arrangement GA is coupled to a connecting system CS′ which is configured to cause the cartridge C to be connected to the fuel cell FC at a desired point in time and/or under certain desired predetermined conditions.

According to the non-limiting embodiment of FIG. 6, the connecting system CS′ utilizes a pneumatic or hydraulic piston/cylinder unit HC which is in fluid connection (e.g., via one or more conduits) to a pneumatic or hydraulic pump HP. The pump HP can be activated by a pivotally mounted lever arrangement LA such that movement of the lever LA downwards causes the pump HP to move downward, which in turn causes the medium in the pump HP to transfer under pressure into the piston/cylinder unit HC. A biasing member BM₁ can optionally be utilized to bias the guiding arrangement GA′ downward towards a connected position. To counteract the spring force of biasing mechanism BM₁ and to ensure that the cartridge C is not inadvertently caused to mate with the fuel cell FC, another biasing member BM₂ is arranged within the pump HP and prevents inadvertent downward movement of the piston of the pump HP. The lever arrangement LA can function as follows: until the lever arrangement LA is moved downwards, the fluid medium (e.g., air, liquid, or other flowable materials) located in the pump HP is prevented by the biasing member BM₂ from moving or transferring into the unit HC. However, when moved downwards, the medium is forced out of the pump HP and into the unit HC owing to the hydraulic pressure generated within the pump HP. This transfer of fluid under pressure forces the piston of the unit HC to descend downwards within the cylinder of unit HC. Because the guiding arrangement GA′ and the cartridge C are connected to the piston, e.g., via a piston rod, the guiding arrangement GA′ and the cartridge C also descend downwards. The cartridge C should then descend until it becomes connected to the fuel cell FC. As will be described later on, once the cartridge C fully mates with the fuel cell FC, the contents of the cartridge C can automatically transfer to the fuel cell FC.

As was the case with the previous embodiment, the embodiment of FIG. 6 arranges the fuel cell FC and the cartridge C on a frame system FS which can be removably statically mounted to a particular location (e.g., within a portion of the cell tower). The frame system FS utilizes a base member BM which supports the fuel cell FC and which can include stops (not shown) which ensure that the fuel cell FC is correctly located below the cartridge C. The frame system FS also utilizes a vertical member VM which supports a support member SM. The support member SM supports the connecting system CS. It is preferred that the system shown in FIG. 6 be installed as a modular unit. This way, the system PS′ can function, when activated, to the point when the fuel cell FC has substantially exhausted of its power capabilities (or reaches the point where the voltage and/or current drop to a predetermined point) and/or is utilized a single time. Then, the unit can be sent back to, e.g., the manufacturer, for possible refurbishment. A new unit can then be installed in place of the used unit.

According to one aspect of the invention, the fuel cell system PS′ of FIG. 6 is a stand-alone, stationary unit, which can generate from the 10s of watts to the 1,000s of watts. The fuel cell FC preferably incorporates components and telchnologies which are described, e.g., in U.S. Pat. Nos. 6,554,877, 6,758,871 and 7,004,207 and in pending U.S. patent application Ser. No. 10/757,849 (US2005/0155279), Ser. No. 10/758,081 (US2005/0155668), Ser. No. 10/634,806 (US2005/0058882 A1), Ser. No. 10/758,080 (US2005/0158609 A1), Ser. No. 10/803,900 (US2005/0206342 A1) Ser. No. 10/824,443 (US2005/0233190 A1), Ser. No. 10/796,305 (US2004/0241521 A1) Ser. No. 10/849,503 (US2005/0260481 A1), Ser. No. 11/132,203 (US2006/0047983 A1), Ser. No. 10/959,763 (US2006/0078783 A1), Ser. No. 10/941,020 (US2006/0057435 A1), Ser. No. 11/226,222 (US2006/0057437 A1), US2002/0076602 A1, US2002/0142196 A1, 2003/0099876 A1, Ser. Nos. 11/384,364, 11/384,365, 11/325,466, 11/325,326 and 60/781,340. The power system PS′ is also more preferably a high powered fuel cell system for portable, auxiliary and remote power requirements. Preferably, the fuel cell system PS′ has a target power output of between approximately 20 watts to approximately 5,000 watts for a limited use time of between approximately 1 hour and approximately 500 hours.

FIG. 7 shows a third non-limiting embodiment of a stand-alone fuel cell power system PS′. As in the previous embodiment, the power system PS′ utilizes a fuel cell FC and cartridge C arrangement. The fuel cell FC includes an outer housing which can be generally rectangular in shape. Of course, the fuel cell FC can have any other desired shape including, but not limited to polygonal, linear, oval, round, and/or curvilinear shapes. A plurality of wires W can have one end connected directly to the housing of the fuel cell FC or alternatively to a bus bar (not shown) which itself is electrically connected to the fuel cell FC. The bus bar or fuel cell FC can then be connected to a main bus bar or power circuit which feeds the source (e.g., a cell phone tower) electrical power for operation. As is shown in FIG. 7, the cartridge C is arranged above the fuel cell FC in a position which will allow the cartridge C to be correctly positioned within and/or mounted to the fuel cell FC at a desired time. Since the cartridge C contains certain active ingredients (e.g., fuel or fuel concentrate and optionally electrolyte) which the fuel cell FC needs to begin producing electrical power, until the cartridge C is mated with the fuel cell FC and until the contents of the cartridge C are transferred to the proper chambers of the fuel cell FC, the fuel cell FC does not produce power and provides an open circuit to wires W. When it is desired to place the fuel cell FC into operation, the cartridge C can be lowered into a position within and/or on the fuel cell FC such that the contents of the cartridge C are safely and properly transferred to the fuel cell FC.

According to the non-limiting embodiment of FIG. 7, the cartridge C is mounted to a guiding arrangement GA″ which ensures that the cartridge C is correctly aligned with the desired mating configuration of the fuel cell FC. In this way, when it is desired to connect the cartridge C to the fuel cell FC, the guiding arrangement GA″ ensures that the port(s) (which will be described in detail later on) of the cartridge C are properly mated with the port(s) of the fuel cell FC. In this regard, the guiding arrangement GA″ can ensure that the cartridge C has the correct rotational position as well as the correct vertical and horizontal position when the cartridge C is moved from the position shown in FIG. 7 to the final or connected position (not shown). The guiding arrangement GA″ is coupled to a connecting system CS″ which is configured to cause the cartridge C to be connected to the fuel cell FC at a desired point in time and/or under certain desired predetermined conditions.

According to the non-limiting embodiment of FIG. 7, the connecting system CS″ utilizes a damping piston/cylinder unit HC′ which ensures that the cartridge C is guided downwardly at a predetermined rate of speed via. The unit HC utilizes vent openings VH₁ and VH₂ which allows a controlled amount of air to enter into the unit HC′. This ensures that the cartridge C is moved downwardly with a predetermined speed. The unit HC′ can be activated by a release of pin RP which, in the position shown in FIG. 7, engages flanges fixed to the support member SM and flanges fixed to the guiding arrangement GA″. When the release pin RP is pulled and/or moved out of engagement with the flanges, the guiding arrangement GA″ becomes free to move downwards, limited only by the damping provided by the unit HC′. A biasing member BM can optionally be utilized to bias the guiding arrangement GA″ downward towards a connected position. The pin RP thus prevents inadvertent downward movement of the cartridge C. The connecting system CS″ can function as follows: until the pin RP is moved out of engagement with the flanges of member SP and arrangement GA″, the piston of the unit HC′ is prevented from moving. However, when the pin RP is removed, the piston of the unit HC′ is allowed to move downwards owing to the force of gravity (due mainly to the weight of the cartridge C). Because the guiding arrangement GA″ and the cartridge C are connected to the piston, e.g., via a piston rod, the guiding arrangement GA″ and the cartridge C also descend downwards. The cartridge C will then continue to descend until it becomes connected to the fuel cell FC. As will be described later on, once the cartridge C fully mates with the fuel cell FC, the contents of the cartridge C can automatically transfer to the fuel cell FC.

As was the case with the previous embodiment, the embodiment of FIG. 7 arranges the fuel cell FC and the cartridge C on a frame system FS which can removably statically mounted to a particular location (e.g., within a portion of the cell tower). The frame system FS utilizes a base member BM which supports the fuel cell FC and which can include stops (not shown) which ensure that the fuel cell FC is correctly located below the cartridge C. The frame system FS also utilizes a vertical member VM which supports a support member SM. The support member SM supports the connecting system CS″. It is preferred that the system shown in FIG. 7 be installed as a modular unit. This way, the system PS′ can function, when activated, to the point when the fuel cell FC has substantially exhausted of its power capabilities (or reaches the point where the voltage and/or current drop to a predetermined point) and/or is utilized a single time. Then, the unit can be sent back to, e.g., the manufacturer, for possible refurbishment. A new unit can then be installed in place of the used unit.

According to one aspect of the invention, the fuel cell system PS′ of FIG. 7 is a stand-alone, stationary unit, which can generate from the 10s of watts to the 1,000s of watts. The fuel cell FC preferably incorporates components and telchnologies which are described, e.g., in U.S. Pat. Nos. 6,554,877, 6,758,871 and 7,004,207 and pending U.S. patent application Ser. No. 10/757,849 (US2005/0155279), Ser. No. 10/758,081 (US2005/0155668), Ser. No. 10/634,806 (US2005/0058882), Ser. No. 10/758,080 (US2005/0158609), Ser. No. 10/803,900 (US2005/0206342) Ser. No. 10/824,443 (US2005/0233190), Ser. No. 10/796,305 (US2004/0241521) Ser. No. 10/849,503 (US2005/0260481), Ser. No. 11/132,203 (US2006/0047983), Ser. No. 10/959,763 (US2006/0078783), Ser. No. 10/941,020 (US2006/0057435), Ser. No. 11/226,222 (US2006/0057437), Ser. Nos. 11/384,364, 11/384,365, 11/325,466, 11/325,326 and 60/781,340. The power system PS′ is also more preferably a high powered fuel cell system for portable, auxiliary and remote power requirements. Preferably, the fuel cell system PS′ has a target power output of between approximately 20 Watts to approximately 5,000 Watts for a limited use time of between approximately 1 hour and approximately 500 hours.

FIGS. 8 and 9 show a fourth non-limiting embodiment of a stand-alone fuel cell power system PS^{III}. As in the previous embodiment, the power system PS^{III} utilizes a fuel cell FC and cartridge C arrangement. The fuel cell FC includes an outer housing which can be generally rectangular in shape. Of course, the fuel cell FC can have any other desired shape including, but not limited to polygonal, linear, oval, round, and/or curvilinear shapes. A plurality of wires W can have one end connected directly to the housing of the fuel cell FC or alternatively to a bus bar (not shown) which itself is electrically connected to the fuel cell FC. The bus bar or fuel cell FC can then be connected to a main bus bar or power circuit which feeds the source (e.g., a cell phone tower) electrical power for operation. As is shown in FIG. 8, the cartridge C is arranged above the fuel cell FC in a position which will allow the cartridge C to be correctly positioned within and/or mounted to the fuel cell FC at a desired time. Since the cartridge C contains certain active ingredients (e.g., fuel or fuel concentrate and optionally electrolyte) which the fuel cell FC needs to begin producing electrical power, until the cartridge C is mated with the fuel cell FC and until the contents of the cartridge C are transferred to the proper chambers of the fuel cell FC, the fuel cell FC does not produce power and provides an open circuit to wires W. When it is desired to place the fuel cell FC into operation, the cartridge C can be lowered into position within and/or on the fuel cell FC (see FIG. 9) such that the contents of the cartridge C are safely and properly transferred to the fuel cell FC. This embodiment is similar to that of FIGS. 1-5 except that the frame system FS is replaced with an enclosure system ES to prevent tampering with the power system PS^{III}. Although not shown, the power system PS′ can utilize a mechanism which indicates to a user that the power system PS^{III} has been previously activated and must be replaced. Such a mechanism can be as simple as making one of the walls of the enclosure ES transparent so that the user can visually see that the cartridge C has been moved into engagement with the fuel cell FC.

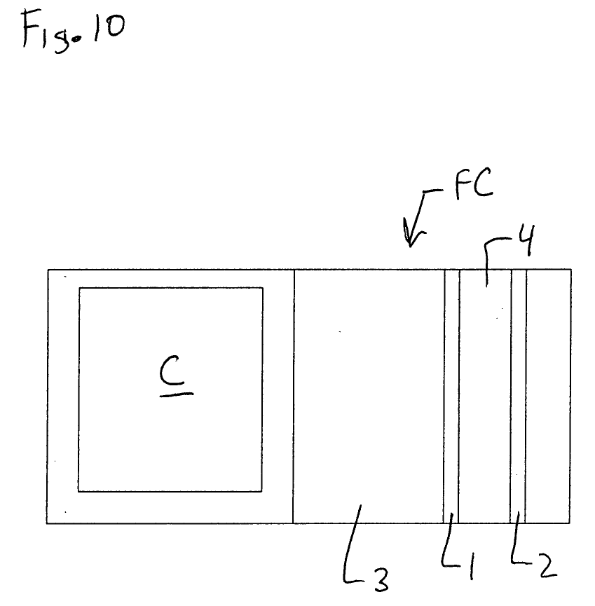

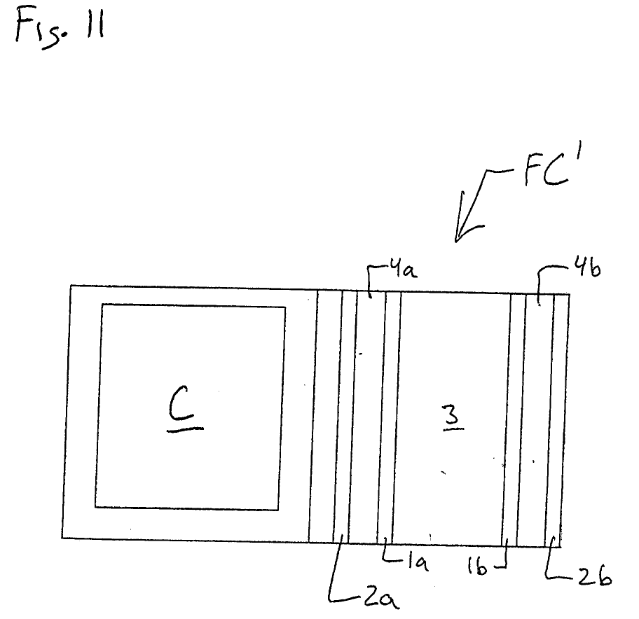

FIG. 10 shows one non-limiting embodiment of the fuel cell FC which can be utilized in the power supply systems disclosed herein. The fuel cell FC shown in FIG. 10 is a single configuration type which includes a single anode 1 and a single cathode 2. A fuel chamber 3 is arranged on the anode side and an electrolyte chamber 4 is arranged between the anode 1 and the cathode 2. Cathode 2 may be (and preferably is) an air-breathing cathode. The fuel chamber 3 is configured to receive the fuel contents of the cartridge C once the cartridge C is mated with the fuel cell FC. The electrolyte chamber 4 is configured to receive the electrolyte contents of the cartridge C once the cartridge C is mated with the fuel cell FC. Prior to insertion of the cartridge C into the fuel cell FC, the fuel chamber 3 and electrolyte chamber 4 remain essentially empty or free of the fuel and electrolyte. Alternatively, the fuel chamber 3 may contain at least a part of the liquid diluent (e.g., water) for a fuel concentrate in the cartridge C and/or the electrolyte chamber 4 may contain at least a part of the electrolyte (e.g., a gel electrolyte) or at least a component of the electrolyte (e.g., water or a solid alkali metal hydroxide).

By way of non-limiting example, one or more of the fuel cells FC shown in FIG. 10 can be used on any of the herein disclosed power supply systems, and can have the following characteristics: Watt-hour output range from approximately 500 to approximately 50,000; voltage from approximately 2 volts to approximately 250 volts, e.g., from approximately 2 volts to approximately 20 volts, or from approximately 110 volts to approximately 230 volts; the exposed area of the anode 1 of the fuel cell FC can be from approximately 200 cm² to approximately 2,000 cm²; the exposed area of the cathode 2 can be from approximately 200 cm² to approximately 2,000 Cm²; the volume of fuel chamber 3 can be from approximately 0.5 liters to approximately 20 liters for each fuel cell FC and from approximately 2 liters to approximately 200 liters for the entire power supply system (when utilizing a plurality of fuel cells); the volume of the electrolyte (e.g., liquid or gel electrolyte) chamber 4 of each fuel cell unit can be from approximately 0.01 liters to approximately 2 liters, and from approximately 0.2 liters to approximately 40 liters for the entire stationary power supply system (when utilizing a plurality of fuel cells).

FIG. 11 shows another non-limiting embodiment of the fuel cell FC′ which can be utilized in the power supply systems disclosed herein. The fuel cell FC′ shown in FIG. 11 is a dual configuration type which includes two anodes 1a and 1b and two cathodes 2a and 2b. A fuel chamber 3 is arranged between the anodes 1a and 1b and two electrolyte chambers 4a and 4b are arranged between the anodes 1a and 1b and the cathodes 2a and 2b. The fuel chamber 3 is configured to receive the fuel contents of the cartridge C once the cartridge C is mated with the fuel cell FC′. The electrolyte chambers 4a and 4b are configured to receive the electrolyte contents of the cartridge C once the cartridge C is mated with the fuel cell FC′. Prior to insertion of the cartridge C into the fuel cell FC′, the fuel chamber 3 and electrolyte chambers 4a and 4b remain essentially empty or free of the fuel and electrolyte.

By way of non-limiting example, one or more of the fuel cells FC′ shown in FIG. 11 can be used on any of the herein disclosed power supply systems, and can have the following characteristics: Watt-hour output range from approximately 500 to approximately 50,000; voltage from approximately 2 volts to approximately 250 volts, e.g., from approximately 2 volts to approximately 20 volts, or from approximately 110 volts to approximately 230 volts; the exposed area of the anodes 1a and b of the fuel cell FC′ can be from approximately 200 cm² to approximately 2,000 cm²; the exposed area of the cathodes 2a and 2b can be from approximately 200 cm² to approximately 2,000 cm²; the volume of the fuel chamber 3 can be from approximately 0.5 liters to approximately 20 liters for each fuel cell FC′ and from approximately 2 liters to approximately 200 liters for the entire power supply system (when utilizing a plurality of fuel cells); the total volume of electrolyte (e.g., liquid or gel electrolyte) chambers 4a and 4b of each fuel cell unit can be from approximately 0.01 liters to approximately 2 liters, and from approximately 0.2 liters to approximately 40 liters for the entire stationary power supply system (when utilizing a plurality of fuel cells).

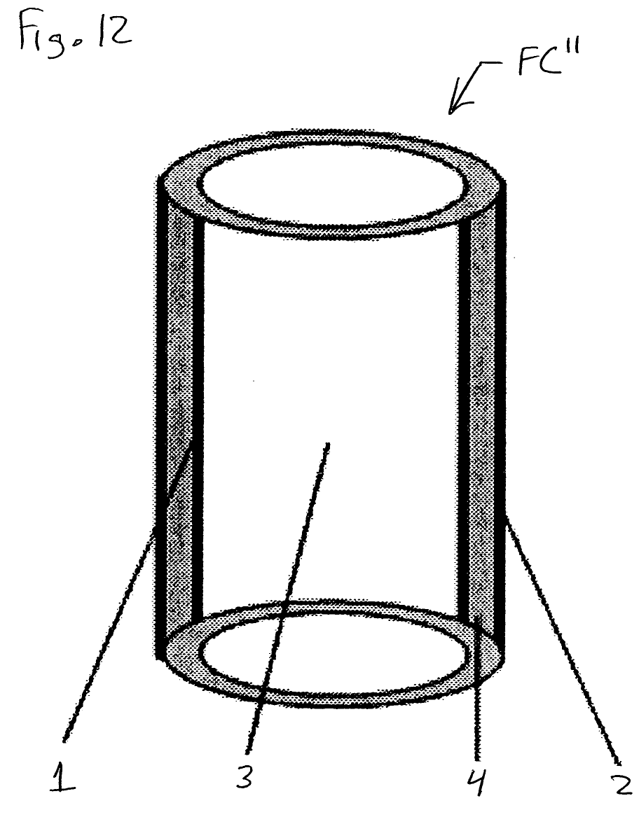

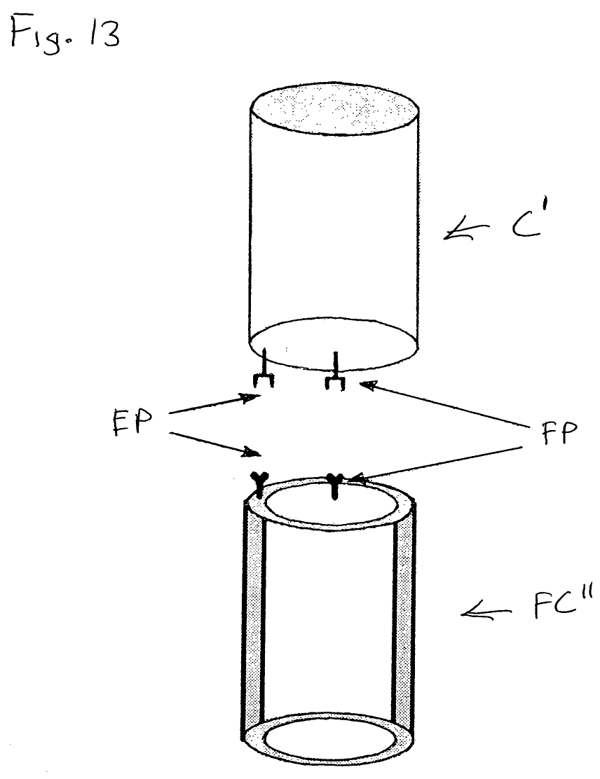

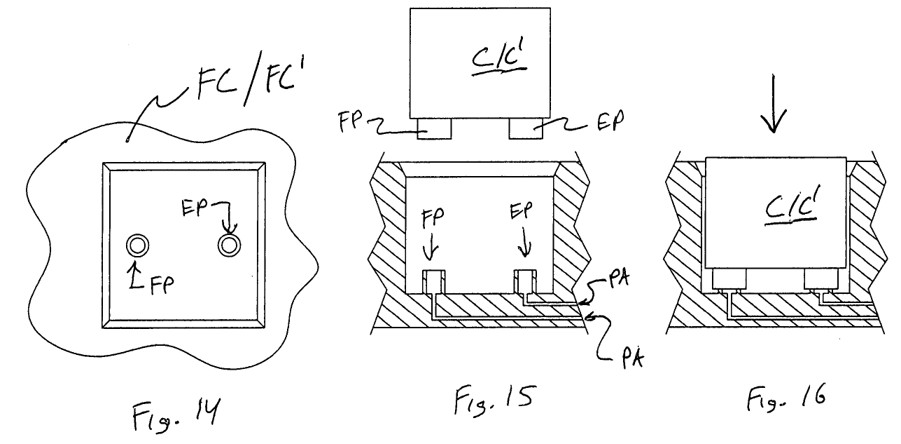

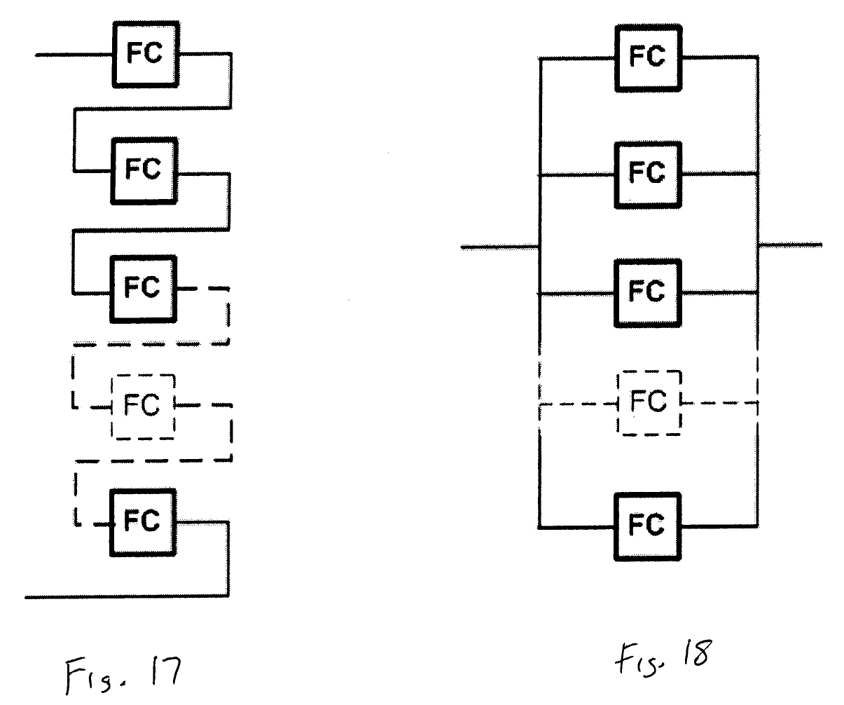

FIGS. 12 and 13 show still another non-limiting embodiment of the fuel cell FC″ and cartridge C′ which can be utilized in the power supply systems disclosed herein. The fuel cell FC″ shown in FIGS. 12 and 13 is a cylindrical module configuration type which includes a cylindrical anode 1 and a cylindrical cathode 2. A cylindrical fuel chamber 3 is arranged within the anode cylinder 1 and an electrolyte chamber 4 is arranged between the anode cylinder 1 and the cathode cylinder 2. The fuel chamber 3 is configured to receive the fuel contents of the cartridge C′ once the cartridge C′ is mated with the fuel cell FC″. The electrolyte chamber 4 is configured to receive the electrolyte contents of the cartridge C′ once the cartridge C′ is mated with the fuel cell FC″. Prior to mating of the cartridge C′ onto the fuel cell FC″, the fuel chamber 3 and electrolyte chamber 4 remain essentially empty or free of the fuel and electrolyte. Transfer of the fuel from the fuel chamber of the cartridge C′ to the fuel chamber 3 of the fuel cell FC″ occurs via fuel ports FP and transfer of the electrolyte from the electrolyte chamber of the cartridge C′ to the electrolyte chamber 4 of the fuel cell FC″ occurs via electrolyte ports EP.

By way of non-limiting example, one or more of the fuel cells FC″ shown in FIGS. 12 and 13 can be used on any of the herein disclosed power supply systems, and can have the following characteristics: Watt-hour output range from approximately 500 to approximately 50,000; voltage from approximately 2 volts to approximately 250 volts, e.g., from approximately 2 volts to approximately 20 volts, or from approximately 110 volts to approximately 230 volts; the exposed area of the anode 1 of the fuel cell FC″ can be from approximately 200 cm² to approximately 2,000 cm²; the exposed area of the cathode 2 can be from approximately 200 cm² to approximately 2,000 cm²; the volume of fuel chamber 3 can be from approximately 0.5 liters to approximately 20 liters for each fuel cell FC″ and from approximately 2 liters to approximately 200 liters for the entire power supply system (when utilizing a plurality of fuel cells); the volume of the electrolyte (e.g., liquid or gel electrolyte) chamber 4 of each fuel cell unit can be from approximately 0.01 liters to approximately 2 liters, and from approximately 0.2 liters to approximately 40 liters for the entire stationary power supply system (when utilizing a plurality of fuel cells).

FIGS. 14-16 show one non-limiting way in which the fuel cell FC/FC′ and cartridge C/C′ described above can interface with each other so that the fuel or fuel components and electrolyte or electrolyte components are safely and properly transferred from the cartridge to the fuel cell. The fuel cell FC/FC′ has a generally rectangular-shaped opening which is sized to receive (with a clearance) the correspondingly shaped cartridge C/C′. To facilitate insertion of the cartridge C/C′ into the opening of the fuel cell FC/FC′, the opening can include a tapered entrance. The corresponding shape of the opening and the cartridge C/C′ ensure that the fuel ports FP and electrolyte ports EP of the cartridge C/C′ and the fuel cell FC/FC′ are aligned and mate in the proper sealed manner. The fuel cell FC/FC′ utilizes integrally formed passages PA which allow the contents of the proper chambers of the cartridge C/C′ to flow to the proper chambers of the fuel cell FC/FC′. For example, the fuel chamber of the fuel cell FC/FC′ will receive the fuel contents of the cartridge C/C′ once the cartridge C/C′ is mated with the fuel cell FC/FC′ and the electrolyte chamber of the fuel cell FC/FC′ will receive the electrolyte contents of the cartridge C/C′ once the cartridge C/C′ is mated with the fuel cell FC/FC′. Prior to mating of the cartridge C/C′ onto the fuel cell FC/FC′, the fuel chamber and electrolyte chamber of the fuel cell FC/FC′ remain essentially empty or free of the fuel and electrolyte. Alternatively, the fuel chamber 3 may contain at least a part of the liquid diluent (e.g., water) for a fuel concentrate in the cartridge C/C′ and/or the electrolyte chamber 4 may contain at least a part of the electrolyte (e.g., a gel electrolyte) or at least a component of the electrolyte (e.g., water or solid alkali metal hydroxide).

FIG. 17 shows one non-limiting way in which the fuel cell power supply system can be configured. According to this embodiment, a number of fuel cell units FC are arranged or connected (with e.g., electrical conduits, wires, etc.) in series such that at least one of the units FC (i.e., the unit which is shown in broken lines) can be activated as described herein. Since the configuration is arranged in series, power supply from all of the units can be prevented until the designated unit(s) are intentionally activated.

FIG. 18 shows another non-limiting way in which the fuel cell power supply system can be configured. According to this embodiment, a number of fuel cell units FC are arranged or connected in parallel such that at least one of the units FC (i.e., the unit which is shown in broken lines) can be activated as described herein. Since the configuration is arranged in parallel, power supply occurs from all of the units except for the designated unit(s), which can then be intentionally activated when additional power is required.

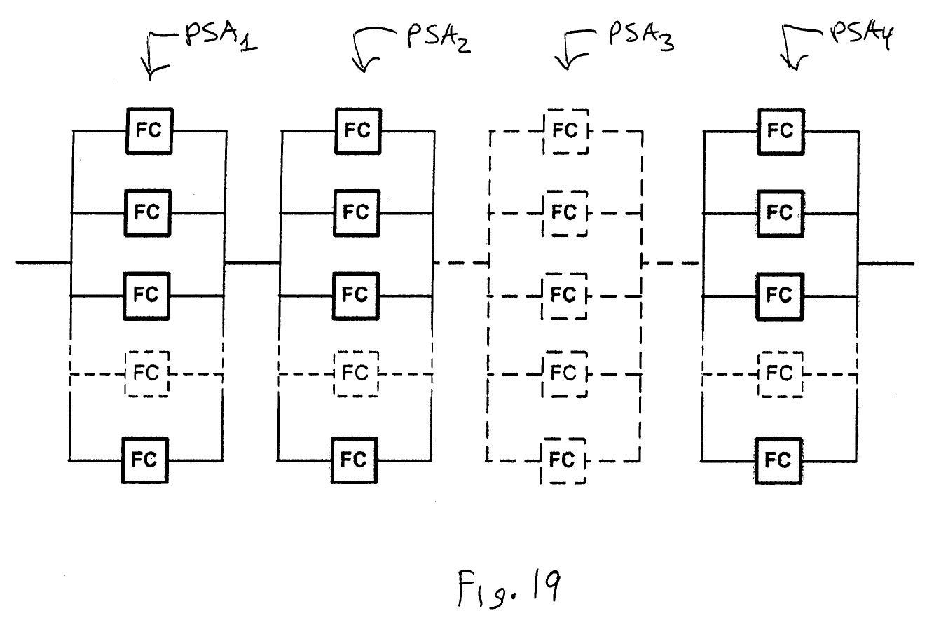

FIG. 19 shows another non-limiting way in which the fuel cell power supply system can be configured. According to this embodiment, the fuel cell power supply system combines units FC arranged in series with units FC arranged in parallel. By way of non-limiting example, a plurality of sub-power-supply arrangements PSA₁, PSA₂, PSA₃, and PSA₄ are arranged in series wherein each of the sub-power-supply arrangements PSA₁, PSA₂, PSA₃, and PSA₄ comprise a plurality of fuel cell units FC arranged in parallel. At least one of the sub-power-supply arrangements PSA₃ can be activated as described herein. That is, all of the units FC of the designated power-supply arrangement PSA₃ can be activated (i.e., simultaneously connected with a cartridge as described herein) when it is desired to utilize power from all of the series connected power-supply arrangements PSA₁, PSA₂, PSA₃, and PSA₄. Since the configuration is arranged in series, power supply from all of the power-supply arrangements PSA₁, PSA₂, PSA₃, and PSA₄ can be prevented until the designated power-supply arrangement(s) PSA₃ is intentionally activated.

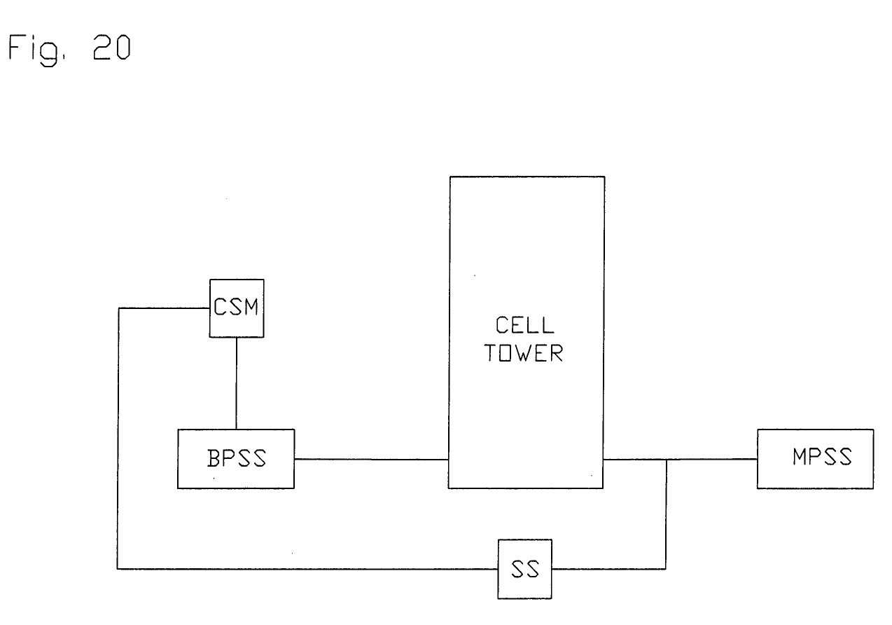

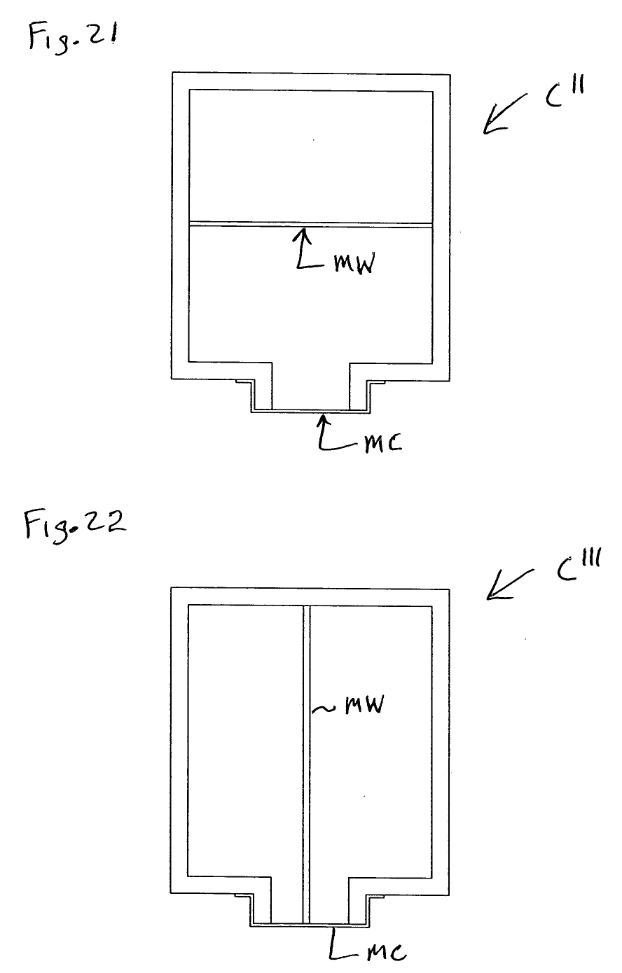

FIG. 20 shows one non-limiting application of the back-up power supply system connected to a cell phone tower. The system utilizes controller CSM which functions to initiate or activate the back-up power system BPSS of the type described above. The back-up power system BPSS is configured and generally matched to provide the necessary power (voltage and current) requirement generally provided by the main power supply system MPSS, i.e., the power typically provided by a utility company. Until the back-up power supply BPSS is activated, the cell tower (or other device requiring back-up power), is powered by the main power source MPSS via input circuit breaker arranged in an electrical box of the cell tower. The cell tower can utilize, among other things, filtering inductors and switches. During normal operation, the cell tower receives continuous current and remains operating by the main power source MPSS. The system controller CSM monitors and controls the state of the switches, the input circuit breaker and the back-up power system BPSS. The system controller CSM can also monitor frequency, voltage and current at several points in the system to maintain a continuous status of the line power available to the cell tower. A number of parameters may be monitored, e.g., voltage and current, via the sensing system SS.

In the event of a voltage deviation or outage (a power interrupt condition), the back-up power system BPSS becomes the power supply for the cell tower. If necessary, an inverter may be utilized to convert the direct current voltage of the back-up power system BPSS to a stable alternating current voltage which is required by the cell tower. Of course, if the cell tower operates by DC current, the back-up power system BPSS can be connected directly to the electrical box of the cell tower. If the system controller CSM determines that line power deviation exceeds a predetermined threshold, the input circuit breaker can be opened, isolating any main power source parasitic loads and the back-up power system BPSS is activated. Rapid, coordinated switching provides for a relatively seamless transfer of power from the main power source MPSS to the inverter and/or the back-up power system BPSS. Preferably, the system is configured to keep the system from initiating the back-up power system BPSS, as would be the case, for example, where there is a very brief transitory outage in voltage.

Any rectifiers which are utilized are preferably operable over a wide frequency and voltage range. Any inverters which are used should also be operable over a wide input range in order to convert the direct current voltage to a stable alternating current voltage while maintaining .+−0.0.5 Hz frequency deviation under the direction of the system controller CSM. Although many conversion techniques are known to those skilled in the art, a preferred technique for conversion from direct to alternating current voltage is to use pulse-width modulation. By properly designing the system, the power supplied to the cell tower in back-up mode should minimize the period of time for bridging the time interval between the detection of power outage, and the start and stabilization of the back-up power system BPSS. Once the main power source MPSS is restored, the system controller CSM can preferably detect its presence and initiate a coordinated sequence to transfer power from the back-up power system BPSS back to the main power source MPSS. Techniques for performing this feature are known to those skilled in the art and, as such, will not be discussed in further detail.

FIGS. 21-26 show non-limiting configurations for the cartridge module C^{II}, C^{III}, C^{IV}, C^{VI}, C^{VII}. The cartridge module C^{II}, C^{III}, and C^{IV} is preferably divided (via e.g., a membrane wall MW) into at least two separate chambers for the two fuel components (see FIGS. 21-23); one chamber can contain fuel concentrate, e.g., fuel paste, and another chamber can contain liquid diluent for the concentrate. An optional third chamber can be provided in the cartridge for storing liquid electrolyte. Each chamber has a sealable opening (via e.g., a membrane cap MC) and/or an opening which can be accessed to allow the transfer of the contents of the cartridge into the appropriate or corresponding chambers in the fuel cell module.

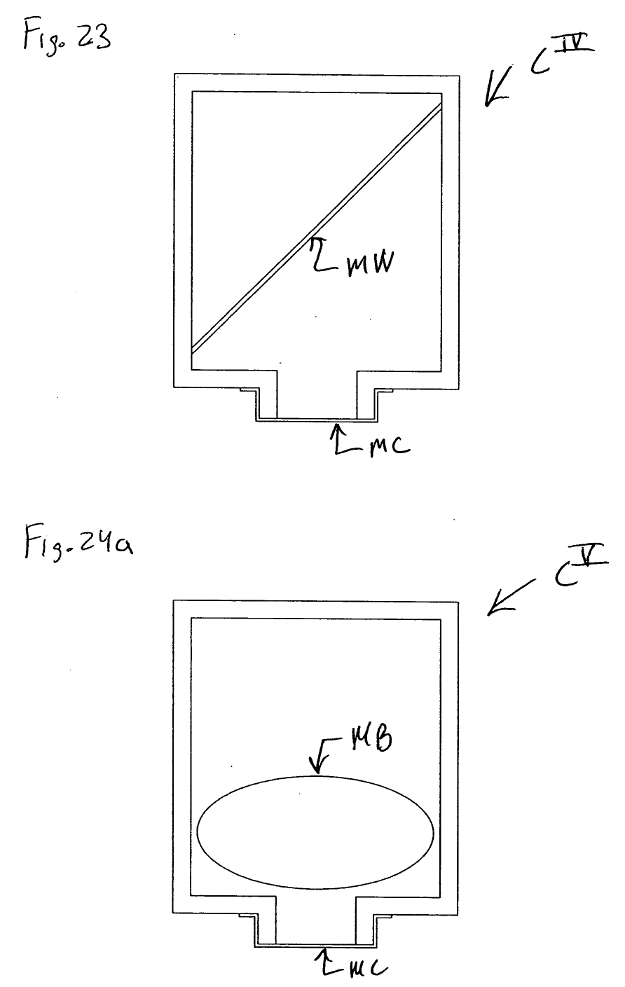

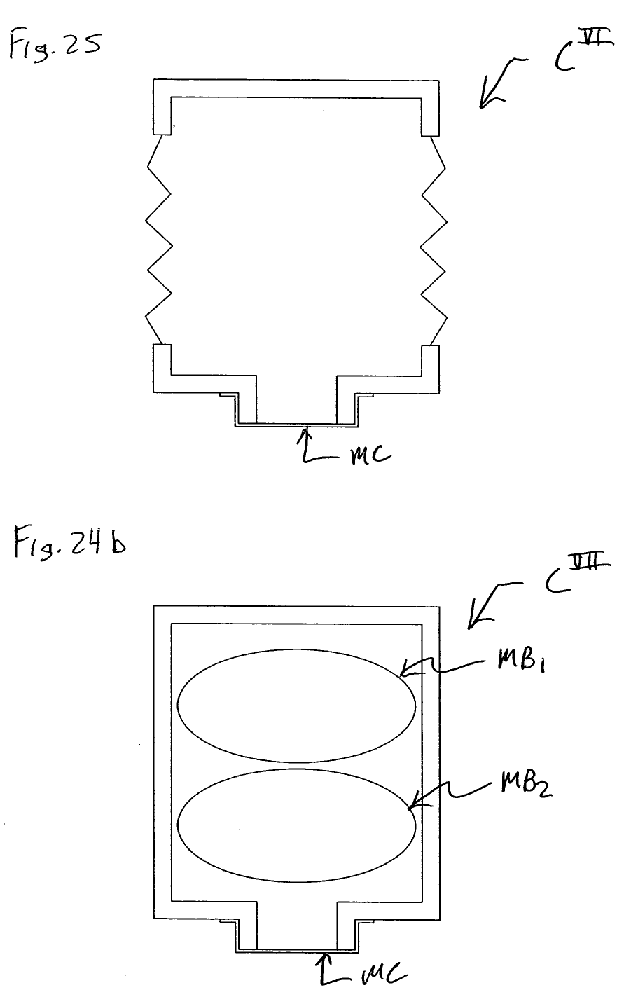

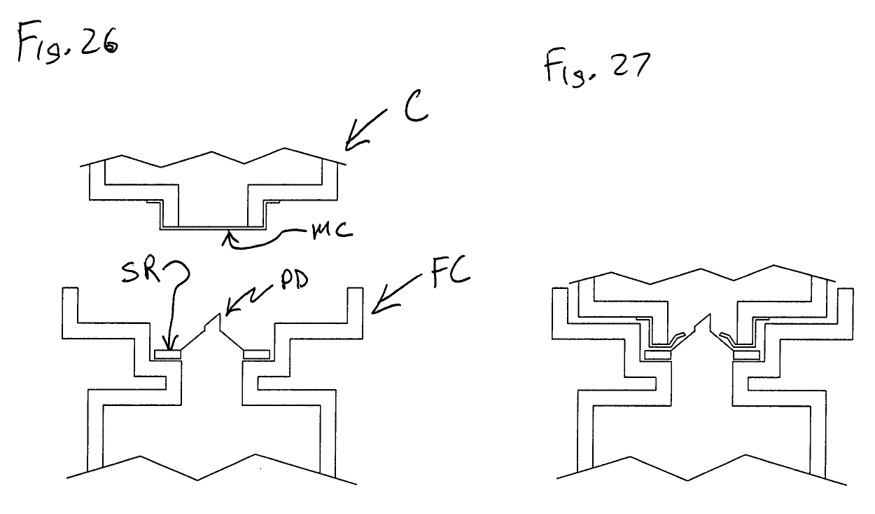

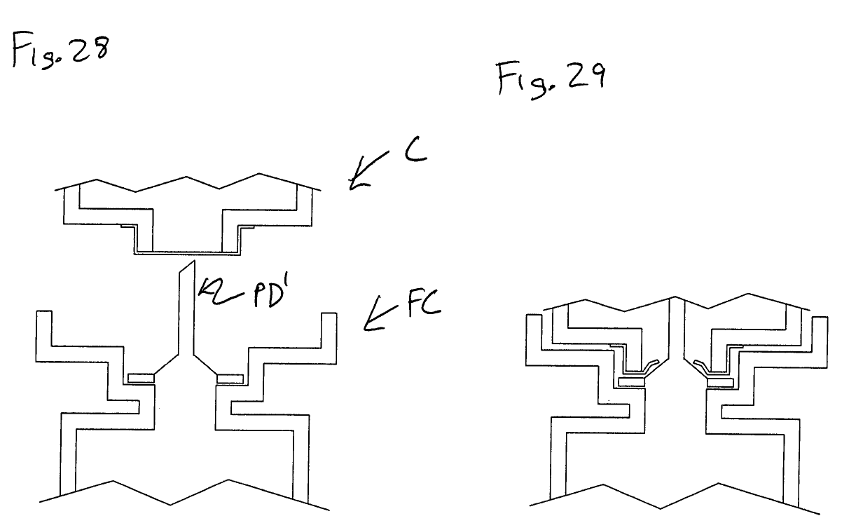

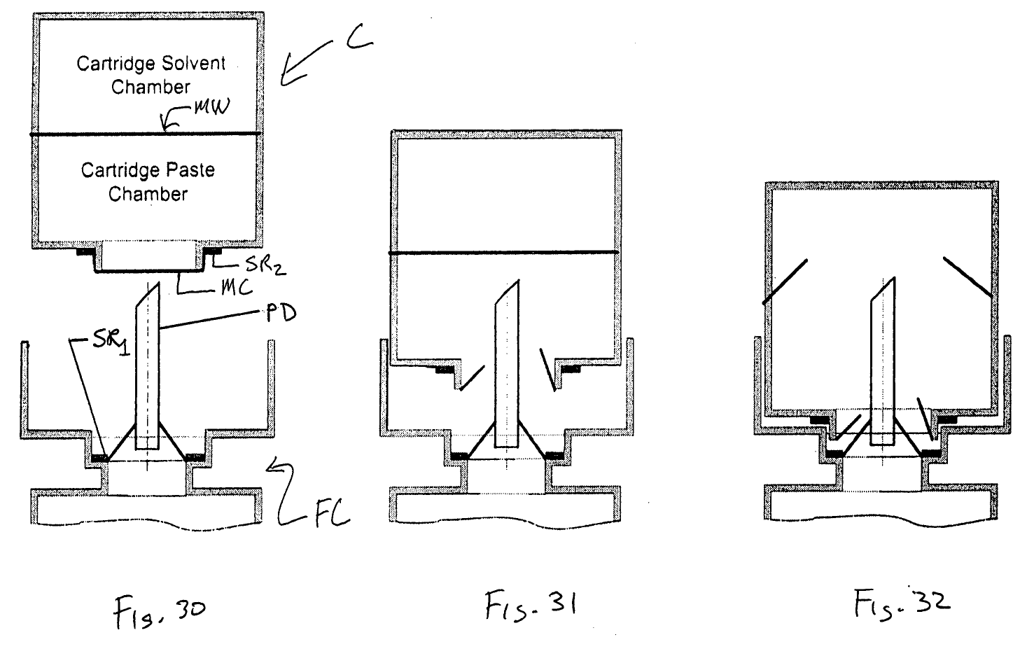

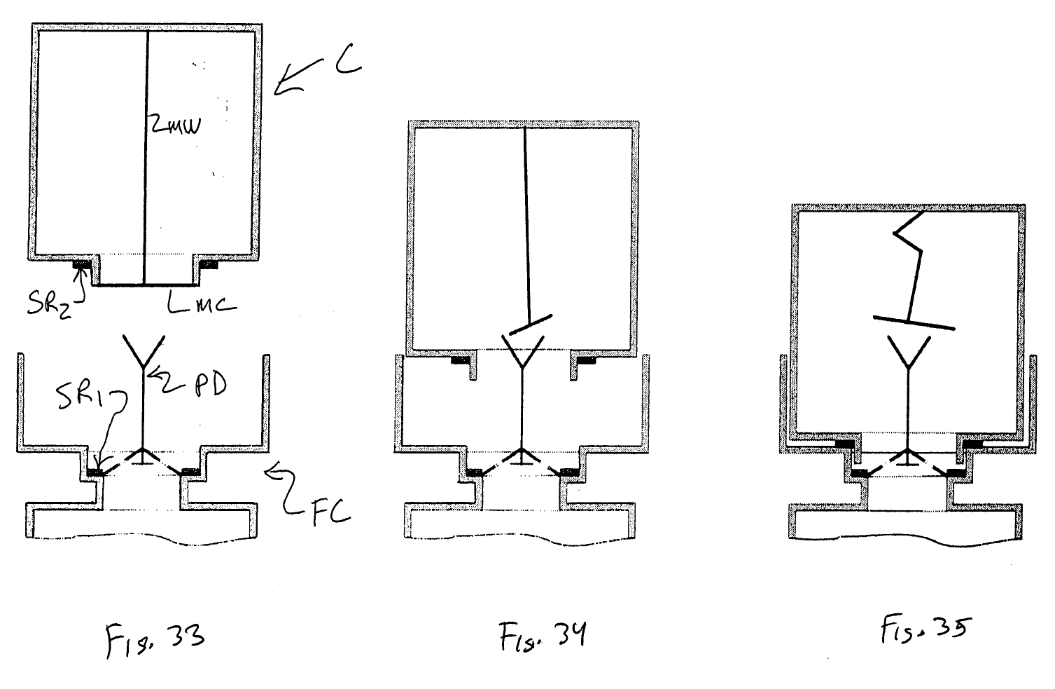

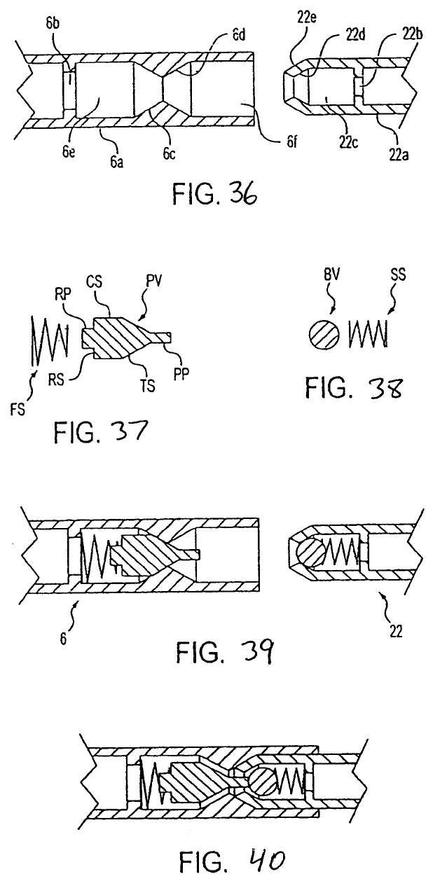

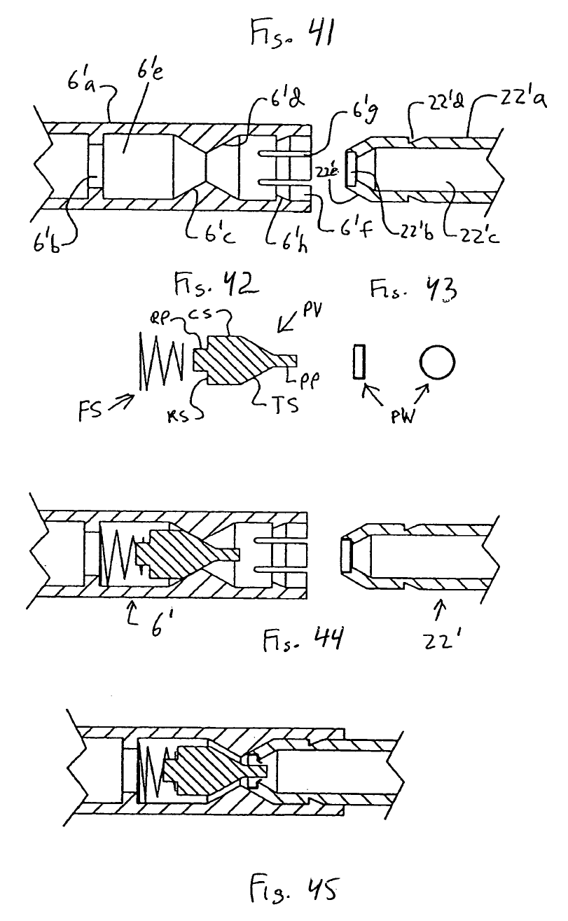

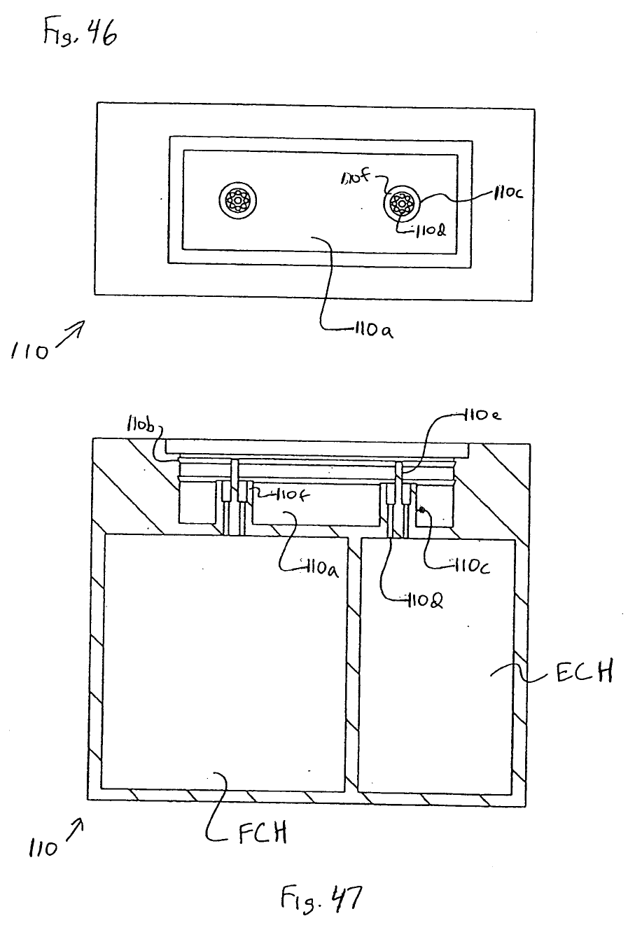

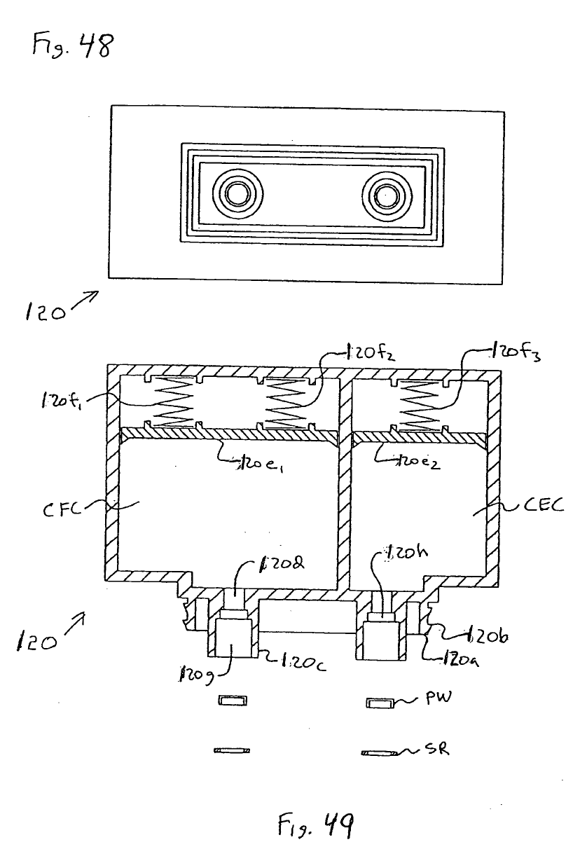

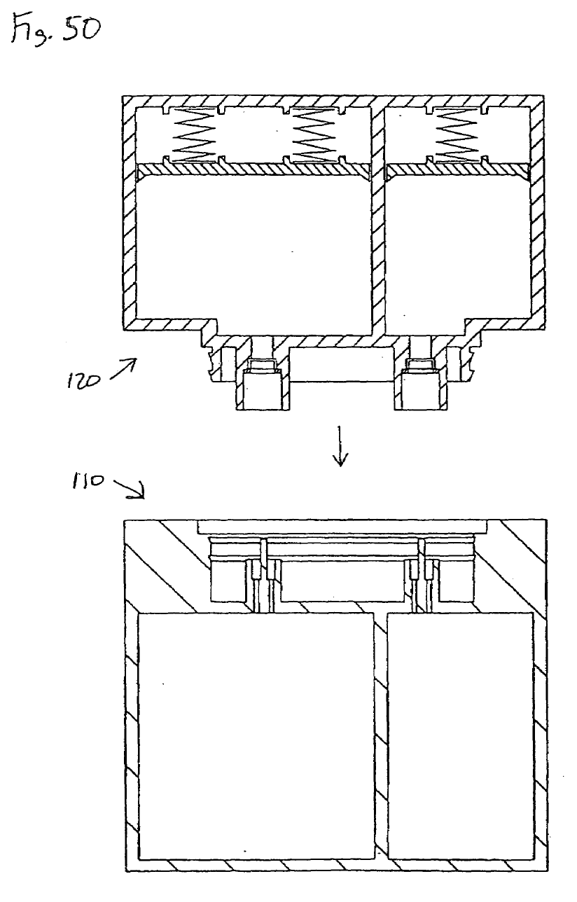

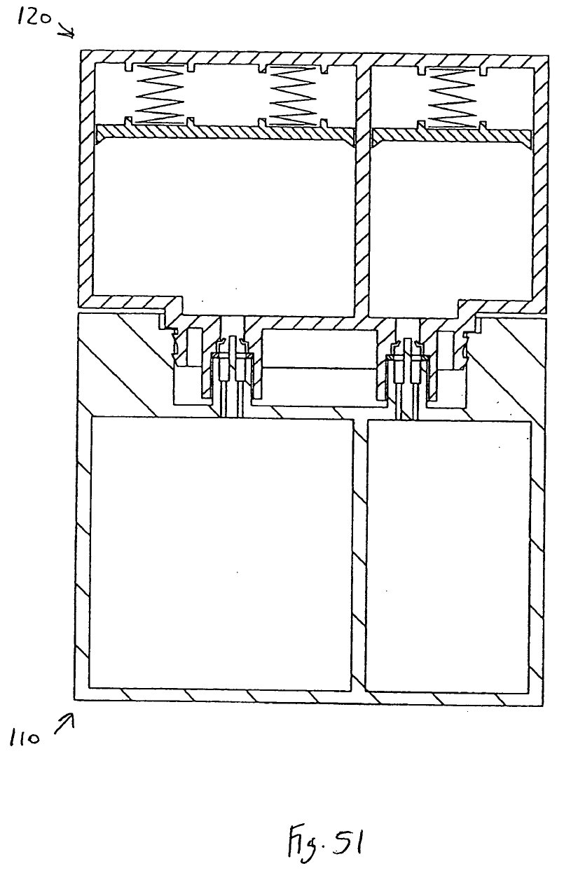

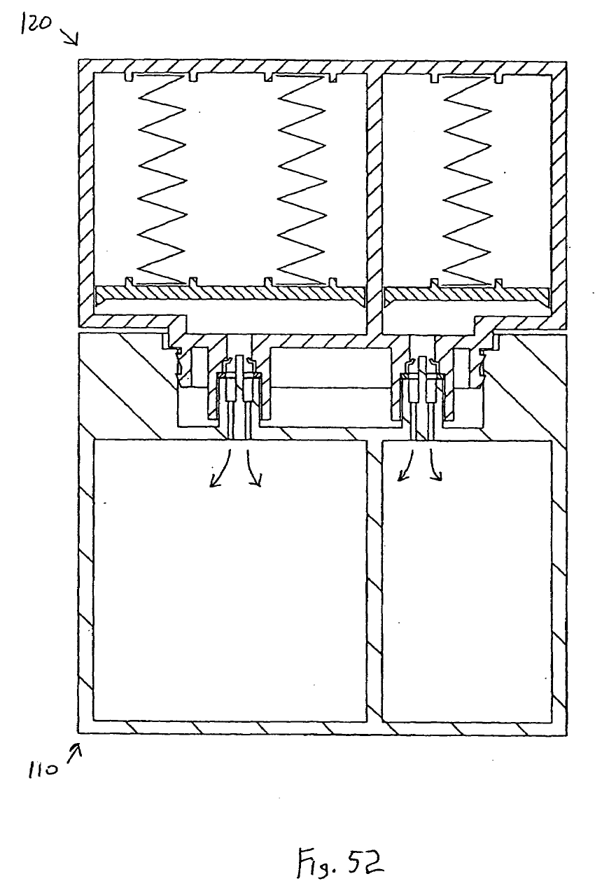

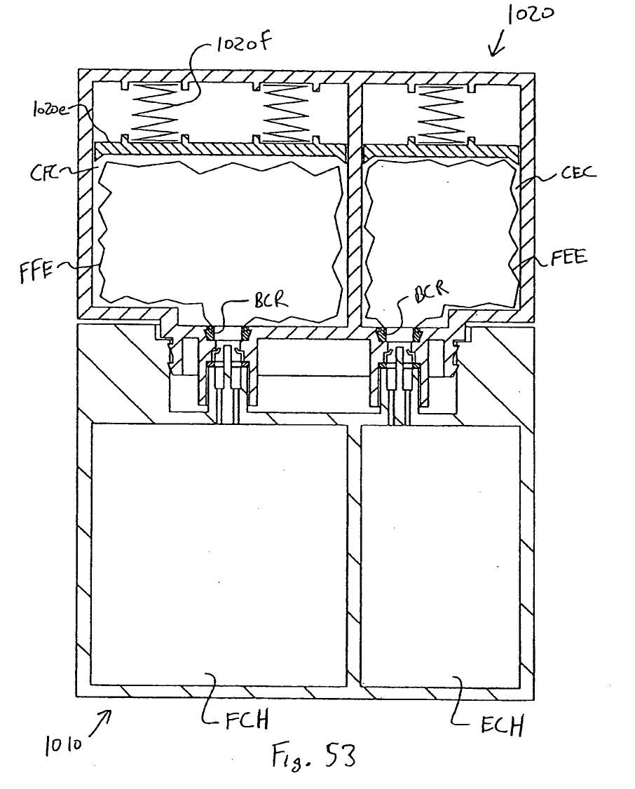

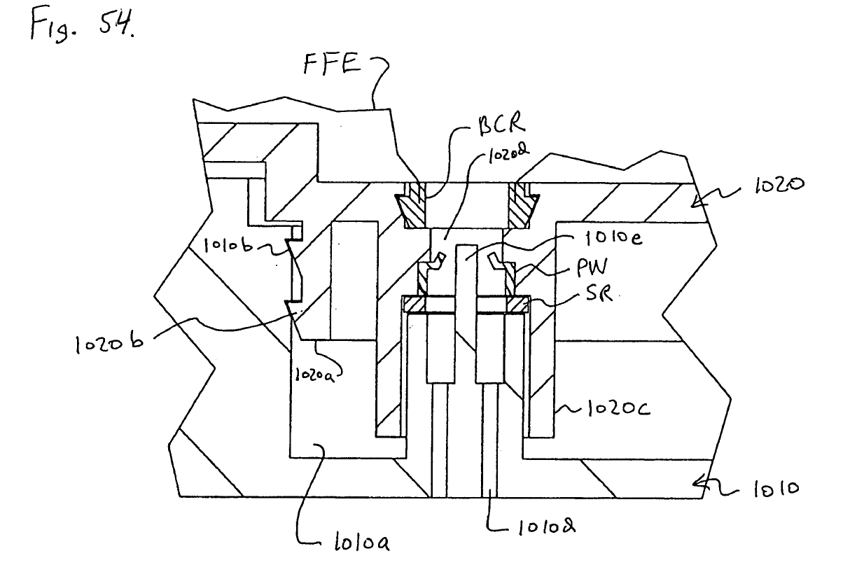

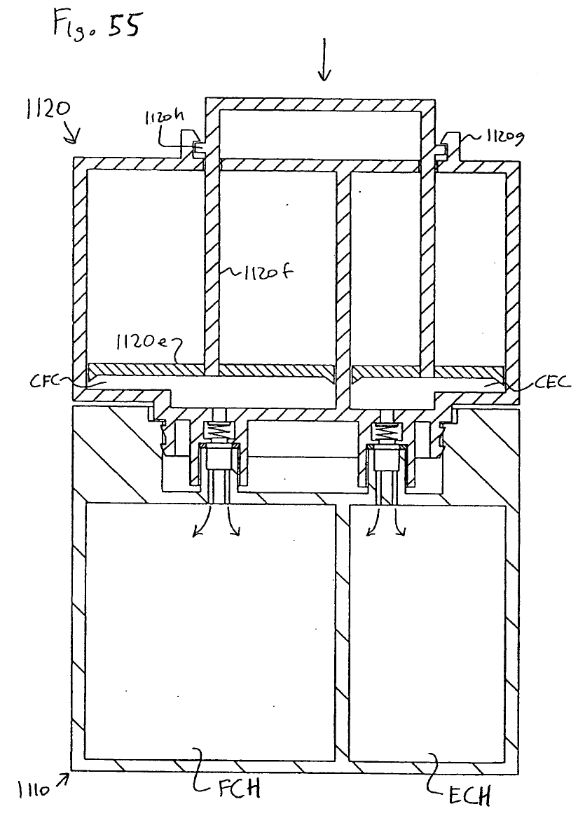

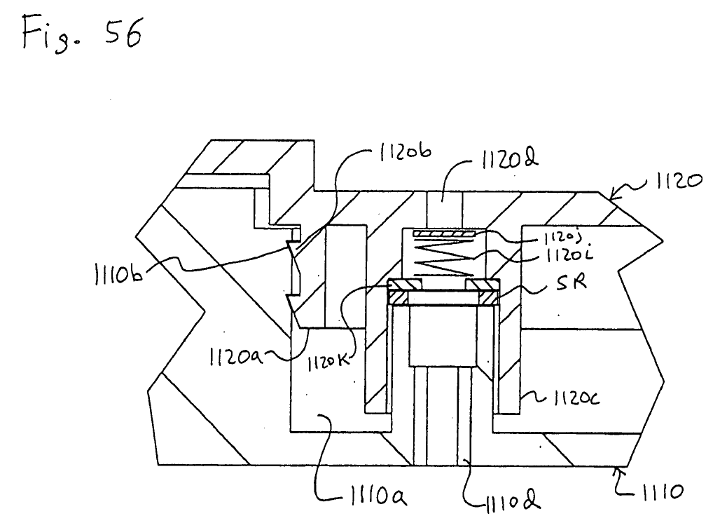

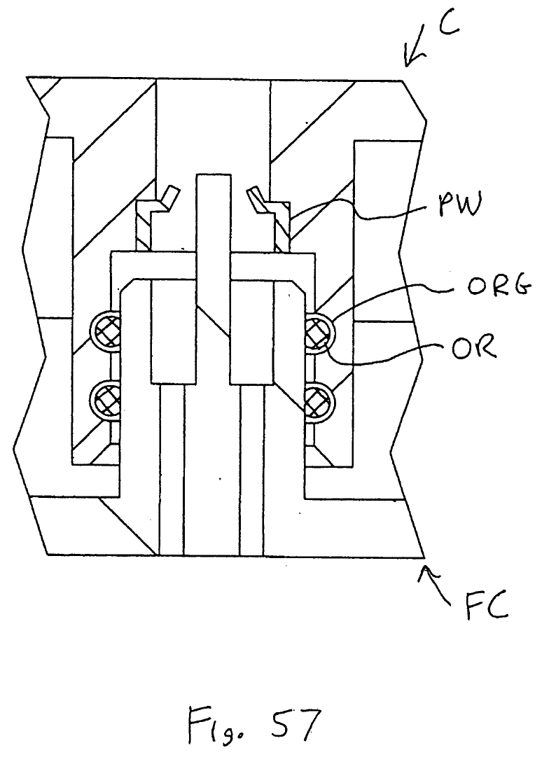

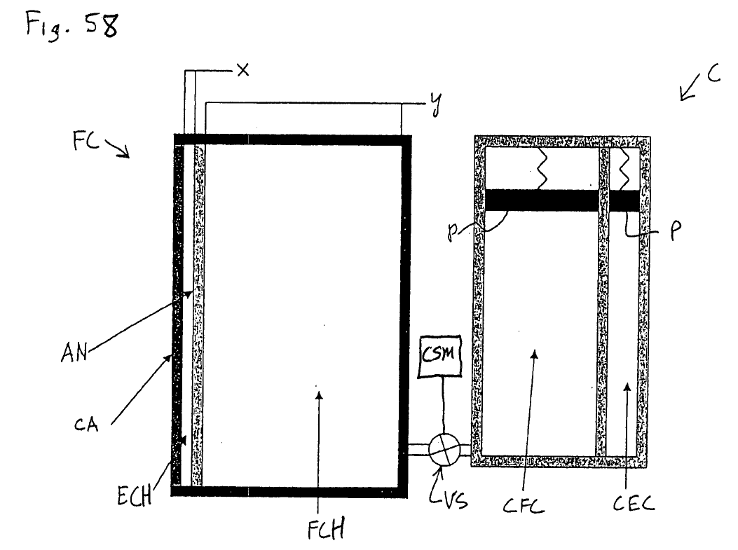

A number of non-limiting options for storing the components in the cartridge chambers may be utilized as follows: the chambers can be arranged within a rigid housing containing a lower seal tab MC and a vertical (see FIG. 22), a horizontal (see FIG. 21), and a diagonal (see FIG. 23) membrane MW separating the paste from its diluent; the chambers can also be arranged within a rigid housing containing a lower seal tab MC and can include a “floating” membrane bag MB containing one component which is surrounded by the second component inside the rigid housing (see FIG. 24a); the chambers can be arranged within a rigid housing, with or without a lower seal tab MC, containing two “floating” membrane bags MB₁, MB₂ for each component (see FIG. 24b); one or more chambers can be arranged within a non-rigid and/or “concertina” type housing that can be compressed vertically with any one of the above-noted options (see FIG. 25).

The cartridge and fuel cell module housings can be produced primarily from lightweight, low-cost materials. Due to cost considerations, the cartridge and fuel cell module housings can preferably be made of polymer materials which are capable of withstanding exposure to the chemicals to be contained therein. Preferred examples of polymer materials include, but are not limited to (optionally filled) PVC, PP, ABS, polycarbonate, polyurethane, etc. In practice, substantially all components (other than those with specific mechanical requirements such as springs, puncturing devices, etc.) are preferably made from such polymer materials. As set forth above, other materials such as, e.g., metals or alloys thereof can be used as well. Exemplary dimensions of cartridge module housings are, for example, from about 5 cm×5 cm×5 cm up to about 20 cm×25 cm×100 cm. Exemplary dimensions for fuel cell module housings are from about 10 cm×10 cm×10 cm up to about 40 cm×50 cm×200 cm.

FIGS. 26-35 shows a number of non-limiting ways for connecting the cartridge units to the fuel cell units: the cartridge unit C can be connected to a mating interface of the fuel cell unit FC in an aligned manner so that, when connected, a puncturing device PD of the fuel cell FC punctures (see FIG. 27) the sealing membrane cap MC so that the contents of the cartridge C can be transferred to the fuel cell FC via the force of gravity. A sealing member or ring SR can be utilized to provide sealing between cartridge C and fuel cell FC to thereby ensure that none of the contents of the cartridge C spill out or leak out during transfer. FIGS. 28 and 29 show a configuration similar to that of FIGS. 26 and 27 except that the puncturing device is longer and capable of severing the membrane wall arranged within the cartridge C; according to FIGS. 30-32, the cartridge unit C can be connected to a mating interface of the fuel cell unit FC in an aligned manner so that, when connected, a puncturing device PD of the fuel cell FC punctures (see FIGS. 31 and 32) both the sealing membrane cap MC and the membrane wall MW so that the contents of the chambers of the cartridge C can be transferred to the fuel cell FC via the force of gravity. Two sealing members or rings SR₁ and SR₂ can be utilized to provide sealing between cartridge C and fuel cell FC to thereby ensure that none of the contents of the cartridge C spill out or leak out during transfer; according to FIGS. 33-35, the cartridge unit C can be connected to a mating interface of the fuel cell unit FC in an aligned manner so that, when connected, a puncturing device PD of the fuel cell FC punctures (see FIGS. 34 and 35) the sealing membrane cap MC and destroys the membrane wall MW so that the contents of the chambers of the cartridge C can be transferred to the fuel cell FC via the force of gravity. Two sealing members or rings SR₁ and SR₂ can be utilized to provide sealing between cartridge C and fuel cell FC to thereby ensure that none of the contents of the cartridge C spill out or leak out during transfer.

By way of one non-limiting example, each of the cartridge embodiments disclosed herein can have one or more valve ports 22 which mate with one or more valve ports 6 of the fuel cell embodiments disclosed herein. FIGS. 36-40 show one non-limiting way in which the ports 6 of the fuel cell can be mated with the ports 22 of the cartridge. FIG. 39 shows the fuel cell valve 6 and cartridge valve 22 in a state prior to being connected to each other. In this state, a plunger valve PV prevents fluid and/or other substances from entering (as well as exiting) the fuel cell by virtue of its tapered surface TS being in sealing contact and/or engagement with correspondingly tapered surface 6c of the valve sleeve 6a. A partially compressed first spring FS acts to bias the plunger valve PV so that sealing contact is maintained between surfaces TS and 6c. The first spring FS is a tapered spring whose larger diameter end is configured to abut against an internal cylindrical shoulder 6b of the sleeve 6a. The smaller diameter portion of the first spring FS is sized to receive therein a rear projection RP of the plunger valve PV and to abut against a rear shoulder RS. The sleeve 6a is generally cylindrical in shape and includes a front cylindrical opening 6f which is sized to receive therein a front cylindrical portion 22a of the cartridge valve 22. In order to ensure that the valve 22 is sealed with respect to the valve 6, the valve 22 includes a tapered surface 22e whose taper corresponds to the tapered surface 6d of the valve 6 (see FIG. 40). The plunger valve PV and first spring FS are both arranged within cylindrical section 6e and can move axially within this opening (compare FIGS. 39 and 40).

In a similar arrangement, a ball valve BV prevents fluid from exiting the cartridge by virtue of its spherical surface being in sealing contact and/or engagement with tapered surface 22d of the valve sleeve 22a. A partially compressed second spring SS acts to bias the ball valve BV so that sealing contact is maintained between the spherical surface of the ball valve BV and tapered surface 22d. The second spring SS is a cylindrical wire spring whose rear end is configured to abut against an internal cylindrical shoulder 22b of the sleeve 22a. The front end of the second spring SS is sized to receive therein a portion of the spherical surface of the ball valve BV (see FIG. 39). The sleeve 22a is generally cylindrical in shape and includes a front cylindrical opening 22c which is sized to receive therein the ball valve BV and second spring SS. As noted above, the valve 22 can be sealed with respect to the valve 6 when the tapered surface 22e engages the tapered surface 6d of the valve 6 (see FIG. 40). The ball valve BV and second spring SS are arranged within cylindrical section 22c and can move axially within this opening (compare FIGS. 39 and 40).

In the position shown in FIG. 39, the valves 6 and 22 are closed and not connected to each other. However, in FIG. 40, the valve 22 has been inserted fully into the valve 6 and both valves 6 and 22 are in an open state to allow fluid communication between the cartridge and the fuel cell. In this opened position, it can be seen that the small diameter projecting portion PP has forced the ball valve BV to move axially away from sealing engagement with tapered surface 22d. This has occurred by causing the second spring SS to compress even more. Similarly, it can be seen that the biasing forces of the springs FS and SS are such that the second spring SS also forces the plunger valve PV, and specifically surface TS, to move axially away from sealing engagement with tapered surface 6c. This has occurred by causing the first spring FS to compress even more. Although not shown, each valve 6 and 22 may also include therein a sleeve or shoulder which allows the plunger valve PV and/or ball valve BV to move away from sealing engagement only a limited amount, thereby ensuring both valves PV and BV are unseated and placed in the opened position reliably and/or essentially simultaneously.

Although not shown, the front of the valve 6 can be slotted, i.e., with slots 6′g shown in FIG. 41), a plurality of spring fingers are formed which deflect outwards when the valve 22 is inserted into the valve 6 (see FIG. 45). This deflection occurs because the projections (which can be similar to projections 6′h in FIG. 45) engage with the cylindrical surface 22a during insertion. When the valve 22 reaches the position shown in FIG. 40, the projections drop into a circumferential recess (similar to recess 22f of FIG. 45). At this point, the valve 22 is fully inserted into and non-removably connected to the valve 6. As is evident from these figures, the valves function to seal the fuel cell and cartridge when they are not connected (see FIG. 39). Of course, the valve arrangement shown in FIGS. 36-40 are but one possible example or embodiments of the valves 6 and 22. The invention contemplates other valve arrangements which allow for the one-time connection and opening of the valves and for the closing of the valves. The various parts of the valves 6 and 22 can be made of any desired material whether conventional or otherwise such as metal, plastic, and/or composites. Additionally, the invention may also utilize valves similar to those used in copending application Ser. No. 10/796,305 (US2004/0241521 A1).

By way of another non-limiting example, the cartridge valve 22 and fuel cell valve 6 may instead have the arrangement shown in FIGS. 41-45. FIG. 44 shows the fuel cell valve 6′ and cartridge valve 22′ in a state prior to being connected to each other. In this state, the plunger valve PV prevents fluid from entering (as well as exiting) the fuel cell by virtue of its tapered surface TS being in sealing contact and/or engagement with correspondingly tapered surface 6′c of the valve sleeve 6′a. A partially compressed first spring FS acts to bias the plunger valve PV so that sealing contact is maintained between surfaces TS and 6′c. The first spring FS is a tapered spring whose larger diameter end is configured to abut against an internal cylindrical shoulder 6′b of the sleeve 6′a. The smaller diameter portion of the first spring FS is sized to receive therein a rear projection RP of the plunger valve PV and to abut against a rear shoulder RS. The sleeve 6′a is generally cylindrical in shape and includes a front cylindrical opening 6′f which is sized to receive therein a front cylindrical portion 22′a of the cartridge valve 22′. In order to ensure that the valve 22′ is sealed with respect to the valve 6′, the valve 22′ includes a tapered surface 22′e whose taper corresponds to the tapered surface 6′d of the valve 6 (see FIG. 45). The plunger valve PV and first spring FS are both arranged within cylindrical section 6′e and can move axially within this opening (compare FIGS. 44 and 45).

Unlike the arrangement shown in FIGS. 36-40, the cartridge valve 22′ in this arrangement does not utilize a one-way valve. Instead, a pierceable washer PW is used to prevent fluid from exiting the cartridge. The pierceable washer PW can be made of thin materials such as, e.g., plastic or aluminum, and may be press fit (or attached in other ways such as by adhesives) into a cylindrical recess 22′b formed in a front portion of the valve 22′. This can occur after the cartridge is initially filled. As can be seen in FIG. 45, the pierceable washer PW is designed to be pierced by the projecting portion PP of the plunger valve PV. To ensure that this occurs reliably, the projecting portion PP may have a sharpened tip (not shown). As can be seen in FIG. 43, the pierceable washer PW is circular and has the form of a cap. The sleeve 22′a is generally cylindrical in shape and includes a front cylindrical opening 22′c which allows the fluid to pass into the valve 6′ of the fuel cell. As noted above, the valve 22′ can be sealed with respect to the valve 6′ when the tapered surface 22′e engages the tapered surface 6′d of the valve 6′ (see FIG. 45).

In the position shown in FIG. 44. the valves 6′ and 22′ are closed and not connected to each other. However, in FIG. 45, the valve 22′ has been inserted fully into the valve 6′ and both valves 6′ and 22′ are in an open state to allow fluid communication between the cartridge and fuel cell. In this opened position, it can be seen that the small diameter projecting portion PP has pierced the pierceable washer PW. This has occurred because the biasing force of the first spring FS is strong enough to causing piercing of the washer PW. On the other hand, the pressure flow from the cartridge to the fuel cell is sufficient to overcome the biasing force of the first spring FS, such that the pressure forces the plunger valve PV, and specifically surface TS, to move axially away from sealing engagement with tapered surface 6′c. This has occurred by causing the first spring FS to compress. Once the pressure in the cartridge is reduced below the biasing force (which occurs after the fluid is transferred from the cartridge to the fuel cell), the valve 6′ will close off. That is, the plunger valve PV, and specifically surface TS, will move axially towards sealing engagement with tapered surface 6′c. Although not shown, the valve 6′ may also include therein a sleeve or shoulder which allows the plunger valve PV to move away from sealing engagement only a limited amount, thereby ensuring the valve PV is unseated and placed in the opened position more reliably.

Because the front of the valve 6′ is slotted, i.e., with slots 6′g, a plurality of spring fingers are formed which deflect outwards when the valve 22′ is inserted into the valve 6′ (see FIG. 45). This deflection occurs because the projections 6′h engage with the cylindrical surface 22′a during insertion. When the valve 22′ reaches the position shown in FIG. 45, the projections 6′h drop into a circumferential recess 22′d. At this point, the valve 22′ is fully inserted into and non-removably connected to the valve 6′. As is evident from these figures, the valves 6′ and 22′ function to seal the fuel cell and cartridge when they are not connected (see FIG. 44). Of course, the valve arrangement shown in FIGS. 41-45 are but one possible example or embodiment of the valves or connecting ports which may be used on the fuel cell and cartridge disclosed herein. The invention contemplates other valve arrangements which allow for the one-time connection and opening of the valves and for the closing of the valves. The various parts of the valves 6′ and 22′ can be made of any desired material whether conventional or otherwise such as metal, plastic, and/or composites.

FIGS. 46-52 schematically illustrate another non-limiting embodiment of the cartridge and fuel cell which can be used in the stand-alone single-use disposable fuel cell back-up power supply system. By way of non-limiting example, the fuel cell 110 includes two chambers FCH and ECH which are separated from each other and the cartridge 120 includes two chambers CEC and CFC which separated from each other. This embodiment is designed so that the fuel cell 110 and a cartridge 120 can be arranged within the frames or housings shown in FIGS. 1-9. In this embodiment, once the arrangement connects the cartridge 120 to the fuel cell 110, the cartridge 120 becomes non-removably connected to the fuel cell 110 so that the back-up power supply system cannot be reused or is used only a single time. This embodiment, as was the case with the previous embodiments, has the advantage that the unit can be stored for relatively long periods of time and then, when desired, the fuel cell 110 can be filled and used at a desirable point in time as described with regard to other embodiments noted above. Once filled, the fuel cell 110 with the connected cartridge 120 is used until it is exhausted, i.e., it stops generating the desired level of power. Then, one can simply discard and/or recycle the fuel cell 110/cartridge 120 as a unit or send it back for refurbishment. The design of the fuel cell 110/cartridge 120 is such that it cannot be refilled and/or its contents cannot be easily removed from the fuel cell 110 without destroying the fuel cell 110 and cartridge 120. This arrangement is ensured when the cartridge 120 is connected to the fuel cell 110 (see FIGS. 51-52) because the cartridge 120 becomes non-removably connected to the fuel cell 110 when fully connected. As will be described herein, this connection also automatically triggers the transfer of fluids between the cartridge 120 and the fuel cell 110. By ensuring that, once fully connected, the cartridge 120 is essentially permanently connected to the fuel cell 110, a user will not be able to refill and/or reuse the fuel cell 110 without likely destroying or damaging it in the attempt to do so. The fuel cell 110 is thus usable only once and may then be discarded or recycled/refurbished.

The two ports 110c (one for the fuel chamber FCH and one for the electrolyte chamber ECH) are arranged within a main recess 110a of the fuel cell 110. These ports 110c can be integrally formed with the fuel cell body by, e.g., injection molding the body in two parts. Alternatively, the ports 110c can be separately formed therefrom and then attached thereto by, e.g., adhesives or a threaded connection (not shown). The ports 110c include a plurality of openings 110d arranged to allow fluid to enter into the fuel chamber FCH and the electrolyte chamber ECH. The ports 110c also include a cylindrical portion whose annular free end is configured to sealingly engage with a sealing ring SR arranged within a cylindrical opening 120g of the cartridge ports 120c. The sealing ring SR may have any desired shape and may be made of a material such as, e.g., Viton. The two ports 120c (one for the fuel chamber CFC and one for the electrolyte chamber CEC) project from a bottom wall of the cartridge 120. The ports 120c and connecting portion 120a (as can be the case with ports 110c and recess 110a) can be integrally formed with the cartridge body by, e.g., injection molding the body in two parts. Alternatively, the ports 120c can be separately formed therefrom and then attached thereto by, e.g., adhesives or a threaded connection (not shown). The ports 120c each include a main opening 120d arranged to allow fluid to enter into the fuel chamber CFC and the electrolyte chamber CEC during initial filling and thereafter allow the fluids to exit and enter into the fuel cell 110 once the piercing washers PW are pierced. By way of non-limiting example, the chambers CFC and CEC can be initially filled with the fluids (e.g., fuel or fuel concentrate and liquid diluent and electrolyte) entering under a fluid pressure which is capable of compressing the springs 120f. Then, the openings 120h are sealed with the piercing washers PW. The ports 120c include a cylindrical portion whose annular free end is configured to receive therein a sealing ring SR and a respective fuel cell port 110c. The ports 120c also include a cylindrical portion 120h which is configured to receive therein a piercing washer PW. The piercing washer PW can be secured to the opening 120h in any desired way as long as it is securely and sealingly connected to the cartridge 120 and as long as it can be pierced by the projecting portions 110e. This can occur by, e.g., a press fit connection or by using an adhesive connection.

In performing the filling process, the arrangement to which the cartridge and fuel cell are mounted aligns the cartridge 120 with the fuel cell 110 (see FIG. 50). Then, the arrangement moves the cartridge 120 into full engagement and/or connection with the fuel cell 110 (see FIG. 51). This causes the piercing plungers 110e of the fuel cell 110 to pierce the piercing washers PW, which in turn automatically triggers the fluid transfer from the cartridge 120 to the fuel cell 110 under the biasing or expansion action of the piston springs 120f1, 120f2, 120f3, and the cartridge pistons 120e1 and 120e2. Then, the fuel cell 110 is filled. Once filled, the piston springs 120f1, 120f2, 120f3, and the cartridge pistons 120e1 and 120e2 ensure that the fluids in the fuel cell 110 cannot flow back into the cartridge 120. Moreover, because the cartridge 120 is non-removably connected to the fuel cell 110, the user will not be able to reuse and refill of the fuel cell 110. To provide this non-removable connection, the cartridge 120 utilizes projections 120b which engage corresponding recesses 110b in the fuel cell 110. The design of the projections 120b and recesses 110b are such that the cartridge 120 cannot be removed from the fuel cell 110 without destroying the fuel cell 110. Of course, the cartridge 120 can also be non-removably secured to the fuel cell 110 in other ways such as by utilizing, e.g., pressure sensitive adhesives or by utilizing projections on the fuel cell 110 and recesses on the cartridge 120.

The fuel cell 110 and cartridge 120 may each be generally rectangular in shape and may be made of an (optionally filled) plastic material such as, e.g., ABS (acrylonitrile-butadiene-styrene), PVC, polypropylene, polyethylene (e.g., HDPE), polycarbonate and polyurethane. Of course, the fuel cell 110 and cartridge 120 can have any other desired shape including, but not limited to any other polygonal or any other linear and/or curvilinear shape. Although not shown, the fuel cell 110, like the fuel cell shown in previous embodiments, includes one or more cathodes, one or more anodes, defines an optional electrolyte chamber, and utilizes a fuel chamber. The fuel cell 110 also includes all of the features otherwise required to produce power. The cartridge 120 is not limited to any particular spring 120f and piston 120e arrangement and/or configuration. The important aspect of this embodiment is that the cartridge 120 has the ability of transferring its contents to the fuel cell 110 automatically once the cartridge is fully, sealingly and non-removably connected to the fuel cell 110. The arrangement shown in FIGS. 46-52 can also be modified so that the chambers CEC and CFC utilize flexible material enclosures, e.g., flexible polymer bags, which are in fluid communication with the openings 120d and which can be compressed by the springs 120f to cause their contents to be expelled out of the cartridge 120 and into the fuel cell 110 (i.e., similar to the arrangement shown in FIG. 53).

FIGS. 53 and 54 schematically illustrate another non-limiting embodiment of the cartridge and fuel cell which can be used in a stand-alone single-use disposable back-up power supply system. By way of non-limiting example, the fuel cell 1010 includes two chambers FCH and ECH which are separated from each other and the cartridge 1020 includes two chambers CEC and CFC which separated from each other. This embodiment is also designed so that the fuel cell 1010 and a cartridge 1020 can be purchased already installed on the arrangement for connecting these devices such that the cartridge and fuel cell remain an unconnected unit with the fresh fuel component(s) or fluids being contained only in the cartridge 1020. The system then connects the cartridge 1020 to the fuel cell 1010 when it is desired to use the fuel cell 1010. This embodiment has the advantage that the system can be stored for relatively long periods of time and then, when required, the fuel cell 1010 can be filled at a desirable point in time. Once filled, the fuel cell 1010 is used with the non-removably connected cartridge 1020 until it is exhausted, i.e. it stops generating the desired level of power. Then, the system can simply be discarded and/or recycled. The design of the fuel cell 1010/cartridge 1020 is such that it cannot be refilled and/or its contents cannot be easily removed from the fuel cell 1010 without destroying the fuel cell 1010. This condition is ensured when the arrangement fully non-removably connects the cartridge 1020 to the fuel cell 1010 (see FIG. 53). This non-removable connection system is similar to that of the embodiment shown in, e.g., FIGS. 46-52. As is evident from FIG. 53, a full connection between the cartridge 1020 and the fuel cell 1010 automatically triggers the transfer of fluids between the cartridge 1020 and the fuel cell 1010. By ensuring that, once fully connected, the cartridge 1020 is sealingly connected to the fuel cell 1010 and by ensuring that the fluids in the fuel cell 1010, once placed therein, cannot be removed, the user will not be able to refill and/or reuse the fuel cell 1010 without likely destroying or damaging it in the attempt to do so. The fuel cell 1010 is thus usable only once and may then be discarded or recycled/refurbished.

As with many of the previously described embodiments, the two ports 1010c (one for the fuel chamber FCH and one for the electrolyte chamber ECH) are arranged within a main recess 1010a of the fuel cell 1010. The ports 1010c can be separately formed therefrom and then attached thereto by, e.g., adhesives and/or a threaded connection (not shown). The ports 1010c include a plurality of openings 1010d arranged to allow fluids to enter into the fuel chamber FCH and the electrolyte chamber ECH. The ports 1010c also include a cylindrical portion whose annular free end is configured to sealingly engage with a sealing ring SR arranged within a cylindrical opening of the cartridge ports 1020c. The sealing ring SR may have any desired shape and may be made of a material such as, e.g., Viton. The two ports 1020c (one for the fuel chamber CFC and one for the electrolyte chamber CEC) project from a bottom wall of the cartridge 1020. The ports 1020c and connecting portion 1020a can be integrally formed with the cartridge body by, e.g., injection molding the body in two parts. Alternatively, the ports 1020c can be separately formed therefrom and then attached thereto by, e.g., adhesives or a threaded connection. The ports 1020c each include a main opening 1020d arranged to allow fluids to enter into the flexible fuel chamber or enclosure FFE and the flexible electrolyte chamber or enclosure FEE during initial filling and thereafter allow the fluids to exit and enter into the fuel cell 1010 once the piercing washers PW are pierced. By way of non-limiting example, the flexible chambers FFE and FEE can be initially filled with the fluids (e.g., fuel or fuel concentrate and liquid diluent and electrolyte) entering under a fluid pressure which is capable of compressing the springs 1020f. Then, the openings are sealed with the piercing washers PW. The ports 1020c include a cylindrical portion whose annular free end is configured to receive therein a sealing ring SR and a respective fuel cell port 1010c. The ports 1020c also include a cylindrical portion which is configured to receive therein a piercing washer PW. The piercing washer PW can be secured to the opening in any desired way as long as it is securely and sealingly connected to the cartridge 1020 and as long as it can be pierced by the projecting portions 1010e. This can occur by, e.g., a press fit connection or by using an adhesive connection.

As is evident in FIG. 54, the flexible enclosures FFE and FEE have an open end which is fixed to a connecting ring BCR. Each ring BCR includes an external projection which securely and sealingly engages with a corresponding internal recess in the cartridge body.

In performing the filling process, the arrangement simply aligns the cartridge 1020 with the fuel cell 1010. Then, the arrangement is activated to move the cartridge 1020 into full engagement and/or connection with the fuel cell 1010. This causes the piercing plungers 1010e of the fuel cell 1010 to pierce the piercing washers PW, which in turn automatically triggers the fluid transfer from the cartridge 1020 to the fuel cell 1010 under the biasing or expansion action of the piston springs 1020f and the cartridge pistons 1020e. The pistons 1020e act to compress the flexible chambers FFE and FEE which forces their contents into the fuel cell 1010. With this arrangement, the fuel cell 1010 can be filled without any of the fluids ever moving back into the cartridge 1020. Once filled, the piston springs 1020f and the cartridge pistons 1020e remain in a lowermost position. On the other hand, the cartridge 1020 remains non-removably connected to the fuel cell 1010. At the same time, the user will not be able to reuse and refill of the fuel cell 1010.

The fuel cell 1010 and cartridge 1020 may each be generally rectangular in shape and may be made of an (optionally filled) plastic material such as, e.g., ABS (acrylonitrile-butadiene-styrene), PVC, polypropylene, polyethylene (e.g., HDPE), polycarbonate and polyurethane. Of course, the fuel cell 1010 and cartridge 1020 can have any other desired shape including, but not limited to any other polygonal or any other linear and/or curvilinear shape (as in other disclosed embodiments). Although not shown, the fuel cell 1010, like the fuel cell discussed above, includes one or more cathodes, one or more anodes, and defines an electrolyte chamber and a fuel chamber. The fuel cell 1010 also includes all of the features otherwise required to produce power. The cartridge 1020 is not limited to any particular spring 1020f and piston 1020e arrangement and/or configuration. The important aspect of this embodiment is that the cartridge 1020 has the ability of transferring its contents to the fuel cell 1010 automatically once the cartridge 1020 is fully, sealingly and non-removably connected to the fuel cell 1010. The arrangement shown in FIGS. 53 and 54 can also be modified so that the cartridge body is formed in two parts which are attached to each other by locking latch mechanisms which include a deflectable locking latch fixed to the upper part and a locking projection fixed to the lower part (see FIGS. 51-52 of US 2005/0260481).

FIGS. 55 and 56 schematically illustrate another non-limiting embodiment of the cartridge and fuel cell which can be used in a stand-alone single-use disposable power supply system. By way of non-limiting example, the fuel cell 1110 includes two chambers FCH and ECH which are separated from each other and the cartridge 1120 includes two chambers CEC and CFC which separated from each other. This embodiment is designed so that the fuel cell 1110 and a cartridge 1120 are together placed in an arrangement and are already connected to each other. However, the fresh fuel component(s) or fluids are contained only in the cartridge 1120. The arrangement is not required to connect the cartridge 1120 to the fuel cell 1110 as in previous embodiments. Instead, the arrangement functions to cause the transfer of the fluids from the cartridge 1120 to the fuel cell 1110. This embodiment also has the advantage that the unit can be stored for relatively long periods of time and then, when activation is desired, the fuel cell 1110 can be filled and used. Once filled, the fuel cell 1110 generates power with the non-removably connected cartridge 1120 connected to it until it is exhausted, i.e. it stops generating the desired level of power. Then, one can simply discard and/or recycle the entire arrangement or remove the fuel cell 1110/cartridge 1120 as a unit and replace it with a new one in the arrangement. The design of the fuel cell 1110/cartridge 1120 is such that it cannot be refilled and/or its contents cannot be easily removed from the fuel cell 1110 without destroying the fuel cell 1110. This condition is ensured when the cartridge 1120 is connected to the fuel cell 1110 (e.g., in a factory setting). Because the cartridge 1120 contains one-way valves 1120i and 1120j, this embodiment can dispense with the need for valves in the fuel cell 1110 or with the piercing washer PW. As is evident from FIG. 56, a full connection between the cartridge 1120 and the fuel cell 1110 does not automatically trigger the transfer of fluids between the cartridge 1120 and the fuel cell 1110, as was the case with many of the previously described embodiments. Instead, this embodiment allows the pressing or connecting arrangement (i.e., the connecting arrangement used in the devices shown in FIGS. 1-9) to physically and mechanically control the fluid transfer by moving the piston rods 1120f. To facilitate this movement, the handle which connects the two rods 1120f is moved in the direction of the fuel cell 1110. At a lowermost position, the handle non-releasably locks to the cartridge 1120 so that the user will not be able to cause the fluids to move back into the cartridge 1120 from the fuel cell 1110. As can be seen in FIG. 55, this locking can occur by utilizing two deflectable locking members 1120g fixed to the cartridge body and two locking projections 1120h fixed to the rods 1120f. By ensuring that the cartridge 1120 is sealingly connected to the fuel cell 1110 and by ensuring that the fluids in the fuel cell 1110, once placed therein, cannot be removed, the user will not be able to refill and/or reuse the fuel cell 1110 without likely destroying or damaging it in the attempt to do so. The fuel cell 1110 is thus usable only once and may then be discarded or recycled/refurbished.

As with many of the previously described embodiments, the two ports 1110c (one for the fuel chamber FCH and one for the electrolyte chamber ECH) are arranged within a main recess 1110a of the fuel cell 1110. The ports 1110c can be separately formed therefrom and then attached thereto by, e.g., adhesives and/or a threaded connection. The ports 1110c include a plurality of openings 1110d arranged to allow fluids to enter into the fuel chamber FCH and the electrolyte chamber ECH. The ports 1110c also include a cylindrical portion whose annular free end is configured to sealingly engage with a sealing ring SR arranged within a cylindrical opening of the cartridge ports 1120c. The sealing ring SR may have any desired shape and may be made of a material such as, e.g., Viton. The two ports 1120c (one for the fuel chamber CFC and one for the electrolyte chamber CEC) project from a bottom wall of the cartridge 1120. The ports 1120c and connecting portion 1120a can be integrally formed with the cartridge body by, e.g., injection molding the body in two parts. Alternatively, the ports 1120c can be separately formed therefrom and then attached thereto by, e.g., adhesives or a threaded connection. The ports 1120c each include a main opening 1120d arranged to allow fluids to enter into the fuel chamber CFC and the electrolyte chamber CEC during initial filling and thereafter allow the fluids to exit and enter into the fuel cell 1110 once the valves 1120j and 1120i are forced open under fluid pressure. By way of non-limiting example, the chambers CFC and CEC can be initially filled with the fluids (e.g., fuel and electrolyte) entering under a fluid pressure which is capable of filling the volume up to the pistons 1120e. Then, the openings are sealed with the sealing disk 1120j, spring 1120i and retaining washer 1120k (which can be press-fit into the cylindrical opening of the ports 1120c). The ports 1120c include a cylindrical portion whose annular free end is configured to also receive therein a sealing ring SR and a respective fuel cell port 1110c.

In performing the filling process, the unit shown in FIG. 55 is arranged within an arrangement of the type shown in FIGS. 1-9. Then, when activated, the arrangement causes the handle connected to the piston rods 1120f to move down towards the fuel cell 1110. This, in turn, causes the fluid transfer from the cartridge 1120 to the fuel cell 1110 under the action of the cartridge pistons 1120e. The fluids force open the sealing disks 1120j, i.e., causing them to move away from the openings 1120d, by overcoming the biasing force of the spring 1120i. This occurs because the fluid pressure in the cartridge 1120 is sufficient to overcome the biasing force of the spring 1120i. The springs 1120i otherwise bias the sealing disks 1120j towards a position closing off the openings 1120d. This occurs by placing the spring 1120i in a compressed state between the sealing disk 1120j and a retaining washer 1120k which is held in place by, e.g., a press fit connection or an adhesive connection. With this arrangement, the fuel cell 1110 can be filled without any of the fluids ever moving back into the cartridge 1120. Once filled, the cartridge pistons 1120e remain in a lowermost position owing to the locking system 1120g/1120h. On the other hand, because the cartridge 1120 is non-removably connected to the fuel cell 1110, one cannot disconnect the cartridge 1120. At the same time, a user will not be able to reuse and refill the fuel cell 1110.

The fuel cell 1110 and cartridge 1120 may each be generally rectangular in shape and may be made of an (optionally filled) plastic material such as, e.g., ABS (acrylonitrile-butadiene-styrene), PVC, polypropylene, polyethylene (e.g., HDPE), polycarbonate and polyurethane. Of course, the fuel cell 1110 and cartridge 1120 can have any other desired shape including, but not limited to any other polygonal or any other linear and/or curvilinear shape. Although not shown, the fuel cell 1110 includes one or more cathodes, one or more anodes, and defines an electrolyte chamber and a fuel chamber. The fuel cell 1110 also includes all of the features otherwise required to produce power. The cartridge 1120 is not limited to any particular piston 1120e arrangement and/or configuration. The important aspect of this embodiment is that the cartridge 1120 has the ability of non-reversibly transferring its contents to the fuel cell 1110 under the action of the activating arrangement. The arrangement shown in FIGS. 55 and 56 can also be modified so that the chambers CEC and CFC utilize flexible material enclosures, e.g., flexible polymer bags, which are in fluid communication with the openings 1120d and which can be compressed by the pistons 1120e to cause their contents to be expelled out of the cartridge 1120 and into the fuel cell 1110 (i.e., similar to the arrangement shown in FIG. 53).

As with many of the previously described embodiments, the two ports 1110c (one for the fuel chamber FCH and one for the electrolyte chamber ECH) are arranged within a main recess 1110a of the fuel cell 1110. The ports 1110c can be separately formed therefrom and then attached thereto by, e.g., adhesives and/or a threaded connection. The ports 1110c include a plurality of openings 1110d arranged to allow fluids to enter into the fuel chamber FCH and the electrolyte chamber ECH. The ports 1110c also include a cylindrical portion whose annular free end is configured to sealingly engage with a sealing ring SR arranged within a cylindrical opening of the cartridge ports 1120c. The sealing ring SR may have any desired shape and may be made of a material such as, e.g., Viton. The two ports 1120c (one for the fuel chamber CFC and one for the electrolyte chamber CEC) project from a bottom wall of the cartridge 1120. The ports 1120c and connecting portion 1120a can be integrally formed with the cartridge body by, e.g., injection molding the body in two parts. Alternatively, the ports 1120c can be separately formed therefrom and then attached thereto by, e.g., adhesives or a threaded connection. The ports 1120c each include a main opening 1120d arranged to allow fluid to enter into the fuel chamber CFC and the electrolyte chamber CEC during initial filling and thereafter allow the fluid to exit and enter into the fuel cell 1110 once the valves 1120j and 1120i are forced open under fluid pressure. By way of non-limiting example, the chambers CFC and CEC can be initially filled with the fluids (e.g., fuel or fuel concentrate and liquid diluent and electrolyte) entering under a fluid pressure which is capable of filling the volume up to the pistons 1120e. Then, the openings are sealed with the sealing disk 1120j, spring 1120i and retaining washer 1120k (which can be press-fit into the cylindrical opening of the ports 1120c). The ports 1120c include a cylindrical portion whose annular free end is configured to also receive therein a sealing ring SR and a respective fuel cell port 1110c.

FIG. 57 shows an alternative non-limiting arrangement for the fluid-tight connection between the ports of the fuel cell FC and those of the cartridge C. This arrangement can be used in any of the previous embodiments such as the ones shown in., e.g., FIGS. 46-56. This arrangement uses two O-rings RW arranged within two O-ring grooves ORG in place of the sealing SR. The O-rings OR sealingly engage with an outer cylindrical surface of the fuel cell ports.

FIG. 58 shows still another non-limiting embodiment of a disposable fuel cell FC and cartridge C. The stand-alone power system is designed so that it can be purchased or procured as a unit assembly including a cartridge containing the fuel component(s) separated from a fuel cell which does not contain the fuel component(s). The user can then install and/or connect the power system to the desired load, e.g., a cell phone tower. Unlike the previous embodiments which require connection of the cartridge C with the fuel cell FC, this embodiment provides for a valve or pump system VS and a control system CSM. The fuel cell FC and cartridge C need not be connected directly to each other and can each instead be connected to the valve or pump system VS. When it is desired to activate the fuel cell FC, the control system CSM issues a command to the valve or pump system VS to open and/or to start transferring the contents from the cartridge C to the fuel cell FC. The system VS also prevents the fuel component(s) from moving back from the fuel cell FC to the cartridge C, as with the previously described embodiments. By way of non-limiting example, the fuel cell FC has an anode AN, a cathode CA, an electrolyte chamber ECH and a fuel chamber FCH. The width of the electrolyte chamber “x”, the width “y” of the fuel chamber FCH, the volume of the electrolyte chamber ECH and the volume of the fuel chamber FCH depend on the desired power. The cartridge C may also utilize spring P actuated pistons to cause the transfer of the fluids in the electrolyte chamber CEC and the fuel chamber CFC to the corresponding chambers ECH and FCH of the fuel cell FC.

FIG. 59 shows a schematic cross-section of a non-limiting example of a cartridge-free fuel cell FC. This fuel cell already contains all of the components that are required for the operation of the fuel cell. The fuel cell FC comprises four puncturable membranes ME₁ to ME₄. Membrane ME₁ divides the fuel chamber FCH into two sections FCHₛ₁ and FCHₛ₂. These two sections each contain one of two components of a two-component liquid fuel, e.g., a fuel concentrate and a liquid diluent for diluting the concentrate. For example, the fuel concentrate may be present in section FCHₛ₁ and the liquid diluent may be present in section FCHₛ₂. Of course, if the liquid fuel is a single-component fuel, there is no need for the presence of membrane ME₁. Membrane ME₂ separates the contents of fuel chamber FCH and in particular, the contents of fuel chamber section FCHₛ₂ from anode AN, thereby preventing contact between the contents of fuel chamber section FCHₛ₂ and anode AN. Membrane ME₄ separates the contents of electrolyte chamber ECH (i.e., the electrolyte) from anode AN, thereby preventing contact between the contents of electrolyte chamber ECH and anode AN. Membrane ME₃ separates the contents of electrolyte chamber ECH from the cathode CA, thereby preventing contact between the contents of electrolyte chamber ECH and cathode CA. Of course, if the electrolyte is a two-component electrolyte, it may be desirable to arrange an additional membrane (not shown in FIG. 59) which separates the two electrolyte components from each other in electrolyte chamber ECH. Further, if there is no risk that anode AN and/or cathode CA will be adversely affected by a prolonged contact with the electrolyte or a component thereof (e.g., during storage of fuel cell FC), one or both of membranes ME₃ and ME₄ may be dispensed with. For example, if the electrolyte is a gel electrolyte, it may not be necessary or even desirable to provide any of these two membranes (rendering knife K₂ superfluous).

The fuel cell FC also comprises two knives K₁ and K₂ which are connected by a plunger PL. When plunger PL is pressed down, knife K₁ simultaneously rips membranes ME₁ and ME₂, and at the same time knife K₂ simultaneously rips membranes ME₃ and ME₄ (of course, each of knives K₁ and K₂ may be divided into two separate knives which may or may not be connected by a common plunger). Accordingly, the fuel cell is activated and able to supply power because there will no longer be a mixing barrier for the contents of fuel chamber sections FCHₛ₁ and FCHₛ₂ and there will also no longer be contact barriers between anode AN and the contents of fuel chamber FCH and electrolyte chamber ECH and between cathode CA and the contents of electrolyte chamber ECH.

FIG. 60 shows a schematic cross-section of another non-limiting example of a cartridge-free fuel cell FC. This fuel cell differs from the fuel cell described in connection with FIG. 59 essentially only in that one of the components of a multi-component (e.g., two-component) liquid fuel (e.g., a liquid diluent for a fuel concentrate that is already present in the fuel chamber FCH) still needs to be added to fuel chamber FCH. Accordingly, there is no need for any membrane that divides fuel chamber FCH into two or more sections. Since a component of the fuel still needs to be added to fuel chamber FCH, the latter is provided with an opening which can be (re)sealed with a cap CP (e.g., a screw cap). Once it is desired to operate fuel cell FC, the missing (e.g., liquid) component of the fuel can be introduced into fuel chamber FCH through the opening thereof and thereafter the opening can be sealed again with cap CP. The missing fuel component can be introduced into fuel chamber FCH, for example, manually with the aid of a funnel. Alternatively, it is also possible to connect the opening of fuel chamber FCH to a container (cartridge) which contains the desired amount of the missing component. This connection may, for example, be accomplished by a transferring system and valve system as described in connection with the cartridge/fuel cell combination. This system may be activated manually or automatically, e.g., in response to a predetermined condition.

Before or after the introduction of the missing fuel component, plungers PL₁ and PL₂ may be pressed down either simultaneously or sequentially to cause knives K₁ and K₂ to rip membrane ME₂ which prevents contact between the contents of fuel chamber FCH and anode AN and membranes ME₃ and ME₄ which prevent contact between the contents of electrolyte chamber ECH and cathode CA and anode AN. Of course, plungers PL₁ and PL₂ may also be combined in a single plunger (as schematically illustrated in FIG. 59). As in the case of the fuel cell discussed in connection with FIG. 59, if there is no risk that anode AN and/or cathode CA would be adversely affected by a prolonged contact with the electrolyte or a component thereof (e.g., during storage of fuel cell FC), one or both of membranes ME₃ and ME₄ may be dispensed with. For example, if the electrolyte is a gel electrolyte, it may not be necessary or even desirable to provide any of these two membranes (rendering knife K₂ superfluous).

It is noted that the fuel cell, the cartridge and the transferring system are all preferably disposable and are preferably made of light-weight (and preferably inexpensive) materials. It should also be noted that the exemplary dimensions, values, sizes, volumes, etc., disclosed herein are not intended to be limiting and may vary by as much as, e.g., 50% less to 150% more. The majority of parts of the cartridge can be made of polymer materials which are suitable for the fuel cell environment and which can withstand contact/exposure with fuel and electrolyte from a fuel cell and/or similar chemicals. Examples of non-limiting polymer materials include optionally filled PVC, PP, PE, ABS, polycarbonate and polyurethane, etc. Further, while the above-described exemplary and non-limiting embodiments of the cartridge/fuel cell power supply system of the present invention have been shown mostly in the form of a (preferred) vertical arrangement of the cartridge relative to the fuel cell, other arrangements are, of course, possible such as, e.g., a horizontal arrangement. Still further, while most of the above-described exemplary and non-limiting embodiments of the power supply system of the present invention have been indicated to be non-reusable after exhaustion of the contents thereof, each of the shown embodiments and any other embodiments within the scope of the present invention may as well be designed in a way which allows the cartridge to be detached from the fuel cell after the contents thereof have been discharged into the fuel cell. This may in some instances facilitate a recycling and/or refurbishment of the cartridge and/or the fuel cell after use thereof.

By way of non-limiting example, all types of fuels, electrolytes and electrodes which are known for use with (direct) liquid fuel cells and the like are contemplated for use by the present invention. Non-limiting examples of fuels, electrolytes and electrodes which are suitable for use in the present invention are disclosed in, e.g., U.S. Pat. Nos. 6,554,877 and 6,758,871 and in pending U.S. Patent Application Nos. US2002/0076602 A1, US2002/0142196 A1, 2003/0099876 A1, Ser. No. 10/757,849 (US2005/0155279 A1), Ser. No. 10/634,806 (US2005/0058882 A1), Ser. No. 10/758,080 (US2005/0158609 A1), Ser. No. 10/959,763 (US2006/0078783 A1), Ser. No. 10/941,020 (US2006/0057435 A1), Ser. Nos. 11/384,364, 11/384,365, 11/325,466, 11/325,326 and 60/781,340. For example, all desirable liquid electrolytes (including those of very high and very low viscosity) may be utilized in each of the disclosed embodiments. Solid electrolytes may also be utilized as well as ion exchange membranes. Matrix electrolytes can also be utilized such as, e.g., a porous matrix impregnated by a liquid electrolyte. Additionally, gel-like electrolytes can also be utilized with any one or more of the disclosed embodiments. The invention also contemplates using hydrogen elimination systems in the fuel cell and/or cartridge. Non-limiting examples of fuel cell arrangements/systems with hydrogen removal are disclosed in co-pending U.S. patent application Ser. Nos. 10/758,080 (US2005/0158609 A1) and Ser. No. 11/226,222 (US2006/0057437 A1).

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A power supply system comprising:
at least one liquid fuel cell which comprises at least one fuel chamber for holding a liquid fuel and at least one electrolyte chamber for holding an electrolyte;
at least one cartridge comprising at least one substance selected from a liquid fuel or a component thereof and a liquid electrolyte or a component thereof; and
a transfer system for transferring the contents of the at least one cartridge to the at least one liquid fuel cell;
the system being capable of providing an electrical energy of at least about 500 watt-hour.

2. The system of claim 1, wherein the system is designed as at least one of a stand-alone unit, a modular unit, and a back-up power supply system.

3. The system of claim 1, wherein the system is capable of providing an electrical energy of at least about 1,000 watt-hour.

4. The system of claim 1, wherein the system is capable of providing an electrical energy of at least about 5,000 watt-hour.

5. The system of claim 1, wherein the system is capable of providing a voltage of at least about 2 V.

6. The system of claim 1, wherein the system is capable of providing a voltage of at least about 20 V.

7. The system of claim 1, wherein the system is capable of providing a voltage of at least about 100 V.

8. The system of claim 1, wherein the system comprises at least two liquid fuel cells.

9. The system of claim 8 wherein the at least two liquid fuel cells are electrically connected in series to each other.

10. The system of claim 8, wherein the at least two liquid fuel cells are electrically connected in parallel to each other.

11. The system of claim 8, wherein each of the at least two liquid fuel cells is capable of providing an electrical energy of at least about 20 watt-hour.

12. The system of claim 1, wherein the system comprises at least about four liquid fuel cells.

13. The system of claim 1, wherein the at least one fuel chamber is substantially empty and the liquid fuel or components thereof are present in one or more cartridges.

14. The system of claim 1, wherein the at least one electrolyte chamber is substantially empty and the electrolyte or components thereof are present in one or more cartridges.

15. The system of claim 1, wherein both the at least one fuel chamber and the at least one electrolyte chamber are substantially empty and the liquid fuel or components thereof and the electrolyte or components thereof are present in one or more cartridges.

16. The system of claim 1, wherein the at least one electrolyte chamber contains an electrolyte or a component thereof.

17. The system of claim 1, wherein the electrolyte chamber comprises a gel electrolyte.

18. The system of claim 1, wherein the at least one electrolyte chamber comprises a liquid electrolyte.

19. The system of claim 1, wherein the at least one electrolyte chamber contains a first component of a liquid electrolyte and the at least one cartridge contains a second component of the liquid electrolyte which in combination with the first component affords the liquid electrolyte.

20. The system of claim 1, wherein the liquid fuel comprises a fuel concentrate and a liquid for diluting the concentrate and wherein both the fuel concentrate and the liquid are present in one or more cartridges.

21. The system of claim 1, wherein the liquid fuel comprises a fuel concentrate and a liquid for diluting the concentrate and wherein at least a part of the liquid is present in the at least one fuel chamber and the concentrate is present in the at least one cartridge.

22. The system of claim 1, wherein the at least one cartridge comprises in separate sections thereof at least two of (i) a liquid fuel or a concentrate thereof, (ii) a liquid for diluting the fuel concentrate and (iii) a liquid electrolyte or a liquid component thereof.

23. The system of claim 24, wherein the at least one cartridge comprises in separate sections thereof a liquid fuel concentrate and a liquid for diluting the fuel concentrate.

24. The system of claim 25, wherein the at least one cartridge comprises a liquid electrolyte in a section thereof which is separate from the sections for the concentrate and the liquid.

25. The system of claim 1, wherein the at least one cartridge comprises at least one puncturable cap.

26. The system of claim 1, wherein the at least one cartridge comprises at least one puncturable separating wall dividing the cartridge into at least two separate sections.

27. The system of claim 1, wherein the at least one fuel cell comprises at least one device for puncturing at least one of a puncturable separating wall and a puncturable cap of the at least one cartridge.

28. The system of claim 1, wherein the at least one cartridge is connected to the at least one fuel cell by the transfer system.

29. The system of claim 1, wherein the at least one cartridge is non-removably connected to the at least one fuel cell by the transfer system.

30. The system of claim 28, wherein the transfer system connects the at least one fuel cell to more than one cartridge.

31. The system of claim 28, wherein the transfer system connects the at least one cartridge to more than one fuel cell.

32. The system of claim 1, wherein the transfer system comprises a frame and a device for at least one of (a) moving, (b) automatically moving upon activation, (c) allowing upon activation, and (d) guiding upon activation, the at least one cartridge from a first position wherein the at least one cartridge is not connected to the at least one fuel cell to a second position wherein the at least one cartridge is connected to the at least one fuel cell.

33. The system of claim 1, wherein the transfer system comprises a frame and a device for forcing, upon activation, the contents of the at least one cartridge into the at least one fuel cell.

34. The system of claim 1, wherein the transfer system comprises a frame and a device for moving, upon activation, the at least one cartridge from a first position wherein the at least one cartridge is not connected to the at least one fuel cell to a second position wherein the at least one cartridge is connected to the at least one fuel cell, whereby the contents of the at least one cartridge in the second position are automatically transferred to the at least one fuel cell.

35. The system of claim 33, wherein the system further comprises an enclosure for housing the at least one cartridge and the at least one fuel cell.

36. The system of claim 34, wherein the system further comprises an enclosure for housing the at least one cartridge and the at least one fuel cell.

37. The system of claim 1, wherein the system is configured to allow the contents of the at least one cartridge to be transferred to the at least one fuel cell due at least partially to gravity.

38. The system of claim 1, wherein the system is configured for transferring the contents of the at least one cartridge to the at least one fuel cell due at least partially to a biasing force.

39. The system of claim 1, wherein the at least one cartridge is configured to slide into an opening in the at least one fuel cell.

40. The system of claim 1, wherein the system is designed to cause the transfer system to transfer the contents of the at least one cartridge to the at least one fuel cell based on a predetermined condition.

41. The system of claim 40, wherein the system further comprises a sensing system for sensing the predetermined condition.

42. The system of claim 40, wherein the system further comprises an activation system for activating the transfer system based on the predetermined condition.

43. The system of claim 41, wherein the system further comprises an activation system for activating the transfer system based on a sensing of the predetermined condition by the sensing system.

44. The system of claim 1, wherein the system further comprises a valve system which connects the at least one cartridge to the at least one fuel cell.

45. The system of claim 1, wherein the transfer system comprises a valve system connected to each of the at least one cartridge and the at least one fuel cell.

46. The system of claim 45, wherein the valve system comprises a plurality of entrance ports and exit ports which are in fluid communication with each of the at least one cartridge and the at least one fuel cell.

47. The system of claim 1, wherein a volume of the at least one fuel chamber of the at least one fuel cell is at least about 0.5 liters.

48. The system of claim 1, wherein a total fuel chamber volume of the entire system is at least about 2 liters.

49. The system of claim 1, wherein the at least one cartridge comprises up to about 50 liters of liquid fuel or of a fuel concentrate plus a liquid for diluting the fuel concentrate.

50. The system of claim 1, wherein the at least one cartridge comprises up to about 10 liters of a liquid electrolyte or a component thereof.

51. The system of claim 1, wherein the at least one fuel cell comprises a generally rectangular housing.

52. The system of claim 51, wherein the at least one cartridge comprises a generally rectangular housing.

53. The system of claim 1, wherein the at least one fuel cell comprises a generally cylindrical housing.

54. The system of claim 53, wherein the at least one cartridge comprises a generally cylindrical housing.

55. The system of claim 1, wherein the liquid fuel comprises at least one of a hydride compound and a borohydride compound.

56. The system of claim 1, wherein the liquid fuel comprises at least one borohydride compound and comprises a concentrate and a liquid for diluting the concentrate.

57. The system of claim 56, wherein the at least one borohydride compound is selected from NaBH₄, KBH₄, LiBH₄, NH₄BH₄, Be(BH₄)₂, Ca(BH₄)₂, Mg(BH₄)₂, Zn(BH₄)₂, AI(BH₄)₃, polyborohydrides, (CH₃)₃NBH₃, and NaCNBH₃.

58. The system of claim 56, wherein the concentrate comprises one or more borohydride compounds in a total concentration of at least about 0.5 mole per liter of concentrate.

59. The system of claim 1, wherein the electrolyte comprises an alkali metal hydroxide.

60. The system of claim 1, wherein the system comprises a plurality of liquid fuel cells and comprises liquid fuel cells which are electrically connected in parallel to each other and liquid fuel cells which are electrically connected in series to each other.

61. The system of claim 1, wherein the system further comprises a battery which is capable of supplying power during a time where the at least one fuel cell is powered up.

62. The system of claim 1, wherein the system further comprises a DC to AC converter.

63. A power supply system comprising:
at least one liquid fuel cell which comprises at least one fuel chamber for holding a liquid fuel and at least one electrolyte chamber for holding an electrolyte;
at least one cartridge comprising at least one substance selected from a liquid fuel or a component thereof and a liquid electrolyte or a component thereof; and
a transfer system for transferring the contents of the at least one cartridge to the at least one liquid fuel cell;
wherein the system is designed to cause the transfer system to be activated based on a predetermined condition.

64. The system of claim 63, wherein the system further comprises an activation system for activating the transfer system based on the predetermined condition.

65. The system of claim 64, wherein the system further comprises a sensing system for sensing the predetermined condition.

66. A power supply system comprising:
at least one liquid fuel cell which comprises at least one fuel chamber for holding a liquid fuel and at least one electrolyte chamber for holding an electrolyte;
at least one cartridge comprising at least one substance selected from a liquid fuel or a component thereof and a liquid electrolyte or a component thereof; and
a transfer system for transferring the contents of the at least one cartridge to the at least one liquid fuel cell;
the transfer system comprising a frame and (i) a device for forcing, upon activation, the contents of the at least one cartridge into the at least one fuel cell or (ii) a device for at least one of (a) moving, (b) automatically moving upon activation, (c) allowing upon activation, and (d) guiding upon activation, the at least one cartridge from a first position wherein the at least one cartridge is not connected to the at least one fuel cell to a second position wherein the at least one cartridge is connected to the at least one fuel cell.

67. A power supply system comprising:
at least one direct liquid fuel cell; and
a system or device for transferring liquid fuel or a component thereof to the at least one fuel cell,
wherein the power supply system is capable of providing an electrical energy of at least about 500 watt-hour.

68. The power supply system of claim 67, wherein the system comprises a liquid fuel which comprises at least one borohydride compound.

69. A load in electrical contact with a power supply system, wherein the power supply system comprises
at least one direct liquid fuel cell which comprises at least one fuel chamber for holding a liquid fuel and at least one electrolyte chamber for holding an electrolyte;
at least one cartridge comprising at least one substance selected from a liquid fuel or a component thereof and a liquid electrolyte or a component thereof; and
a transfer system for transferring the contents of the at least one cartridge to the at least one liquid fuel cell;
and wherein the load has an electric power of at least about 20 watts and the power supply system is capable of powering the load and providing an electrical energy of at least about 100 watt-hour.

70. The load of claim 69, wherein the load comprises a hospital or facility thereof, a store or facility thereof, an office or facility thereof, a communications system, or a home.

71. The load of claim 69, wherein the load comprises at least one of a cell phone tower, an industrial motor, a life support system, a computer system, a facsimile machine, an emergency lighting system, an air conditioner, a furnace fan, a space heater, a water heater, a freezer, a refrigerator, a range, a hotplate, a microwave oven, a water well pump, a sump pump, and a battery charger.

72. The load of claim 69, wherein the system comprises a liquid fuel which comprises at least one borohydride compound.

73. A method of generating electrical power during a power outage, wherein the method comprises activating the power supply system of claim 1.

74. The method of claim 73, wherein the method comprises activating the power supply system based on a predetermined condition.

75. A method of generating electrical energy during a power outage, wherein the method comprises activating a power supply system for one-time use which comprises at least one direct liquid fuel cell and a hydride or borohydride containing liquid fuel and is capable of providing an electrical energy of at least about 100 watt-hour.

76. The method of claim 75, wherein the power supply system comprises at least about four direct liquid fuel cells which are electrically connected to each other.

77. The method of claim 75, wherein the method comprises automatically activating the system when the power outage is detected.

78. A method of supplying a customer with an emergency power supply, wherein the method comprises supplying the customer with a power supply system for one-time use or a component thereof, the system comprising at least one direct liquid fuel cell.

79. The method of claim 78, wherein the system further comprises at least one cartridge comprising at least one substance selected from a liquid fuel or a component thereof and a liquid electrolyte or a component thereof.

80. The method of claim 79, wherein the system further comprises a transfer system for transferring the contents of the at least one cartridge to the at least one fuel cell.

81. The method of claim 79, wherein the liquid fuel comprises at least one of a hydride compound and a borohydride compound.

82. The method of claim 78, wherein the power supply system is capable of providing an electrical energy of at least about 100 watt-hour.

83. The method of claim 78, wherein the method further comprises providing the customer with an opportunity to return the used power supply system or component thereof.

84. The method of claim 78, further comprising providing the customer with an opportunity to exchange a used power supply system or component thereof for an operational power supply system or component thereof.

85. The method of claim 83, wherein the method further comprises refurbishing a returned power supply system or component thereof and offering the refurbished system or component thereof for sale to the same or a different customer.

86. The method of claim 78, wherein the method further comprises offering to at least one of deliver and install the power supply system or a component thereof at a location specified by the customer.

87. The method of claim 86, wherein the method further comprises offering to pick up a used power supply system or component thereof and replace it by a new power supply system or component thereof.

88. The method of claim 86, wherein the method further comprises offering to refurbish a used power supply system or component thereof at the location.

89. The method of claim 86, wherein the method further comprises offering to check and, if needed, repair an installed power supply system at the location in periodic intervals to ensure operability thereof at the time of use.

90. The method of claim 78, wherein the customer is a private customer.

91. The method of claim 78, wherein the customer is a commercial customer.

92. A power supply system comprising at least one liquid fuel cell, wherein the at least one fuel cell comprises a cathode, an anode, a fuel chamber comprising a liquid fuel or at least one component thereof on one side of the anode and an electrolyte chamber comprising an electrolyte or at least one component thereof between the anode and the cathode, and wherein at least the contents of the fuel chamber are separated from the anode by a first separating device which is at least one of removable from the anode and puncturable and wherein the system further comprises a first activation device by which the first separating device can be at least one of removed from the anode and punctured to allow the contents of the fuel chamber to contact the anode.

93. The system of claim 92, wherein the contents of the electrolyte chamber are separated from the anode by a second separating device which is at least one of removable from the anode and puncturable and wherein the system further comprises a second activation device by which the second separating device can be at least one of removed from the anode and punctured to allow the contents of the electrolyte chamber to contact the anode.

94. The system of claim 92, wherein the contents of the electrolyte chamber are separated from the cathode by a third separating device which is at least one of removable from the cathode and puncturable and wherein the system further comprises a third activation device by which the third separating device can be at least one of removed from the cathode and punctured to allow the contents of the electrolyte chamber to contact the cathode.

95. The system of claim 92, wherein the liquid fuel comprises a fuel concentrate and a liquid for diluting the concentrate and wherein the fuel chamber is divided into at least a first fuel chamber section and a second fuel chamber section by a fourth separating device which is at least one of puncturable and removable, one of the first and second fuel chamber sections comprising the concentrate and the other one of the first and second fuel chamber sections comprising the liquid, and wherein the system further comprises a fourth activation device by which the fourth separating device can be at least one of punctured and removed to allow the concentrate and the liquid to mix.

96. The system of claim 92, wherein the electrolyte comprises a first liquid component and a second component and wherein the fuel chamber is divided into at least a first electrolyte chamber section and a second electrolyte chamber section by a fifth separating device which is at least one of puncturable and removable, one of the first and second electrolyte chamber sections comprising the first component and the other one of the first and second electrolyte chamber sections comprising the second component, and wherein the system further comprises a fifth activation device by which the fifth separating device can be at least one of punctured and removed to allow the first and second components to mix.

97. The system of claim 92, wherein the first separating device comprises a membrane.

98. The system of claim 97, wherein the first activation device comprises a blade.

99. The system of claim 93, wherein the second separating device comprises a membrane.

100. The system of claim 99, wherein the second activation device comprises a blade.

101. The system of claim 93, wherein the first and second activation devices are combined in a single activation device.

102. The system of claim 95, wherein the fourth separating device comprises a membrane.

103. The system of claim 102, wherein the fourth activation device comprises a blade.

104. The system of claim 95, wherein the first and fourth activation devices are combined in a single activation device.

105. The system of claim 92, wherein the system is capable of providing an electrical energy of at least about 500 watt-hour.

106. The system of claim 92, wherein the system is designed as at least one of a stand-alone unit, a modular unit, and a back-up power supply system.

107. The system of claim 92, wherein the system comprises a plurality of fuel cells which are electrically connected at least one of in series to each other and parallel to each other.

108. The system of claim 92, wherein the at least one liquid fuel cell is capable of providing an electrical energy of at least about 20 watt-hour.

109. The system of claim 92, wherein the electrolyte chamber comprises a gel electrolyte.

110. The system of claim 92, wherein the electrolyte chamber comprises a liquid electrolyte.

111. The system of claim 92, wherein the system is designed to cause the first activation device to at least one of puncture and remove the first separating device based on a predetermined condition.

112. The system of claim 111, wherein the system further comprises a sensing system for sensing the predetermined condition.

113. The system of claim 111, wherein the system further comprises an activation system for activating the first activation system based on the predetermined condition.

114. The system of claim 92, wherein a volume of the fuel chamber of the at least one fuel cell is at least about 0.5 liters.

115. The system of claim 92, wherein a volume of the fuel chamber of the at least one fuel cell is not larger than about 20 liters.

116. The system of claim 92, wherein a total fuel chamber volume of the entire system is at least about 2 liters.

117. The system of claim 92, wherein the liquid fuel comprises at least one of a hydride compound and a borohydride compound.

118. The system of claim 117, wherein the liquid fuel comprises at least one borohydride compound selected from NaBH₄, KBH₄, LiBH₄, NH₄BH₄, Be(BH₄)₂, Ca(BH₄)₂, Mg(BH₄)₂, Zn(BH₄)₂, AI(BH₄)₃, polyborohydrides, (CH₃)₃NBH₃, and NaCNBH₃.

119. The system of claim 117, wherein the electrolyte comprises an alkali metal hydroxide.

120. The system of claim 92, wherein the liquid fuel comprises a fuel concentrate and a liquid for diluting the concentrate, wherein the fuel chamber comprises the concentrate and wherein the fuel cell has an opening for transferring the liquid to the fuel chamber.

121. The system of claim 92, wherein the electrolyte comprises a first liquid component and a second component, wherein the electrolyte chamber comprises the second component and wherein the fuel cell has an opening for transferring the first liquid component to the electrolyte chamber.
